(19) United States
(12) Patent Application Publication
(10) Pub. No.: US 2026/0256053 A1
(43) Pub. Date: Sep. 3, 2026

(54) RIDING MOWER

(71) Applicant: Nanjing Chervon Industry Co., Ltd., Nanjing (CN)

(72) Inventors: Dezhong Yang, Nanjing (CN); Zhongyan Hou, Nanjing (CN); Jicun Cai, Nanjing (CN); Zhen Wang, Nanjing (CN); Qian Liu, Nanjing (CN); Fan Gao, Nanjing (CN); Xi Chen, Nanjing (CN); Fangjie Nie, Nanjing (CN); Toshinari Yamaoka, Nanjing (CN); Cheng Dai, Nanjing (CN); Rong Wu, Nanjing (CN); Lijin Zhang, Nanjing (CN); Tianfang Wei, Nanjing (CN); Tao Zhang, Nanjing (CN); Zhuxian Shang, Nanjing (CN); Xinming Shen, Nanjing (CN)

(21) Appl. No.: 19/652,720

(22) Filed: Apr. 20, 2026

Related U.S. Application Data
(63) Continuation-in-part of application No. 17/838,482, filed on Jun. 13, 2022, now Pat. No. 12,628,734.
Application No. 17/838,482 is a continuation-in-part of application No. 17/695,231, filed on Mar. 15, 2022, now Pat. No. 11,812,689.
Application No. 17/695,231 is a continuation of application No. PCT/CN2020/124287, filed on Oct. 28, 2020.
Application No. 17/838,482 is a continuation of application No. PCT/CN2020/071419, filed on Jan. 10, 2020.

(30) Foreign Application Priority Data
Oct. 29, 2019 (CN) 201911034246.X
Oct. 29, 2019 (CN) 201911034247.4
Oct. 29, 2019 (CN) 201911034248.9
Dec. 31, 2019 (CN) 201911401855.4
Jul. 24, 2020 (CN) 202010719948.8
Jul. 25, 2025 (CN) 202511039001.1

(51) Int. Cl. A01D 34/78; A01D 34/66; A01D 69/02; A01D 101/00

(52) U.S. Cl. CPC A01D 34/78; A01D 34/66; A01D 69/02; A01D 2101/00

(57) ABSTRACT

A riding mower includes a seat for a user to sit on, a main frame configured to support the seat, a power output assembly configured to mow vegetation, a traveling assembly configured to enable the riding mower to travel, an operating assembly configured to be operated by the user, a control module configured to control the riding mower, and a power supply apparatus configured to supply power to the riding mower. At least a portion of the control module is disposed on the lower side of the seat, and the control module comprises a drive control board for controlling the power output assembly and the traveling assembly, a fuse, and a power supply management module.

### RELATED APPLICATION INFORMATION

The subject application is a continuation-in-part of U.S. application Ser. No. 17/838,482, filed Jun. 13, 2022, which is a continuation-in-part of U.S. application Ser. No. 17/695,231, filed Mar. 15, 2022, which is a U.S. national stage application of International Application No. PCT/CN2020/124287, filed on Oct. 28, 2020, which claims the benefit of Chinese Patent Application No. 201911034247.4, filed on Oct. 29, 2019, Chinese Patent Application No. 201911034246.X, filed on Oct. 29, 2019, Chinese Patent Application No. 201911034248.9, filed on Oct. 29, 2019, and Chinese Patent Application No. 202010719948.8, filed on Jul. 24, 2020.

The subject application is also a continuation of International Application No. PCT/CN2020/071419, filed on Jan. 10, 2020, which claims the benefit of Chinese Patent Application No. 201911401855.4, filed on Dec. 31, 2019.

The subject application also claims the benefit of Chinese Patent Application No. 202511039001.1, filed on Jul. 25, 2025.

Each of these applications from which priority is claimed is incorporated herein by reference in its entirety.

### BACKGROUND

As a garden tool, a mower is widely applied to fields including mowing a lawn and vegetation. A riding mower in the related art is a small engineering machine that can be driven by one person. Generally, special functions of the riding mower determine the special structure of the riding mower. Due to the specific working environment and relatively complicated working terrain, the riding mower in the related art causes a user to encounter relatively great ups and downs during operation. As for riding mowers, under the premise of satisfying various performance requirements, functional requirements, and safety requirements, how to provide a riding mower with a simple structure, high structural strength and good stability becomes an urgent problem to be solved at present.

### SUMMARY

A riding mower is provided. The riding mower includes a seat, a main frame, a mowing element, a traveling assembly, and an operating assembly. The seat is for a user to sit on. The main frame extends in the direction of a first straight line and is configured to carry the seat. The mowing element is configured to mow vegetation. The traveling assembly is configured to enable the riding mower to travel. The operating assembly is configured to be operated by the user to control the riding mower to travel and output power. The traveling assembly includes a first traveling wheel, a second traveling wheel, a first drive assembly, and a second drive assembly. The first drive assembly and the second drive assembly are configured to drive the second traveling wheel to rotate. The first drive assembly and the second drive assembly are connected to the main frame by a connector and are disposed symmetrically about a symmetry plane parallel to the direction of the first straight line. The traveling assembly further includes a connection plate disposed in the direction of a line perpendicular to the direction of the first straight line and perpendicular to the symmetry plane. The connection plate connects the first drive assembly and the second drive assembly and enables the first drive assembly and the second drive assembly to be connected into a whole.

In one example, the first drive assembly and the second drive assembly each include a gearbox. The connection plate is connected to the gearbox.

In one example, when the connection plate is connected to the first drive assembly and the second drive assembly, an accommodation space that separates at least part of the upper space of the main frame from at least part of the lower space of the main frame and that is located on the lower side of the main frame is formed. The first drive assembly and the second drive assembly are disposed in the accommodation portion.

In one example, the connection plate includes a first connection plate and a second connection plate.

The first connection plate is disposed on the upper side of the first drive assembly and on the upper side of the second drive assembly.

The second connection plate is disposed on the lower side of the first drive assembly and on the lower side of the second drive assembly.

In one example, an accommodation space is formed between the first connection plate and the second connection plate. The first drive assembly and the second drive assembly are disposed in the accommodation space.

In one example, the first connection plate and the second connection plate are disposed in parallel in an up and down direction perpendicular to the first straight line.

In one example, the first connection plate and the second connection plate are staggered in a straight-line direction perpendicular to the first straight line.

In one example, the riding mower further includes a control circuit configured to control the first drive assembly and the second drive assembly and connected by a connection line.

In one example, the connection line is disposed in the accommodation space.

In one example, the connection line is disposed on the rear side of the first drive assembly in the accommodation space and on the rear side of the second drive assembly in the accommodation space.

A riding mower is provided. The riding mower includes a seat, a main frame, a mowing element, a traveling assembly, and an operating assembly. The seat is for a user to sit on. The main frame is configured to carry the seat. The mowing element is configured to mow vegetation. The traveling assembly is configured to enable the riding mower to travel. The operating assembly is configured to be operated by the user to control the riding mower to travel. The riding mower further includes a power supply apparatus. The power supply apparatus is disposed on the rear end of the main frame. The power supply apparatus includes a battery pack able to provide energy and a battery compartment configured to accommodate the battery pack. The battery compartment includes a main compartment configured to accommodate the battery pack and a compartment cover configured to at least partially enclose the main compartment. The compartment cover includes a first cover and a second cover. The first cover includes a body and a grid spreading around the body.

In one example, the first cover and the second cover are detachably connected to each other.

In one example, the second cover is a transparent member.

In one example, a second reinforcing rib is disposed on the side of the second cover facing the main compartment.

In one example, a first reinforcing rib is disposed on the side of the first cover facing the main compartment. The first cover is disposed on the side facing the main compartment. The second cover is disposed on the side of the first cover facing away from the main compartment. The second cover at least partially covers the first cover.

In one example, the grid is formed by through holes extending through the first cover.

In one example, the body is Y-shaped. The grid connects the body and the edge of the first cover.

In one example, the riding mower further includes a support base. The power supply apparatus is connected to the main frame by a group of support bases.

In one example, the support base includes a support portion configured to support the power supply apparatus, a first connection portion configured to connect the power supply apparatus, and a second connection portion configured to connect the main frame.

In one example, a buffer is disposed between the power supply apparatus and the main frame.

A riding mower is provided. The riding mower includes a seat, a main frame, a mowing element, a traveling assembly, and an operating assembly. The seat is for a user to sit on. The main frame is configured to carry the seat. The mowing element is configured to mow vegetation. The traveling assembly is configured to enable the riding mower to travel. The operating assembly is configured to be operated by the user to control the riding mower to travel and output power. The riding mower further includes a power supply apparatus disposed on the rear end of the main frame. The power supply apparatus includes a battery pack able to provide energy and a battery compartment configured to accommodate the battery pack. The battery compartment includes a main compartment configured to accommodate the battery pack and a compartment cover configured to at least partially enclose the main compartment. The compartment cover is provided with a fastener locked to the main compartment. The main compartment is formed with a matching stop portion. The fastener includes a locking portion. The side of the locking portion facing the stop portion includes a first edge and a second edge. An included angle between the first edge and the second edge is greater than or equal to 60° and less than or equal to 90°.

In one example, the included angle between the first edge and the second edge is 90°.

In one example, the main compartment is formed with a through hole for the locking cover. portion to extend through. The stop portion extends along the through hole.

In one example, the stop portion is formed with a channel for the locking portion to go through and a protrusion matching the locking portion.

In one example, the compartment cover is formed with an accommodation recess configured to accommodate the fastener.

In one example, the fastener further includes a pivot portion and an operating portion. The pivot portion is for the fastener to rotate around. The pivot portion is connected to the accommodation recess by a group of connection structures. The operating portion is disposed between the pivot portion and the locking portion.

In one example, the riding mower further includes an elastic member disposed between the fastener and the compartment cover.

In one example, the locking portion has a first position and a second position that are relative to the stop portion.

When the locking portion is at the first position, a locking hook abuts the stop portion and is able to hook the stop portion. When the locking portion is at the second position, the locking hook is disengaged from the stop portion.

In one example, the compartment cover is connected to the main compartment by a first connector and a second connector. The first connector is disposed on an end of the compartment cover and on an end of the main compartment. The compartment cover is able to rotate around the first connector and relative to the main compartment. The second connector is connected to the middle of the compartment cover and the middle of the main compartment. The second connection portion is configured to support the compartment cover to make the compartment cover opened or closed relative to the main compartment.

In one example, the second connector includes a first connection end and a second connection end. The first connection end is disposed on the compartment cover. The second connection end is disposed on the main compartment. A gas spring able to support the compartment cover to make the compartment cover opened or closed relative to the main compartment is disposed between the first connection end and the second connection end.

A riding mower is provided. The riding mower includes a main frame, a mowing element, a traveling assembly, and an operating assembly. The mowing element is configured to mow vegetation. The traveling assembly is configured to enable the riding mower to travel. The operating assembly is configured to be operated by the user to control the riding mower to travel and output power. The traveling assembly includes a first traveling wheel, a second traveling wheel, a first drive assembly, and a second drive assembly. The first drive assembly and the second drive assembly are configured to drive the second traveling wheel to rotate. The first drive assembly and the second drive assembly each include a drive motor, a gear mechanism, an output shaft, and a gearbox. The drive motor is configured to output a driving force. The gear mechanism is connected to the drive motor. The output shaft is configured to connect the gear mechanism and the second traveling wheel and is able to drive the second traveling wheel to rotate. The gearbox is configured to accommodate the gear mechanism and the output shaft. The gear mechanism includes a transmission gear connected to the output shaft. The output shaft is further connected to the gearbox by a first connection assembly. The first connection assembly includes a first bearing and a retainer. The first bearing is distributed in the axial direction of the output shaft. The retainer is disposed between the first bearing and the transmission gear.

In one example, the retainer and the first bearing are sleeved on the output shaft. The riding mower further includes a second bearing configured to secure the output shaft and disposed on the end of the output shaft facing the second traveling wheel.

In one example, the retainer is a ring disposed around the output shaft. The ring is provided with thrust rollers able to rotate freely on the ring.

In one example, the first connection assembly further includes a first gasket and a second gasket. The first gasket and the second gasket are disposed between the first bearing and the retainer.

In one example, when the second gasket abuts the retainer, the thrust rollers are able to rotate relative to the second gasket.

In one example, the output shaft is formed with a protrusion portion. The protrusion portion is disposed between the transmission gear and the second traveling wheel and adjacent to the transmission gear.

In one example, the protrusion portion is disposed around the output shaft. The diameter of the protrusion portion is greater than the diameter of the output shaft.

In one example, the gearbox is formed with an accommodation recess. The protrusion portion is disposed in the accommodation recess.

In one example, the riding mower further includes a sleeve disposed on the side of the protrusion portion facing away from the transmission gear.

In one example, the riding mower further includes a third gasket disposed between the protrusion portion and the sleeve.

A riding mower is provided. The riding mower includes a seat, a main frame, a power output assembly, a traveling assembly, an operating assembly, a control module, and a power supply apparatus. The seat is for a user to sit on. The main frame extends in the direction of a first straight line and is configured to carry the seat. The power output assembly is configured to mow vegetation. The traveling assembly is configured to enable the riding mower to travel. The operating assembly is configured to be operated by the user to control the riding mower to travel and output power. The control module is configured to control the riding mower. The power supply apparatus is configured to supply power to the riding mower. The main frame extends basically in a first plane. The first straight line is in the first place. The main frame is basically symmetrical about the first straight line. The first plane further includes a second straight line perpendicular to the first straight line. The main frame is basically symmetrical about the second straight line. On a second plane extending through the second straight line and perpendicular to the first plane, the seat is disposed on the main frame and at least partially extends through the second plane. The first straight line and the second straight line have an intersection. The control module is at least partially disposed in the range of the intersection.

In one example, the operating assembly includes a first operating element and a second operating element. The first operating element is disposed on two sides of the seat. The second operating element is disposed on the front side of the main frame and is located on the left side of the main frame.

In one example, the riding mower further includes a grass catcher. The power supply apparatus is disposed on the rear side of the main frame. The grass catcher is at least partially disposed on the upper side of the power supply apparatus.

In one example, the riding mower further includes a group of connection rods connected to the main frame. The connection rods are configured to support the grass catcher.

In one example, the riding mower includes a grass catching mode and a grass discharging mode. When the riding mower is in the grass catching mode, the grass catcher is disposed on the upper side of the power supply apparatus. When the riding mower is in the grass discharging mode, the grass catcher is detached from the connection rods. The connection rods are connected to a sunshade configured to shade from the sun.

In one example, the connection rods are disposed between the seat and the power supply apparatus.

In one example, the traveling assembly includes a first traveling wheel and a second traveling wheel. The first traveling wheel is disposed on the front side of the main frame. The second traveling wheel is disposed on the rear side of the main frame. The power output assembly is disposed between the first traveling wheel and the second traveling wheel and is at least partially located on the lower side of the main frame. The power supply apparatus is disposed on the rear side of the second traveling wheel and is located on the upper side of the main frame.

In one example, the control module includes a drive control board, a power supply management module, and a fuse. The drive control board is at least partially disposed at the intersection between the first straight line and the second straight line. The power supply management module is at least partially disposed between the seat and the power supply apparatus. The fuse is disposed between the drive control board and the power supply management module.

In one example, the drive control board, the fuse, and the power supply management module are basically arranged in the direction of the first straight line.

In one example, the control module further includes a junction box disposed on the upper side of the drive control board.

A riding mower is provided. The riding mower includes a seat, a main frame, a mowing element, a traveling assembly, an operating assembly, and a power supply apparatus. The seat is for a user to sit on. The main frame is configured to carry the seat. The mowing element is configured to mow vegetation. The traveling assembly is configured to enable the riding mower to travel. The operating assembly is configured to be operated by the user to control the riding mower to travel and output power. The power supply apparatus is configured to supply power to the riding mower. The main frame is disposed in a first plane and extends in the direction of a first straight line. When being mounted, the power supply apparatus is located in an extension plane of the main frame. The main frame is provided with an anti-collision rod disposed around the power supply apparatus and located on an outer side of the main frame.

In one example, the anti-collision rod is connected to the rear side of the main frame and is basically semicircular.

In one example, the cross section of the anti-collision rod is circular.

In one example, the main frame includes a first rod, a second rod, and a third rod. The first rod and the second rod are parallel to each other. The third rod is disposed on the front end of the first rod and on the front end of the second rod. The first rod, the second rod, and the third rod are securely connected or integrally formed.

In one example, the third rod is formed with or is connected to a connection hole configured to connect the traveling assembly. The junction between the third rod and the first rod and the junction between the third rod and the first rod are each provided with a reinforcing portion.

In one example, the anti-collision rod is connected to the first rod and the second rod.

In one example, the riding mower further includes a first connection plate and a second connection plate that connect the first rod and the second rod. The first connection plate is parallel to or intersects the second connection plate.

In one example, the first connection plate extends in a plane and is formed with a pedal portion configured for being pressed down.

In one example, in a projection plane perpendicular to the up and down direction, a projection of the main frame in the up and down direction in the projection plane is basically rectangular.

In one example, the cross section of the main frame is rectangular.

A riding mower is provided. The riding mower includes a seat, a main frame, a power output assembly, a traveling assembly, and an operating assembly. The seat is for a user to sit on. The main frame is configured to carry the seat. The power output assembly is connected to the main frame and includes a mowing element and a first motor. The mowing element is configured to output power to implement the mowing function. The first motor is configured to drive the mowing element to output power. The traveling assembly is at least able to drive the electric riding mower to travel in the direction of a first straight line on the ground. The traveling assembly includes a second motor configured to drive the traveling assembly. The operating assembly is configured to be operated by the user to control the riding mower to travel and output power. The riding mower further includes a parking system enabling the riding mower to switch between a parking state and a non-parking state. When the parking system is locked, the riding mower is in the parking state. When the parking system is not locked or is unlocked, the riding mower is in the non-parking state. The riding mower further includes a rotation stop system linked to the parking system. When the parking system enters a locked state from an unlocked state, the rotation stop system is triggered and controls the second motor to stop rotation.

In one example, the parking system includes a pedal assembly, a base, a ratchet, and a first elastic member. The pedal assembly is configured to be operated by the user to implement a switch between the parking state and the non-parking state. The base is configured to be mounted with the pedal assembly. The ratchet is securely connected to the pedal assembly. The first elastic member connects the pedal assembly and the base.

In one example, the pedal assembly includes a pedal, a first rotatable member, and a pedal arm. The pedal is for the user to press down. The first rotatable member connects the pedal assembly and is rotatable around a central axis synchronously. Two ends of the pedal arm are securely connected to the pedal and the first rotatable member respectively.

In one example, the rotation stop system includes a triggering member, a contact member, and a rotation stop switch. The triggering member is formed with or connected to a triggering portion. The contact member matches the triggering portion. The rotation stop switch matches the contact member and, when being triggered by the contact member, controls the second motor to stop rotation.

In one example, the triggering member and the first rotatable member are configured to rotate synchronously.

In one example, the triggering member includes a first section and a second section. The triggering portion is disposed on the second section.

In one example, the base is provided with a slide rail extending through the base. The triggering member is connected to the first rotatable member by a fastening piece. The triggering member is disposed on one side of the base. The first rotatable member is disposed on another side of the base.

In one example, the slide rail includes a first slide rail and a second slide rail that are disposed in different rotation radii.

In one example, the length of the first slide rail is smaller than the length of the second slide rail.

In one example the rotation stop switch is configured to control the second motor to stop rotation when the rotation stop switch is held in a triggered state.

In the present application, the arrangement in which the connection plate is disposed between the first drive assembly and the second drive assembly helps enhance the structural strength of the entire traveling assembly, enabling the riding mower to adapt to more complicated working conditions.

A stand-on mower includes: a traveling mechanism including a first drive wheel and a second drive wheel, configured to support the stand-on mower to travel on the ground; a mowing mechanism at least partially disposed between the first drive wheel and the second drive wheel; a frame configured to mount the traveling mechanism and the mowing mechanism; a power supply configured to supply power to at least the traveling mechanism and the mowing mechanism, the power supply including a plurality of battery packs; a support mechanism mounted on the frame, configured to carry an operator; in a width direction, a distance L1′ between an inner side of the first drive wheel and an inner side of the second drive wheel is less than or equal to 520 mm.

In some examples, a distance L2′ between an outer side of the first drive wheel and an outer side of the second drive wheel is less than or equal to 860 mm.

In some examples, the mowing mechanism includes a mowing blade and a mowing deck covering above the mowing blade, and in the width direction, a maximum distance L′ from the mowing deck to the first drive wheel or the second drive wheel is less than or equal to 880 mm.

In some examples, a maximum cutting width of the mowing mechanism is less than or equal to 40 inches.

In some examples, the mowing mechanism further includes a side discharge assembly, the side discharge assembly includes a discharge opening and a side discharge baffle rotatable about a side discharge pivot shaft, and the side discharge assembly is configured to directionally throw grass clippings to the ground through the discharge opening.

In some examples, in a left-right direction, the side discharge pivot shaft at least partially overlaps with one of the first drive wheel or the second drive wheel, a distance from the side discharge pivot shaft to an inner side of a tire is smaller than a distance from the side discharge pivot shaft to an outer side of the tire, and a distance L5′ from the side discharge pivot shaft to an outermost point of the frame is less than or equal to 47 mm.

In some examples, in an up-down direction, the side discharge pivot shaft is located below the frame.

In some examples, the stand-on mower further includes a circuit board assembly mounted on the frame; in the left-right direction, a width L3′ of the circuit board assembly is less than or equal to 450 mm.

In some examples, a housing is provided on the frame, the housing forms an accommodating space to receive the circuit board assembly, the housing includes a left upright and a right upright, and a width L4′ between the left upright and the right upright is less than or equal to 510 mm.

In some examples, the circuit board assembly includes a printed circuit board and a housing assembly accommodating the printed circuit board; the frame includes a first longitudinal beam and a second longitudinal beam extending in a front-rear direction, and the housing assembly is at least partially disposed between the first longitudinal beam and the second longitudinal beam.

In some examples, an angle α′ between an extension direction of the housing assembly and an extension direction of the longitudinal beam of the frame is greater than or equal to 20° and less than or equal to 80°.

In some examples, in the width direction, a ratio of a maximum width L3′ of the housing assembly to the distance L1′ between the inner side of the first drive wheel and the inner side of the second drive wheel is greater than or equal to 0.8.

In some examples, the circuit board assembly is electrically connectable to the traveling mechanism or the power supply.

In some examples, the circuit board assembly is located at a rear of the power supply.

A stand-on mower includes: a traveling mechanism including a first drive wheel and a second drive wheel, configured to support the stand-on mower to travel on the ground; a frame configured to mount the traveling mechanism; the frame including a first longitudinal beam and a second longitudinal beam extending in a front-rear direction; a mowing mechanism including a mowing element for performing a mowing function; a power supply configured to supply power to at least the traveling mechanism and the mowing mechanism, the power supply including a plurality of battery packs; a support mechanism mounted on the frame, configured to carry an operator; a circuit board assembly at least partially disposed between the first longitudinal beam and the second longitudinal beam; the circuit board assembly including a printed circuit board and a housing assembly accommodating the printed circuit board; wherein a maximum cutting width of the mowing mechanism is less than or equal to 40 inches; an angle α′ between an extension direction of the housing assembly and an extension direction of the first longitudinal beam is greater than or equal to 20° and less than or equal to 80°; and, in a width direction, a ratio of a maximum width L3′ of the housing assembly to a distance L1′ between an inner side of the first drive wheel and an inner side of the second drive wheel is greater than or equal to 0.8.

A stand-on mower includes: a traveling mechanism configured to support the stand-on mower to travel on the ground; a mowing mechanism including a mowing element for performing a mowing function; a support mechanism mounted on a frame, configured to carry an operator; a power supply configured to supply power to the traveling mechanism and the mowing mechanism, the power supply including a plurality of battery packs, at least one of the plurality of battery packs being detachable; wherein the stand-on mower is configured with a minimum start-up state; in the minimum start-up state, at least one battery pack is installed and capable of providing current to the stand-on mower; and, in the minimum start-up state, a weight of the stand-on mower is less than or equal to 320 kg.

In some examples, the stand-on mower is configured with a bare machine state, in which a weight of the stand-on mower is less than or equal to 300 kg, wherein the bare machine state is a machine state after removing components defined as user-detachable from the stand-on mower.

In some examples, the stand-on mower is configured with a fully loaded state, in which a weight of the stand-on mower is less than or equal to 350 kg, wherein the fully loaded state is a state after all standard interfaces in the power supply of the stand-on mower are respectively equipped with adapted battery packs.

In some examples, at least one battery pack has a capacity greater than or equal to 40 Ah.

In some examples, in the minimum start-up state, at least one battery pack is installed to perform a work function other than starting the mowing mechanism.

In some examples, at least one battery pack includes a plurality of battery cells, and the battery cells include lithium iron phosphate battery cells.

In some examples, a maximum cutting width of the mowing mechanism is less than or equal to 40 inches.

A stand-on mower includes: a traveling mechanism configured to support the stand-on mower to travel on the ground; a mowing mechanism including a mowing element for performing a mowing function; a support mechanism mounted on a frame, configured to carry an operator; a power supply configured to supply power to the traveling mechanism and the mowing mechanism, the power supply including a plurality of battery packs, at least one of the plurality of battery packs being detachable; wherein the stand-on mower has a minimum start-up state; in the minimum start-up state, at least one battery pack is installed and capable of supplying power to the traveling mechanism to implement a traveling function of the stand-on mower; and, in the minimum start-up state, a weight of the stand-on mower is less than or equal to 320 kg.

In some examples, the stand-on mower is configured with a bare machine state, in which a weight of the stand-on mower is less than or equal to 300 kg, wherein the bare machine state is a machine state after removing components defined as user-detachable from the stand-on mower.

A stand-on mower includes: a traveling mechanism configured to support the stand-on mower to travel on the ground; a frame configured to mount the traveling mechanism, the frame including a first longitudinal beam and a second longitudinal beam extending in a front-rear direction; a mowing mechanism including a mowing element for performing a mowing function; a power supply configured to supply power to at least the traveling mechanism and the mowing mechanism; a circuit board assembly at least partially disposed between the first longitudinal beam and the second longitudinal beam in a left-right direction; a mounting member connected to the frame; the mounting member being configured to mount the circuit board assembly and being movable relative to the frame.

In some examples, the frame further includes a cross beam extending in a second direction; the mounting member is disposed on the cross beam, and the mounting member is movable relative to the cross beam.

In some examples, the mounting member is rotatable relative to the frame about a first axis.

In some examples, the first axis is not higher than the frame.

In some examples, the circuit board assembly includes a printed circuit board and a housing assembly accommodating the printed circuit board; an angle α′ between an extension direction of the housing assembly and an extension direction of the first longitudinal beam is greater than or equal to 20° and less than or equal to 80°.

In some examples, the circuit board assembly includes a first circuit board assembly, the first circuit board assembly includes a power supply management board configured to manage discharge of the power supply; and further includes a second circuit board assembly including a drive circuit board configured to at least control the traveling mechanism.

In some examples, the mounting member is configured to mount the first circuit board assembly and rotate relative to the frame.

In some examples, the first circuit board assembly is rotatable relative to the second circuit board assembly.

A stand-on mower includes: a traveling mechanism configured to support the stand-on mower to travel on the ground; a frame configured to mount the traveling mechanism, the frame including a first longitudinal beam and a second longitudinal beam extending in a front-rear direction; a mowing mechanism including a mowing element for performing a mowing function; a power supply configured to supply power to at least the traveling mechanism and the mowing mechanism; a circuit board assembly at least partially disposed between the first longitudinal beam and the second longitudinal beam in a left-right direction; a mounting member mounted on the frame and rotatable relative to the frame about a first axis; and, in a height direction, the first axis is not higher than the frame.

In some examples, the circuit board assembly includes a printed circuit board and a housing assembly accommodating the printed circuit board; an angle α′ between an extension direction of the housing assembly and an extension direction of the first longitudinal beam is greater than or equal to 20° and less than or equal to 80°.

An outdoor mowing device includes: a traveling mechanism configured to support the outdoor mowing device to travel on the ground; a frame configured to mount the traveling mechanism; a mowing mechanism including a mowing element for performing a mowing function; a power supply configured to supply power to at least the traveling mechanism and the mowing mechanism, the power supply including a plurality of battery packs; an operating mechanism configured to be operated by an operator to change a working state of the outdoor mowing device; a cooling device powered by the power supply and attached to the operating mechanism to lower a temperature of the operating mechanism.

In some examples, the operating mechanism includes an operating lever and a height adjustment handle, wherein the operating lever controls forward, backward, and turning of the stand-on mower, and the height adjustment handle is connected to a height adjustment mechanism to adjust a distance of the mowing mechanism as a whole from the ground.

In some examples, the operating mechanism includes an operating region for the user to stably grip.

In some examples, the cooling device is connected to the power supply via a wire harness.

In some examples, the cooling device includes a cooling element and a heat sink for dissipating heat from a hot side of the cooling element.

In some examples, the cooling element is directly attached or fixedly mounted to an outer surface of the operating mechanism, and a cold side of the cooling element is in close contact with a user grip region.

In some examples, the operating mechanism is at least partially hollow, and the cooling element is arrangeable in an internal cavity of the operating mechanism.

An outdoor mowing device includes: a traveling mechanism configured to support the outdoor mowing device to travel on the ground; a frame configured to mount the traveling mechanism; a mowing mechanism including a mowing element for performing a mowing function; a power supply configured to supply power to at least the traveling mechanism and the mowing mechanism, the power supply including a plurality of battery packs; an operating mechanism having an operating region, configured to be operated by an operator to change a working state of the outdoor mowing device; a temperature reduction device capable of establishing a heat transfer relationship with the operating region of the operating mechanism to absorb heat from the operating region.

In some examples, the temperature reduction device is capable of generating a thermoelectric effect or a phase change effect.

In some examples, the operating mechanism includes an operating lever and a height adjustment handle, wherein the operating lever controls forward, backward, and turning of the stand-on mower, and the height adjustment handle is connected to a height adjustment mechanism to adjust a distance of the mowing mechanism as a whole from the ground.

A stand-on mower includes: a traveling mechanism configured to support the stand-on mower to travel on the ground; a frame configured to mount the traveling mechanism; a mowing mechanism including a mowing element for performing a mowing function; a power supply configured to supply power to at least the traveling mechanism and the mowing mechanism; a circuit board assembly configured to at least control the traveling mechanism or the mowing mechanism; a central control mechanism including a console for a user to operate to control the stand-on mower; the central control mechanism includes a housing, the housing surrounds to form an accommodating space, and at least a portion of the circuit board assembly is disposed in the accommodating space; and an air vent is formed on the housing to allow airflow to enter the housing through the air vent to dissipate heat from the circuit board assembly when the stand-on mower is traveling.

In some examples, the frame includes a first longitudinal beam and a second longitudinal beam extending in a front-rear direction; the circuit board assembly, in a left-right direction, is at least partially disposed between the first longitudinal beam and the second longitudinal beam.

In some examples, in the front-rear direction, the air vent is located at a front side of the circuit board assembly.

In some examples, in the front-rear direction, the circuit board assembly is located at a rear of the power supply.

In some examples, the power supply includes a battery pack and a battery compartment accommodating the battery pack, the circuit board assembly is located at a rear of the battery compartment, and the air vent is located at a rear of the battery compartment.

In some examples, in an up-down direction, the air vent is at least partially located above the battery compartment.

In some examples, the circuit board assembly includes a printed circuit board and a housing assembly accommodating the printed circuit board; an angle α′ between an extension direction of the housing assembly and an extension direction of the first longitudinal beam is greater than or equal to 20° and less than or equal to 80°.

In some examples, the circuit board assembly includes a first circuit board assembly, the first circuit board assembly includes a power supply management board configured to manage discharge of the power supply; and further includes a second circuit board assembly including a drive circuit board configured to at least control the traveling mechanism.

In some examples, a support mechanism is mounted on the frame, configured to carry an operator, and the support mechanism is at least partially located at a rear of the central control mechanism.

A stand-on mower includes: a traveling mechanism configured to support the stand-on mower to travel on the ground; a frame configured to mount the traveling mechanism; the frame including a first longitudinal beam and a second longitudinal beam extending in a front-rear direction; a mowing mechanism including a mowing element for performing a mowing function; a power supply configured to supply power to at least the traveling mechanism and the mowing mechanism; a circuit board assembly configured to at least control the traveling mechanism or the mowing mechanism; in a width direction, disposed between the first longitudinal beam and the second longitudinal beam; a central control mechanism including a console for a user to operate to control the stand-on mower; the central control mechanism includes a housing, the housing surrounds to form an accommodating space, and at least a portion of the circuit board assembly is disposed in the accommodating space; and the housing includes an air vent, and in the front-rear direction, the air vent is located at a front side of the circuit board assembly.

### BRIEF DESCRIPTION OF DRAWINGS

FIG. 1 is an external view of a riding lawn mower from a perspective;

FIG. 2 is an external view of the riding lawn mower from another perspective;

FIG. 3A is a communication system of the riding lawn mower according to an example;

FIG. 3B is a communication system of the riding lawn mower according to another example;

FIG. 4 is a schematic diagram of a connection of negative terminals of various modules of the riding lawn mower according to an example;

FIG. 5 is a structural diagram of an electric control system of an example of the riding lawn mower from a perspective;

FIG. 6 is a structural diagram of the electric control system of the example of the riding lawn mower from another perspective;

FIG. 7 is a first heat sink of the riding lawn mower;

FIG. 8 is a structural diagram of the riding lawn mower from another perspective;

FIG. 9A is a structural diagram of a circuit board including a cover from a perspective;

FIG. 9B is a structural diagram of the circuit board including the cover from another perspective;

FIG. 10 is a structural diagram of the circuit board and the cover separated from each other from a perspective;

FIG. 11 is a structural diagram of the circuit board and the cover separated from each other from another perspective;

FIG. 12 is a perspective view of a riding mower.

FIG. 13 is a perspective view taken from another angle to illustrate the riding mower of

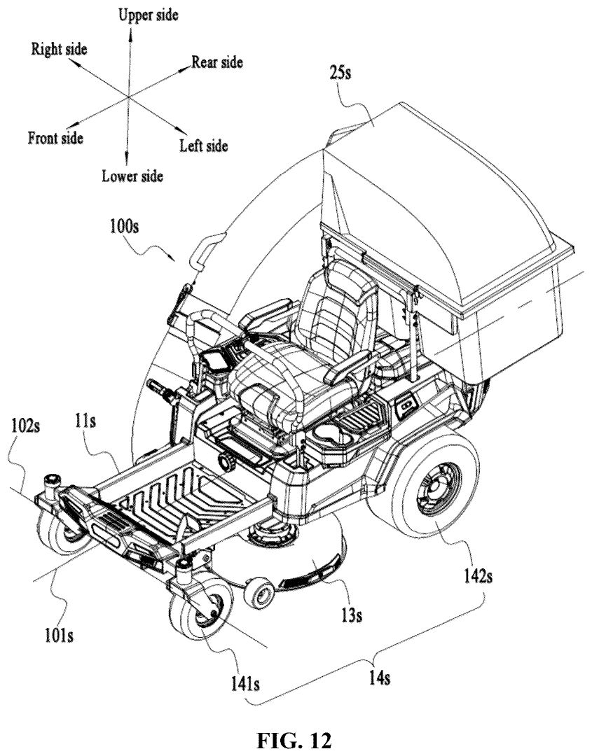

FIG. 12 without a grass catcher.

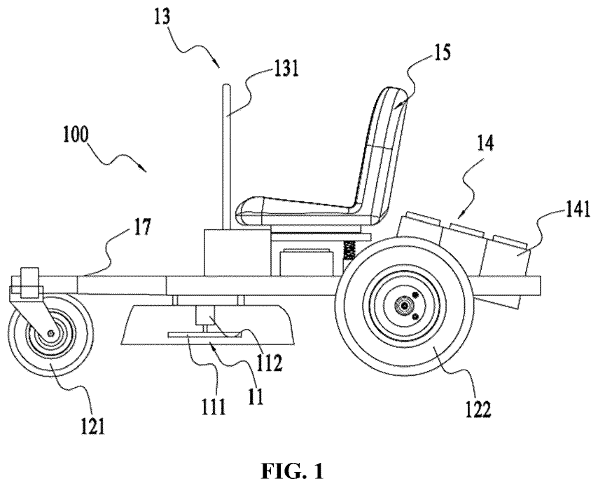

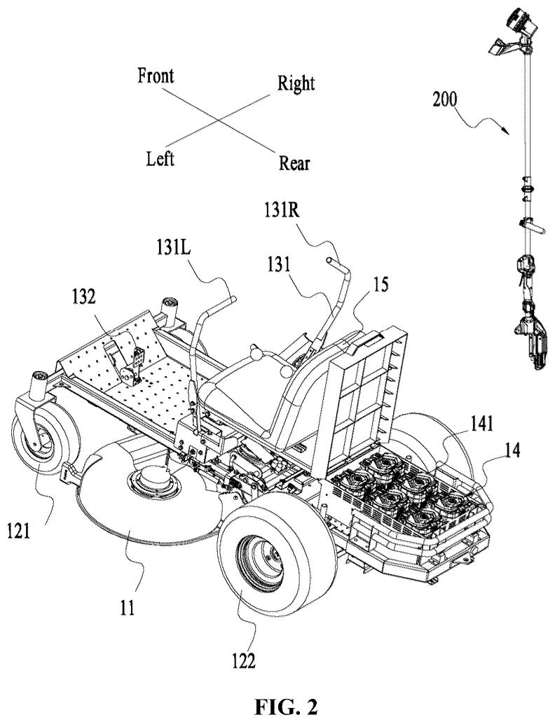

FIG. 14 is a perspective view illustrating a power supply apparatus of the riding mower of FIG. 1 is disposed on a main frame of the riding mower of FIG. 12

FIG. 15 is a perspective view of the power supply apparatus of the riding mower of FIG. 12.

FIG. 16 is an exploded view of the connection relationship between the power supply apparatus of the riding mower of FIG. 14 and the main frame of the riding mower of FIG. 14.

FIG. 17 is a perspective view illustrating that a compartment cover of the power supply apparatus of the riding mower of FIG. 15 is opened.

FIG. 18 is a partial enlarged view of position A of the riding mower of FIG. 17.

FIG. 19 is an exploded view of the power supply apparatus of the riding mower of FIG. 17.

FIG. 20 is an exploded view of the power supply apparatus of the riding mower of FIG. 19 from another perspective.

FIG. 21 is a perspective view of a fastener of the power supply apparatus of the riding mower of FIG. 20.

FIG. 22 is a partial enlarged view of position B of the riding mower of FIG. 20.

FIG. 23 is a section view of the power supply apparatus of the riding mower of FIG. 15.

FIG. 24 is a partial enlarged view of position C of the riding mower of FIG. 23.

FIG. 25 is an exploded view of the compartment cover of the power supply apparatus of the riding mower of FIG. 19.

FIG. 26 is an exploded view taken from another angle to illustrate the compartment cover of the power supply apparatus of the riding mower of FIG. 25.

FIG. 27 is a perspective view illustrating the main frame of the riding mower of FIG. 12 is connected to a traveling assembly of the riding mower of FIG. 12.

FIG. 28 is a perspective view of second traveling wheels of the riding mower of FIG. 27 and drive assemblies disposed on the second traveling wheels.

FIG. 29 is a rear view of the second traveling wheels of the riding mower of FIG. 28 and the drive assemblies disposed on the second traveling wheels.

FIG. 30 is a partial enlarged view of position D of the riding mower of FIG. 28.

FIG. 31 is a section view of part of a second traveling wheel of the riding mower of FIG. 28 and part of the drive assemblies disposed on the second traveling wheel.

FIG. 32 is a partial enlarged view of position E of the riding mower of FIG. 31.

FIG. 33 is an exploded view of part of a second traveling wheel of the riding mower of FIG. 28 and part of the drive assemblies disposed on the second traveling wheel.

FIG. 34 is a perspective view of a retainer of the riding mower of FIG. 33.

FIG. 35 is a partial enlarged view of position F of the riding mower of FIG. 33.

FIG. 36 is an exploded view of an output shaft of the riding mower of FIG. 33.

FIG. 37 is a top view of the riding mower of FIG. 12 with a seat and part of a cover excluded.

FIG. 38 is a perspective view illustrating a control module is mounted on the main frame of the riding mower of FIG. 37.

FIG. 39 is a top view illustrating the control module is mounted on the main frame of the riding mower of FIG. 33.

FIG. 40 is a partial enlarged view of position G of the riding mower of FIG. 39.

FIG. 41 is a perspective view of the main frame of the riding mower of FIG. 37.

FIG. 42 is a front view of a parking system of the riding mower of FIG. 12.

FIG. 43 is a front view of a parking system of the riding mower of FIG. 42.

FIG. 44 is a front view of a rotation stop system of the riding mower of FIG. 12.

FIG. 45 is a side structural view of a stand-on mower as an example of the present application.

FIG. 46 is a partial structural view of the stand-on mower as an example of the present application from another angle.

FIG. 47 is a partial front structural view of the stand-on mower as an example of the present application.

FIG. 48 is a view illustrating that a power supply is adapted to different power tools as an example of the present application.

FIG. 49 is a structural view of a circuit board assembly as an example of the present application, wherein a first circuit board assembly is in a first position.

FIG. 50 is a structural view of a second circuit board assembly as an example of the present application.

FIG. 51 is a structural view of the circuit board assembly as an example of the present application, wherein the first circuit board assembly is in a second position.

FIG. 52 is a partial front structural view of the stand-on mower as an example of the present application.

FIG. 53 is a structural view of a central control mechanism of the stand-on mower as an example of the present application.

FIG. 54 is a structural view of a cooling device as an example of the present application.

FIG. 55 is a view of a phase change material as an example of the present application.

FIG. 56 is a view of an installation manner of a temperature reduction device as an example of the present application.

FIG. 57 is a structural view of a battery compartment mounted on a frame as an example of the present application, wherein a compartment cover is closed.

FIG. 58 is a structural view of the battery compartment mounted on the frame as an example of the present application, wherein the compartment cover is open.

FIG. 59 is a structural view of the battery compartment mounted on the frame as an example of the present application, showing the compartment cover at a stop point and a closed position respectively.

FIG. 60 is an exploded view of the compartment cover of the battery compartment as an example of the present application.

FIG. 61 is a side structural view as an example of the stand-on mower of the present application, with the battery compartment removed.

FIG. 62 is a bottom view of a mowing mechanism as an example of the present application.

FIG. 63 is a structural view of a height adjustment mechanism as an example of the present application, wherein the height adjustment mechanism is in a second state.

FIG. 64 is a structural view of the height adjustment mechanism as an example of the present application, wherein the height adjustment mechanism is in a first state.

FIG. 65 is a structural view of an assist assembly as an example of the present application.

FIG. 66 is a structural view of a limiting assembly as an example of the present application.

FIG. 67 is a half-sectional view of FIG. 66.

FIG. 68 is a partial enlarged view of M in FIG. 53.

FIG. 69 is a partial structural view of a standing platform as an example of the present application, wherein a user is standing on the standing platform.

FIG. 70 is a partial structural view of the standing platform as an example of the present application, wherein no user is standing on the standing platform.

FIG. 71 is a structural view of the standing platform from another angle as an example of the present application.

FIG. 72 is a view of part of components of the standing platform as an example of the present application.

FIG. 73 is a structural view of the standing platform from another angle as an example of the present application, wherein a connecting piece is disposed inside a foot pedal.

FIG. 74 is a structural view of the standing platform from another angle as an example of the present application, wherein the connecting piece is disposed outside the foot pedal.

FIG. 75 is a view showing an installation position of a front lighting assembly in a stand-on mower according to an example of the present application.

FIG. 76 is a partial exploded view of the front lighting assembly of FIG. 75.

FIG. 77 is a schematic half-sectional view of the front lighting assembly of FIG. 75.

FIG. 78 is a structural view of a central control mechanism of a stand-on mower as another example of the present application.

FIG. 79 is a control flow chart of a stand-on mower as another example of the present application.

### DETAILED DESCRIPTION

Those skilled in the art should understand that, in the disclosure of this application, the terms “up”, “down”, “front”, “rear”, “left”, “right” and the like indicate the orientation or positional relationship based on the orientation or positional relationship shown in the drawings, which are only for the convenience of describing the present application, and do not indicate or imply that the device or element referred to must have a specific orientation, or be constructed and operated in a specific orientation, and therefore the above terms should not be understood as a limitation of the present application.

Referring to FIG. 1, a riding lawn mower 100 includes: a power output assembly 11, a walking assembly 12, an operating component 13, a power supply assembly 14, a seat 15, a chassis 16, and a lighting assembly 17.

The chassis 16 is configured to carry the seat 15, and the chassis 16 at least partially extends in a front and rear direction; the seat 15 is for an operator to sit on, and the seat 15 is mounted on the chassis 16.

For the convenience of description, the direction in which the operator sits on the seat is defined as the front or the front side of the riding lawn mower, and the direction opposite to the front is defined as the rear or rear side of the riding lawn mower, and the operator's left hand direction is defined as the left or left side of the riding lawn mower 100, and the operator's right hand direction is defined as the right or right side of the riding lawn mower 100.

The power output assembly 11 includes an output member for outputting power to achieve certain mechanical function. For example, in this example, the output member may be a mowing element 111 for achieving a mowing function, and the power output assembly 11 is also connected to the chassis 16. The power output assembly 11 also includes a cutting motor 112 for driving the mowing element 111 to rotate at a high speed and a cutting control module 113 for controlling the cutting motor 112. The power output assembly 11 may include more than one mowing element 111, and correspondingly, the number of cutting motors 112 may correspond to the number of mowing elements 111. The cutting motors 112 are controlled by the cutting control module 113. In some specific examples, the cutting control module 113 includes a control chip, such as MCU, ARM, and so on.

In order to obtain a better mowing effect, optionally, the power output assembly 11 may include two mowing elements 111, and correspondingly, two cutting motors 112, namely a left cutting motor 112L and a right cutting motor 112R. Optionally, the two cutting motors 112 are respectively controlled by two cutting control modules 113, and the two cutting control modules 113 are a left cutting control module 113L and a right cutting control module 113R, respectively. That is, the power output assembly 11 includes two cutting control modules 113 and cutting two motors 112. Alternatively, the power output assembly 11 may include only one cutting control module 113, which controls two cutting motors 112 at the same time.

The walking assembly 12 is configured to enable the riding lawn mower 100 to walk on the lawn. The walking assembly 12 may include first walking wheels 121 and second walking wheels 122, the number of the first walking wheels 121 is two, and the number of the second walking wheels 122 is also two, including a left drive wheel 122L and a right drive wheel 122R. The walking assembly 12 may also include walking motors 123 for driving the second walking wheels 122, and the number of walking motors 123 is also two, namely a left walking motor 123L and a right walking motor 123R, respectively. In this way, when the two walking motors 123 drive the corresponding second walking wheels 122 to rotate at different speeds, a speed difference is generated between the two second walking wheels 122, so as to steer the riding lawn mower 100. The walking assembly 12 includes two walking control modules 124, the two walking control modules 124 are a left walking control module 124L and a right walking control module 124R, respectively, which are used to control the left walking motor 123L and the right walking motor 123R, respectively. In some specific examples, the walking control module 124 includes a control chip, such as MCU, ARM, and so on.

The power supply assembly 14 is configured to provide electric power for the riding lawn mower 100. Optionally, the power supply assembly 14 is configured to at least supply power to the cutting motors 112 and the walking motors 123, and the power supply assembly 14 may also supply power to other electronic components in the riding lawn mower 100, such as the cutting control module 113 and the walking control module 124.

In some examples, the power supply assembly 14 is provided on the rear side of the seat 15 on the chassis 16. In some examples, the power supply assembly 14 includes a plurality of battery packs 141 capable of supplying power to the power tool 200. The battery packs 141 are configured to be pluggably mounted to the riding lawn mower 100 by the user. The installation and removal of the battery packs 141 by plugging and unplugging makes the operation more convenient and also the placement of the battery packs 141 more accurate. Optionally, the battery pack 141 includes a plurality of battery cells connected in series, in parallel, or in a combination of series and parallel. A plurality of battery cells are coupled in a battery casing to form a whole, and the battery cell may be a lithium battery cell. The power tool 100 may be a gardening tool such as a string trimmer, a hedge trimmer, a blower, a chain saw, etc., and may also be a torque output tool such as an electric drill, an electric hammer, etc., and may also be a sawing tool such as an electric circular saw, a jig saw, and a reciprocating saw, etc., and may also be a grinding tool such as an angle grinder, a sanding machine, etc. In some other examples, the battery pack 141 may also be configured to power a hand-push power tool, such as a hand-push lawn mower, a hand-push snow blower, and so on. In this way, the battery pack 141 applied to the riding lawn mower of the present application can be unplugged by the user to be applied to the above power tools. In other words, the user can also borrow the battery pack 141 in these power tools to power the riding lawn mower 100, thereby improving the versatility of the riding lawn mower 100 and reducing the usage cost. The power supply assembly 14 includes a battery compartment 144 for placing the battery packs 141. The number of battery compartment 144 may be one, which stores multiple battery packs 141, or may be multiple, for example, the same as the number of battery packs 141, wherein each battery compartment 144 stores one battery pack 141.

The power supply assembly 14 further includes a power supply management module 142 for controlling the operation of the power supply assembly 14. In this example, the power supply management module 142 is configured to control the safe discharge of the plurality of battery packs 141, so that the riding lawn mower 100 can operate normally. In some specific examples, the power supply management module 142 includes a control chip, such as MCU, ARM, and so on.

The riding lawn mower 100 further includes a walking control module 124 for controlling the walking process of the riding lawn mower 100. The walking control module 124 is at least used to control the walking motors 123 of the walking assembly 12 to control the walking process of the riding lawn mower 100. The walking control module 124 can control the walking motors 123 to start.

The operating component 13 is operable by the user, and the user sends control instructions through the operating component 13 to control the operation of the riding lawn mower 100. The operating component 13 can be operated by the user to set the target speed, travel direction, etc. of the riding lawn mower 100. In other words, the operating component 13 can be operated by the user to set the target operating state of the riding lawn mower 100. The operating component 13 includes an operating mechanism 131 and an operation sensing module 132 enabled to sense changes in the state of the operating mechanism.

In some specific examples, the operating mechanism 131 includes at least one operating lever, and the operation sensing module 132 includes at least one position sensor. The operating lever may be arranged on either sides or a periphery of the seat 15. Different positions of the operating lever correspond to different target states of the riding lawn mower. By pushing the operating lever to the target positions, the user controls the riding lawn mower 100 to reach the target states corresponding to the target positions reached by the operating lever, including the traveling direction, traveling speed, parking, braking, deceleration, etc. In a specific example, the operating levers include a left operating lever 131L and a right operating lever 131R, and the walking motors 123 include the left walking motor 123L and the right walking motor 123R. The left operating lever and the right operating lever are used to respectively control the left walking motor 123L and the right walking motor 123R, so as to respectively control the two second walking wheels 122. The position sensor is configured to detect the position of the operating lever. When the operating lever is in different positions, the position sensor outputs detected signals representing different positions.

The operating mechanism 131 may further include at least one switch triggerable to change its state so as to set the riding lawn mower 100 in different target states. The operation sensing module 132 includes a switch state detection assembly, and the switch state detection assembly is configured to detect the state of at least one switch. For example, a seat switch arranged under the seat 15 can sense the user sitting on the seat or leaving the seat; a start switch can start the riding lawn mower 100 when the user presses this switch; a key switch start or stop the walking motor 123 when the user inserts the key and rotates to the on position or the off position. The switch state detection assembly can detect the different states of each switch and send the detected information to the required module.

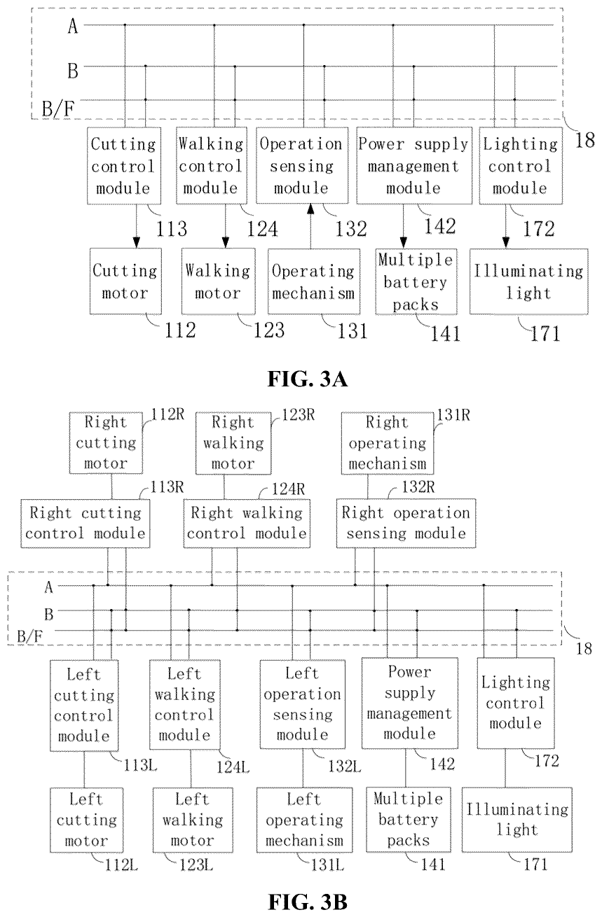

The operating mechanism of the operating component 13 may also include a combination of one or more operating mechanisms such as a pedal, a switch, a handle, and a steering wheel, for example, the manual operating lever, combined with a foot brake pedal, a speed pedal and a steering wheel is configured for the user to operate the riding lawn mower 100. The operating component 13 may also be a control panel, which includes a plurality of buttons, and different buttons correspond to different control commands. The user inputs different control commands through the switch to control the walking motor 123 of the walking assembly 12. Refer to the communication system of the riding lawn mower 100 according to an example shown in FIG. 3A, the riding lawn mower 100 further includes a bus module 18, and the bus module 18 is connected with a variety of modules, for example, the bus module 18 is at least connected with the cutting control module 113, the walking control module 124, the operation sensing module 132, the power supply management module 142 in order to transmit data between the cutting control module 113, the walking control module 124, the operation sensing module 132, and the power supply management module 142. The cutting control module 113, the walking control module 124, the operation sensing module 132, and the power supply management module 142 can all send data to the bus module 18 and receive data through the bus module 18. When sending data, these modules cannot send data at the same time. At most one device can send data at any time. Each device may obtain the bus control right to send data by competing for the busy line B/F, and the module that obtains the bus control right realize occupation and release of the bus through a “busy bus” signal and an “idle bus” signal. When receiving data, all modules can receive information from the bus module 18, and determine of the information is related to themselves, if yes, then perform corresponding processing, if not, continue the original work. Optionally, the riding lawn mower 100 further includes a lighting assembly for illuminating functions; a lighting control module 172 for controlling the operation of the illuminating light 171, and the lighting control module 172 is connected to the bus module 18. The lighting control module 172 controls the illuminating light 171 to turn on upon receiving a signal that requires lighting.

In an example, the user expects the riding lawn mower 100 to go straight forward at a maximum speed. In a specific implementation, the user operates the operating mechanism 131 to a certain state and issues a command to go straight forward at the maximum speed; the operation sensing module 132 detects command to go straight forward at the maximum speed, which corresponds to the current state of the operating lever of the operating mechanism 131, and sends detected information including the position of the operating lever to the bus module 18; the bus module 18 broadcasts the information to all modules connected to the bus module 18; the walking control module 124, the cutting control module 113, the operation sensing module 132 and the power supply management module 142 receive the information including the position of the operating lever through the bus, and determine the data is related to themselves. At this time, the cutting control module 113 controls the cutting motor to stop working; and according to the acquired signal of the operation sensing module 132, the two walking control modules 124 obtain the rotational speed and the rotational direction of the two walking motors 123 corresponding to the signal through calculation or lookup table. Both walking motors 123 run at the maximum forward rotational speed, so that the riding lawn mower 100 moves straight forward in accordance with the target state set by the operating mechanism.

Similarly, the user controls the riding lawn mower 100 by operating the operating mechanism 131, including controlling the mowing speed, traveling direction and speed of the riding lawn mower 100.

Referring to a communication system of the riding lawn mower 100 according to another example as shown in FIG. 3B, which is different from the communication system of the riding lawn mower shown in FIG. 3A in that: there are two cutting control modules 113, namely a left cutting control module 113L and a right cutting control module 112R, which are respectively configured to control a left cutting motor 112L and a right cutting motor 112R; there are two walking control modules 124, namely a left walking control module 124L and a right walking control module 124R, which are respectively configured to control a left walking motor 123L and a right walking motor 123R; there are two operating mechanisms 131 and two operation sensing modules 132: a left operating mechanism 131L configured to control a left walking motor 123L, and a right operating mechanism 131R configured to control a right walking motor 123R, a left operation sensing module 132L configured to sense the state of the left operating mechanism 131L, and a right operation sensing module 132R configured to sense the state of the right operating mechanism 131R.

In an example, when braking is needed, if the left walking motor 123L has a braking abnormality, the left walking control module 124L sends a signal to the bus module 18, and other modules can receive information on the braking abnormality of the left walking motor 123L from the bus module 18. After receiving the braking abnormality signal, the right walking control module 124R still controls the right walking motor 123R to brake normally. Optionally, when any one of the walking motors has a braking abnormality, the parking mode is automatically triggered, and the riding lawn mower 100 enters the parking mode. This can ensure that the riding lawn mower 100 is parked and stopped when there is a braking abnormality, thereby reducing the occurrence of safety accidents.

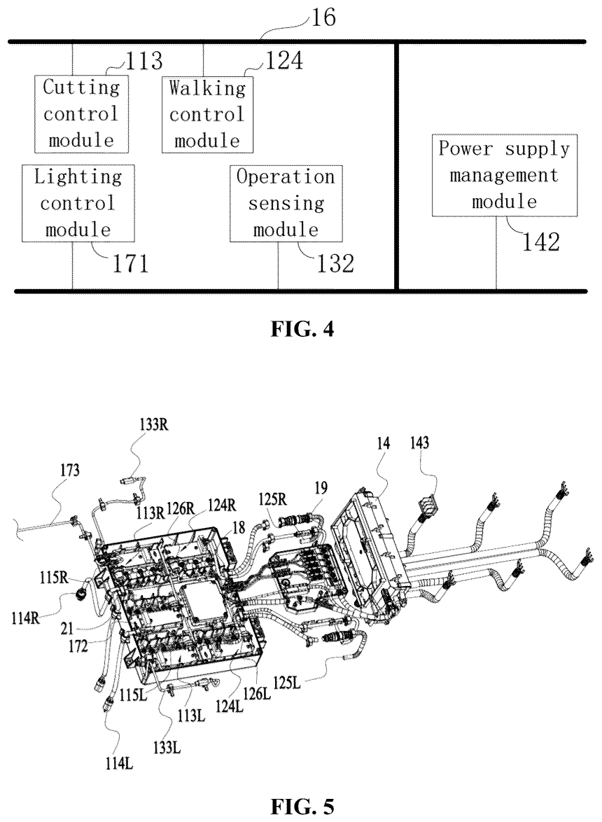

Referring to FIG. 4, in an example, the chassis 16 is made of a metallic material, the negative terminals of at least the cutting control module 113, the walking control module 124, and the power supply management module 142 are connected with the chassis 16. The negative terminals of other modules may also be connected to the chassis, including the lighting control module 172 and the operation sensing module 132. In this way, the chassis 16 could be used as the negative terminal of the electric control system of the riding lawn mower 100, which reduces the wiring and cost, and facilitates assembly.

Referring to FIG. 5, according to an example of the riding lawn mower 100, the electric control system includes the left cutting control module 113L, the right cutting control module 113R, the left walking control module 124L, the right walking motor control module 124R, the bus module 18, the power supply management module 142, the left operation sensing module, the right operation sensing module, and a power supply positive junction box 25. Optionally, the lighting control module 172 is also included.

The left cutting control module 113L is configured to control the left cutting motor 112L. The right cutting control module 113R is configured to control the right cutting motor 112R. The left walking control module 124L is configured to control the left walking motor 123L. The right walking control module 124R is configured to control the right walking motor 123R.

The power supply management module 142 is configured to coordinate and control the discharge process of at least one battery pack 141. The electric energy discharged by the at least one battery pack 141 is distributed to other modules through the power supply positive junction box 25, for example, the left cutting control module 113L, the right cutting control module 113R, the left walking control module 124L, the right walking motor control module 124R, the bus module 18 and so on.

The bus module 18 is in commutation connection with the left cutting control module 113L, the right cutting control module 113R, the left walking control module 124L, the right walking control module 124R, the power supply management module 142, the left operation sensing module (not shown), and the right operation sensing module (not shown), the power supply positive junction box 25 and the lighting control module 172.

The riding lawn mower 100 includes at least one circuit board 19 for installing the cutting control module 113, the walking control module 124, and the power supply management module 142, and optionally, the operation sensing module, the bus module 18 and the illuminating light 171. The circuit board 19 is provided with electronic components, and the electronic components include a controller, a hardware circuit that cooperates with the controller, and the like.

Optionally, the riding lawn mower 100 includes a plurality of circuit boards 19 for respectively installing the cutting control module 113, the walking control module 124, the operation sensing module 132, the power supply management module 142, and the bus module 18. Each of the circuit boards is arranged separately. The advantage is that the above-mentioned modules are separately arranged on different circuit boards, which is convenient for installation and disassembly, facilitates independent maintenance, and reduces maintenance costs.

As an optional solution, the left cutting control module 113L, right cutting control module 113R, left walking control module 124L, right walking control module 124R, bus module 18, power supply management module 24, left operation sensing module 132L, right operation sensing module Both the 132R and the lighting control module 27 include a circuit board, and each module is separately arranged on a plurality of different circuit boards, that is, each module is separately arranged on a circuit board. In this way, each module is self-contained, easy to install and maintain separately, and reduce maintenance costs.

Optionally, the left cutting control module 113L, the right cutting control module 113R, the left walking control module 124L, the right walking control module 124R, the bus module 18, the power supply management module 142, the left operation sensing module 132L, the right operation sensing module 132R, and the lighting control module 172 are all provided with an interface group. The interface group is provided with multiple interfaces.

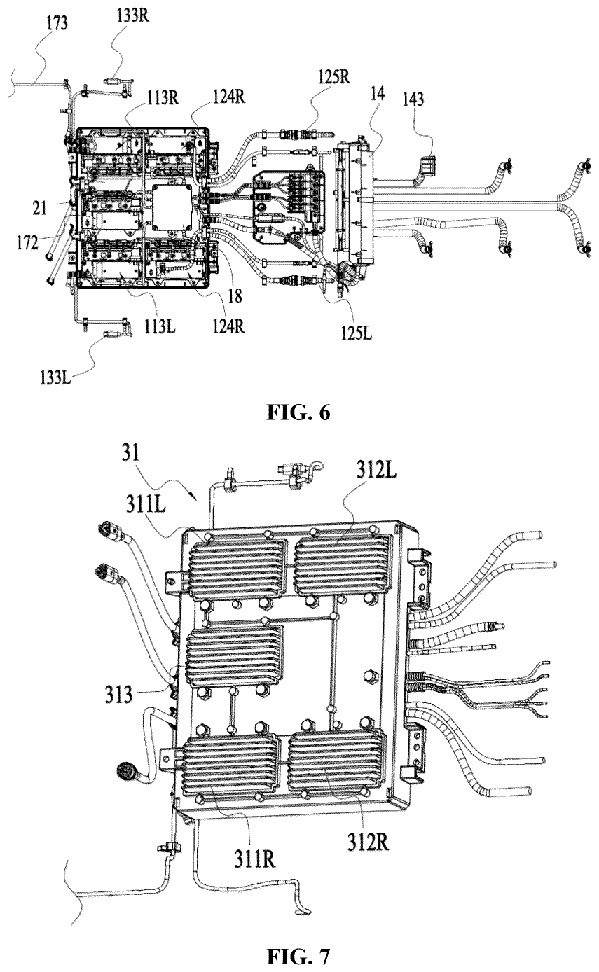

Referring to FIGS. 5 and 6, a left cutting control module 113L is provided with a left cutting motor interface 114L and a communication interface 115L, which are respectively used for connecting the left cutting motor 112L and the bus modules 18. Similarly, the right cutting control module 113R is provided with a right cutting motor interface 114R and a communication interface 115R, which are respectively used for connecting the right cutting motor 112R and the bus module 18.

The left walking control module 124L is provided with a left walking motor interface 125L and a communication interface 126L, which are respectively used for connecting the left cutting motor 123L and the bus module 18. The right cutting control module 124R is provided with a right cutting motor interface 125R and a communication interface 126R, which are respectively used for connecting the right cutting motor 123R and the bus module 18. The lighting control module 172 is provided with an interface 173 for connecting the illuminating light 171.

The power supply management module 142 is provided with a plurality of battery pack interfaces 143 for connecting with the plurality of battery packs 141. The power supply management module 142 is also provided with a bus positive output terminal, which is connected to the power supply positive junction box 25, and a plurality of positive output terminals are branched out through the power supply positive junction box 25. The plurality of positive output terminals are used to connect with the power ports of other modules to provide electric power to other modules. The power supply management module 142 is also provided with a communication interface for connecting the bus module 18 through a communication wire.

The bus module 18 is also provided with multiple interfaces, including a communication interface for connecting each module and a positive power terminal. For example, the bus module 18 is provided with a communication interface 133L for connecting the left operation sensing module 132L and a communication interface 133R for connecting the right operation sensing module 132R. The bus module 18 has a plurality of communication interfaces for connecting with the above-mentioned modules through communication wires. Optionally, the communication interface is a type-C interface to facilitate insertion and assembly.

In this way, each module can be connected to other external modules or components through an interface, so that the modules can be connected to each other through a wire and without complicated circuit design and layout, making the structure of the electric control system of the riding lawn mower 100 more compact, reliable, and simple, and making the modules easy to replace, repair and assemble.

When the interface group is provided with multiple interfaces, each interface can be connected to wires of different colors or lengths, which can effectively prevent the wires from being connected incorrectly and damaging the electrical components.

Optionally, the plurality of circuit boards and the plurality of modules are arranged under the seat 15. This has the advantage of saving space, lowering the center of gravity of the whole machine, and making the operation of the riding lawn mower safer and more stable. In this example, the left cutting control module 113L, the right cutting control module 113R, the left walking control module 124L, the right walking control module 124R, the bus module 18, and the lighting control module 172 are arranged under the seat 15, and the left operation sensing module 132L is arranged near the left operating mechanism 131L, and the right operation sensing module 132R is arranged near the right operating lever 131R.

Optionally, the power supply management module 142 may be arranged on the lower rear side of the seat 15, at a position close to the front of the battery compartment 144, to save space.

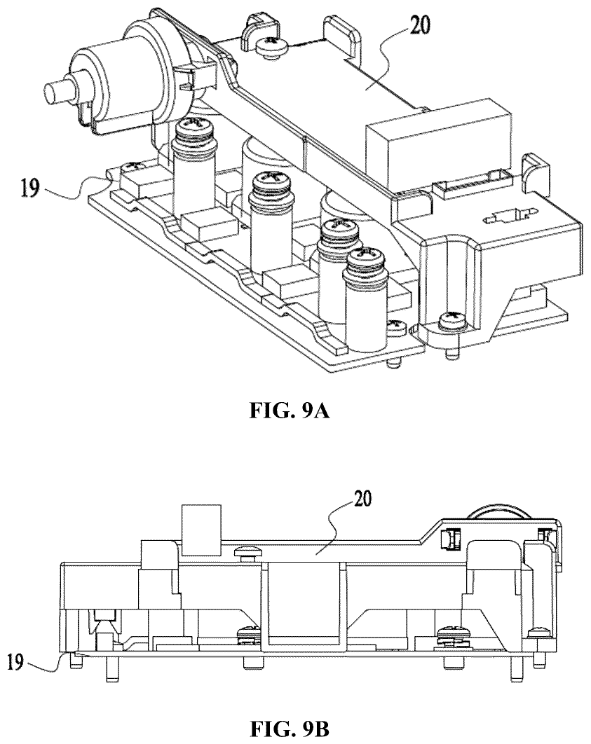

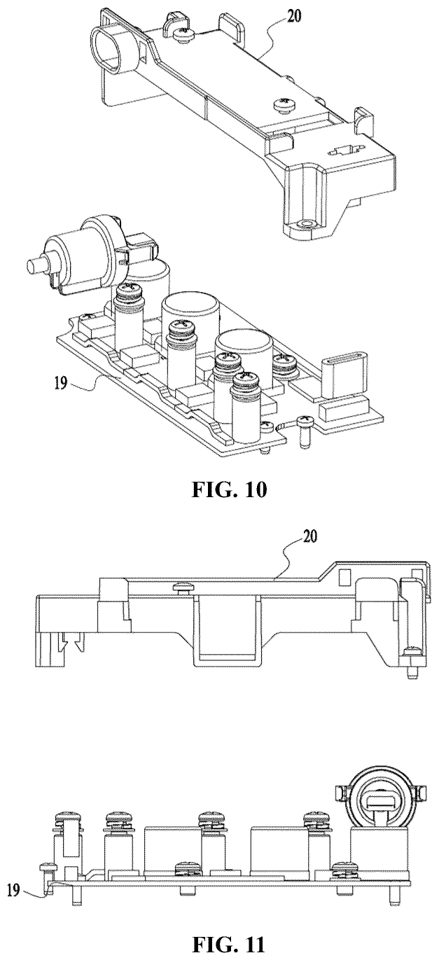

Referring to FIGS. 9-11, optionally, a detachable cover 20 is provided on the circuit board 19, the cover 20 is at least partially located above the core components on the circuit board, for example, above the controller to protect the components on the circuit board. Optionally, the cover 20 is provided in a semi-open form. In other words, the cover is not completely closed, so that external airflow can flow through the electronic components on the circuit board, which improves the cooling effect of the control module and the components.

Optionally, the riding lawn mower 100 further includes a metal plate 21, which is disposed on the lower side of at least one of the cutting control module 113, the walking control module 124, and the power supply management module 142. The negative terminal of at least one of the cutting control module 113, the walking control module 124, and the power management module 142 is connected to the metal plate.

In an optional example, the cutting control module 113 includes a left cutting control module 113L and a right cutting control module 113R, and the walking control module 124 includes a left walking control module 124L and a right walking control module 124R. The left cutting control module 113L and the left walking control module 124L share a metal plate, the right cutting control module 113R and the right walking control module 124R share a metal plate, and the bus module 18 and the lighting control module 172 share a metal plate. The power supply management module 142 uses a metal plate alone. The above-mentioned left cutting control module 113L, right cutting control module 113R, left walking control module 124L, right walking control module 124R, bus module 18, and lighting control module 172 can all share a metal plate, that is, the negative terminals of the above modules are all connected to the same metal plate.

Optionally, the metal plate is made of aluminum material. The advantage is that the negative terminal of each module can be connected through the metal plate 21, thereby reducing the wiring, simplifying the wiring difficulty, reducing the cost, and facilitating maintenance.

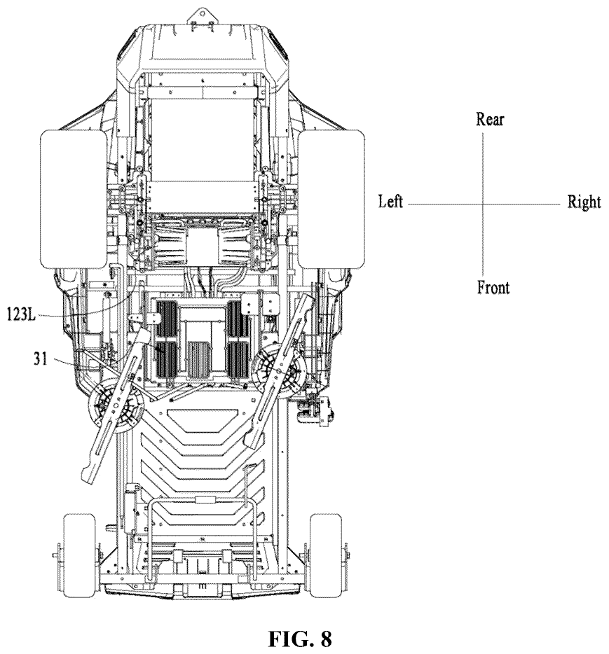

Referring to FIGS. 5-8, the riding lawn mower 100 includes a heat sink for cooling the electrical control system. Optionally, the riding lawn mower 100 includes a first heat sink 31, which is located close to the cutting control module 113 and/or the walking control module 124 and faces the ground, which is mainly used to cool the controller in the control module and the electronic components that generate heat.

The first heat sink 31 includes a plurality of cooling fins, and the plurality of cooling fins are vertically arranged at the bottom of the circuit board of the cutting control module 113 and/or the walking control module 124 to increase the cooling area. The cooling fins are arranged in parallel with the front and rear direction of the riding lawn mower. When the riding lawn mower 100 is walking, the airflow flows through the cooling fins, creating a good cooling effect.

In an alternative example, the cutting control module 113 includes a left cutting control module 113L and a right cutting control module 113R, the walking control module 124 includes a left walking control module 124L and a right walking control module 124R, and the first heat sink 31 includes a left cutting heat sink 311L, a right cutting heat sink 311R, a left walking heat sink 312L and a right walking heat sink 312R, wherein the left cutting heat sink 311L is disposed on the lower side of the left cutting control module 113L, and the right cutting heat sink 311R is disposed on the lower side of the right cutting control module 113R, the left walking heat sink 312L is disposed on the lower side of the left walking control module 124L, and the right cutting heat sink 311R is disposed on the lower side of the right walking control module 124R.

Optionally, the first heat sink 31 further includes a lighting control heat sink 313, which is disposed on the lower side of the lighting control module 172 for cooling the lighting control module 172.

The first heat sink 31 is disposed facing the ground. In the example with the metal plate 21, the first heat sink 31 is disposed on the lower side of the metal plate 21. When the riding lawn mower 100 is walking, the airflow flows through the first heat sink 31 to take away the heat of the first heat sink 31 and the above-mentioned control module, creating a good cooling effect. The number of first heat sinks 31 of the riding lawn mower 100 can be configured according to actual cooling requirements.

Optionally, the riding lawn mower 100 includes a second heat sink 32, and the second heat sink 32 is disposed close to the power supply management module 142 and facing the front of the riding lawn mower 100.

The second heat sink 32 includes a plurality of cooling fins, and the plurality of cooling fins are vertically arranged at the bottom of the circuit board of the power supply management module 142 facing the front of the riding lawn mower 100 to increase the cooling area. The cooling fins are arranged substantially in parallel with the up and down direction of the riding lawn mower. When the riding lawn mower 100 is walking, the airflow flows through the cooling fins, creating a good cooling effect.

The second heat sink 32 is used for cooling the power supply management module 142 and is mainly used for the controller in the power supply management module and the electronic components that are prone to generate heat. When the riding lawn mower 100 travels forward, the airflow from the front of the riding lawn mower 100 flows through the second heat sink 32, taking away the heat from the power supply management module 142 and the second heat sink 32, creating a good cooling effect.

An electric riding machine shown in FIG. 12 may be an electric machine for working indoors or outdoors. In this example, a riding mower 100s is taken as an example of the electric riding machine. A user can sit on the riding mower 100s to control the riding mower 10 to trim, for example, a lawn and vegetation.

It is to be understood that the electric riding machine may also be a tool of another type. The electric riding machine may be an electric riding vehicle, for example, an all-terrain vehicle or a golf cart. Alternatively, the electric riding machine may be an electric riding tool with its function implemented through outputting a certain form of power, for example, a riding snowplow or a riding agricultural machine. Of course, it is to be understood that the electric riding machine may be a tool for other purposes, for example, a riding mopping vehicle or a riding forklift. In fact, as long as including the substantive content of the description hereinafter in the present application, these tools all fall within the scope of the present application.

To facilitate the description of technical solutions in the present application, a riding mower is taken as an example. Moreover, a front side, a rear side, a left side, a right side, an upper side, and a lower side shown in FIG. 12 are further defined.

As shown in FIG. 12, the riding mower 100s includes a main frame 11s, a seat 12s, a power output assembly 13s, a traveling assembly 14s, an operating assembly 15s, and a power supply apparatus 16s.

The main frame 11s is configured to carry the seat 12s, the power output assembly 13s, the traveling assembly 14s, the operating assembly 15s, and the power supply apparatus 16s. The main frame 11s at least partially extends in the direction of a first straight line 101s parallel to the front and rear direction. The preceding assemblies and apparatuses are reasonably distributed to various parts of the main frame.

The power output assembly 13s includes an output member configured to output power to implement the mechanical function. For example, in this example, the output member may be a mowing element. The power output assembly 13s is further connected to the main frame 11s. In this example, the power output assembly 13s is mounted on the lower side of the main frame 11s. The power output assembly 13s further includes a first motor and a chassis. The mowing element is configured to implement the mowing function. The first motor is configured to drive the mowing element to rotate at a high speed. The chassis is formed with an accommodation space configured to accommodate at least part of the motor and part of the mowing element. The power output assembly may include more than one mowing element. Correspondingly, the number of first motors may correspond to the number of mowing elements.

The traveling assembly 14s is configured to enable the riding mower 100s to travel on the lawn. The traveling assembly 14s may include first traveling wheels 141s and second traveling wheels 142s. In the front and rear direction, the first traveling wheels 141s are disposed on the front side of the second traveling wheels 142s. In this example, the number of the first traveling wheels 141s is two, and the number of the second traveling wheels 142s is also two. In the direction of the first straight line 101s, the power output assembly 13s is at least partially disposed between the first traveling wheels 141s and the second traveling wheels 142s. Moreover, in the direction of the first straight line 101s, the seat 12s is also at least partially disposed between the first traveling wheels 141s and the second traveling wheels 142s. In this case, the center of gravity of the entire mower is located between the first traveling wheels 141s and the second traveling wheels 142s and in the direction of the first straight line 101s, thereby improving the balance performance of the entire mower. A first traveling wheel 141 may be an Omni wheel rotatable around a first axis 102s and has a first diameter. The traveling assembly 14s further includes a second motor configured to drive the second traveling wheels 142s to rotate around a second axis. The number of second motors is also two. In this case, when the two second motors drive the corresponding second traveling wheels 142s to rotate at different rotational speeds, a speed difference is generated between the two second traveling wheels 142s, thereby causing the riding mower 100s to turn. A second traveling wheel 142 has a second diameter. The second diameter of a second traveling wheel 142 is greater than the first diameter of a first traveling wheel 141.

The operating assembly 15s is configured to be operated by the user to control the riding mower 100s to travel and output power. The operating assembly 15s may include a first operating element 151s and a second operating element 152s. The first operating element 152 is configured to be operated manually by the user to start the motors so as to control the mowing element to mow the grass and control the riding mower 100s to travel on the lawn. The second operating element 152s is for the user to press down so as to control the running state of the mower.

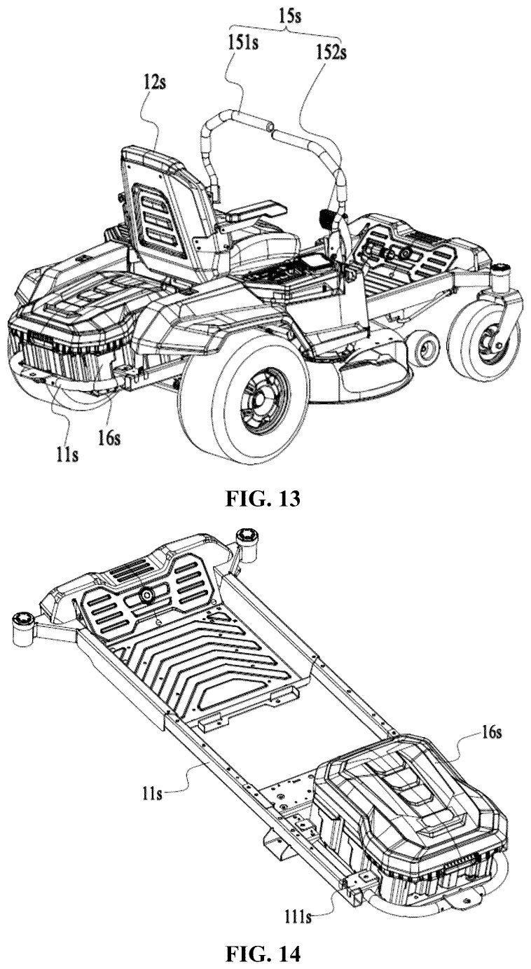

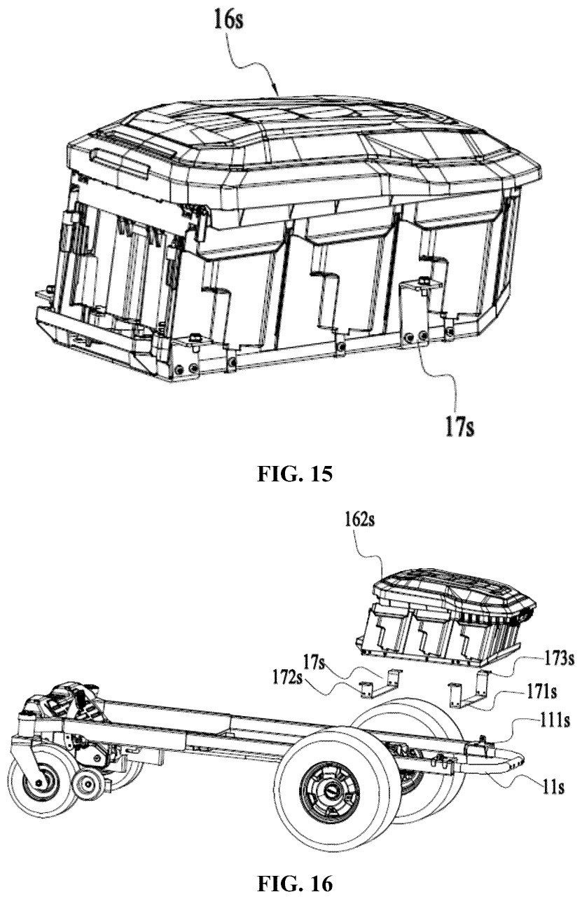

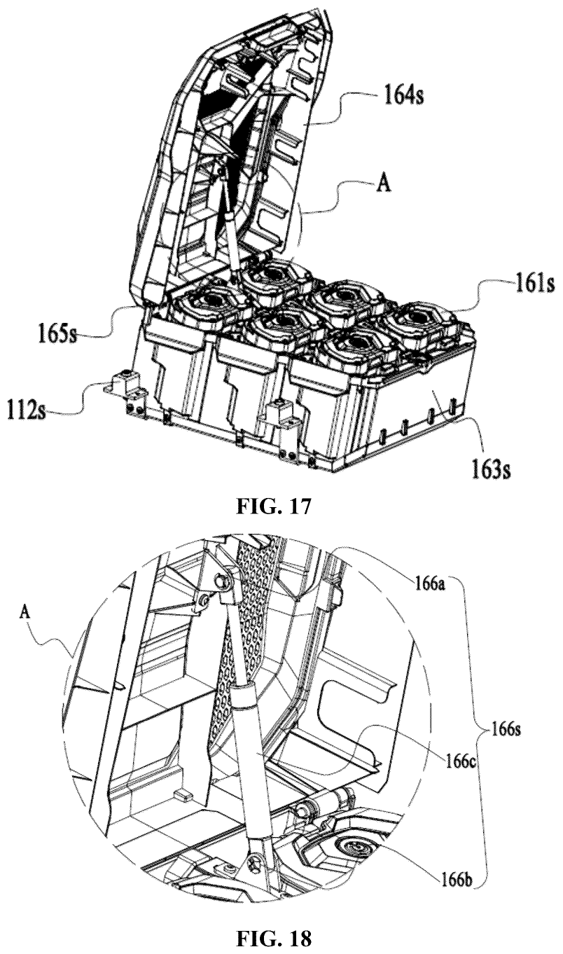

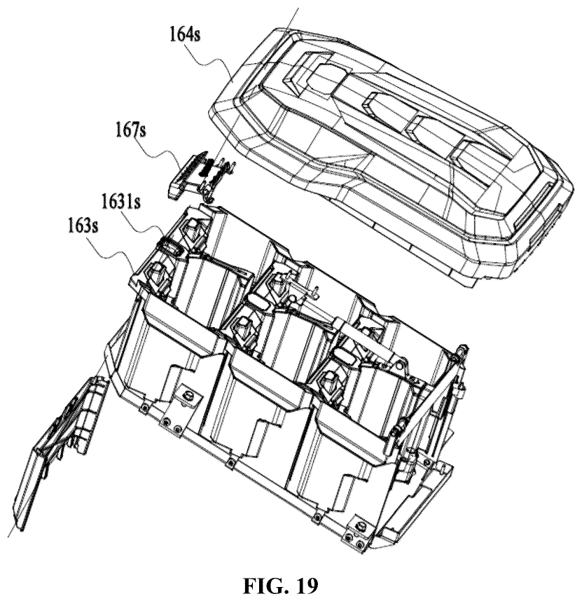

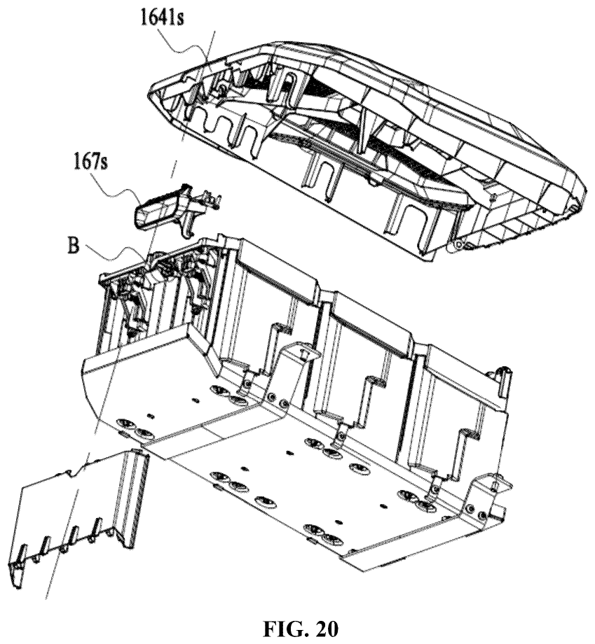

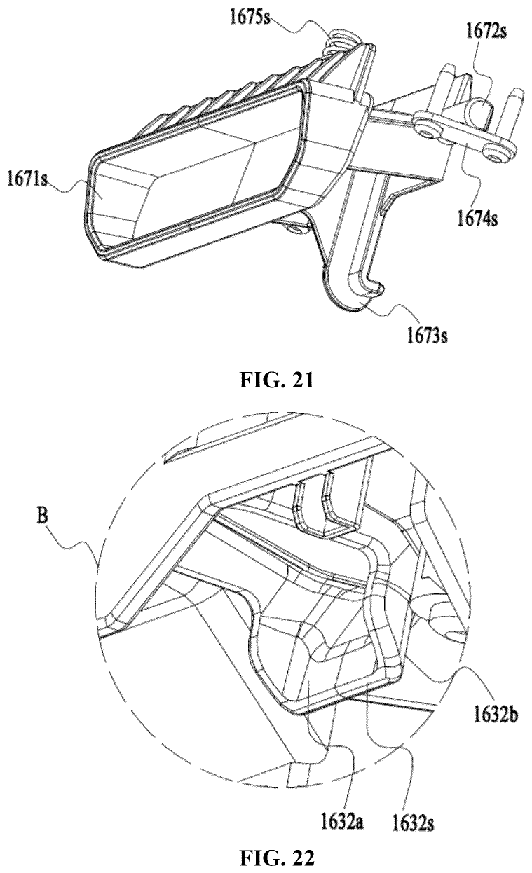

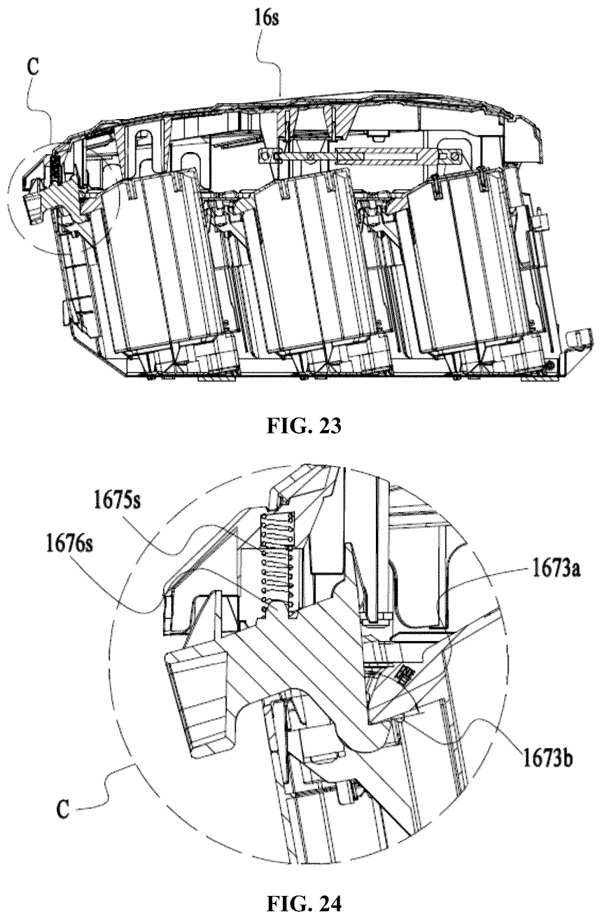

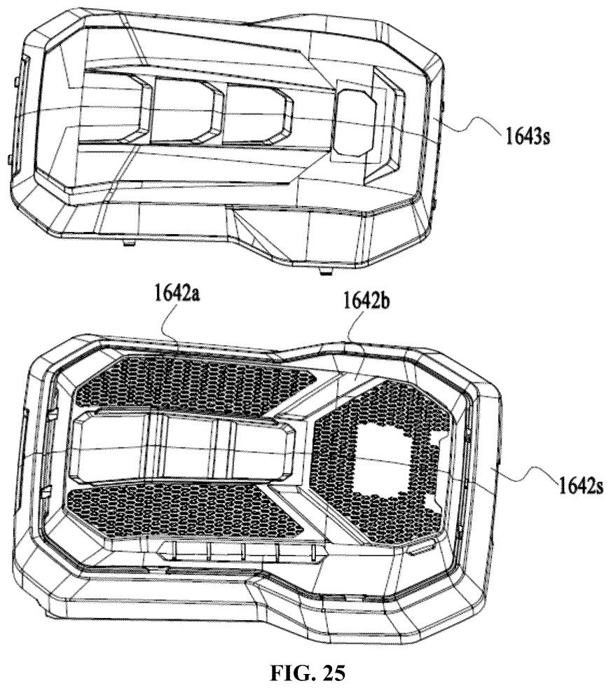

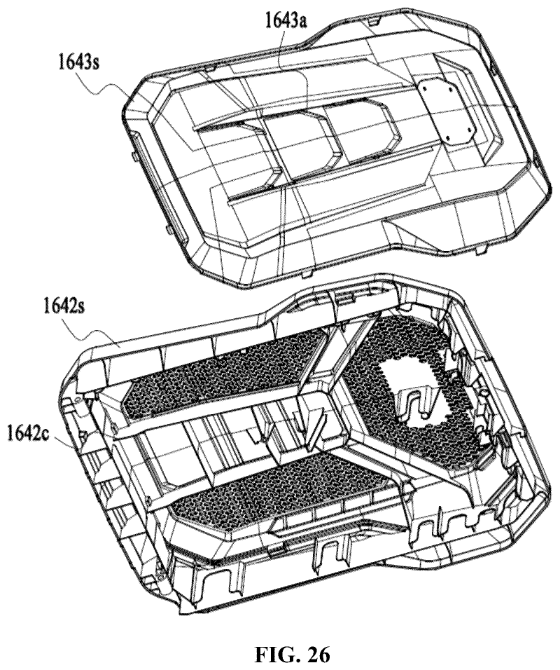

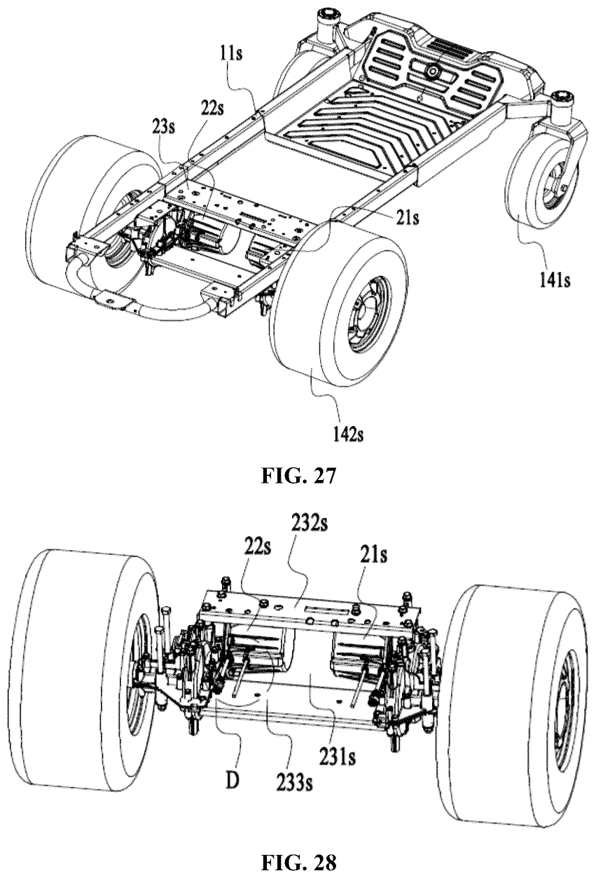

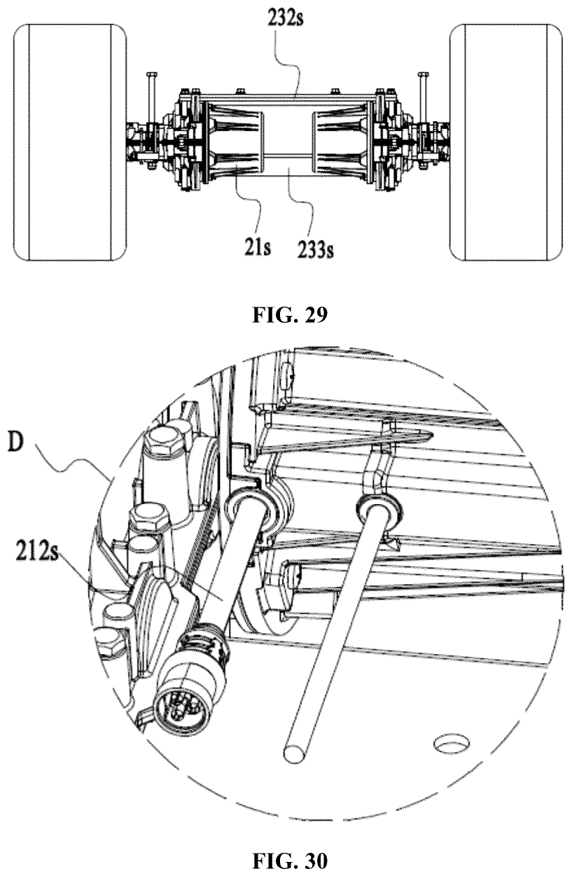

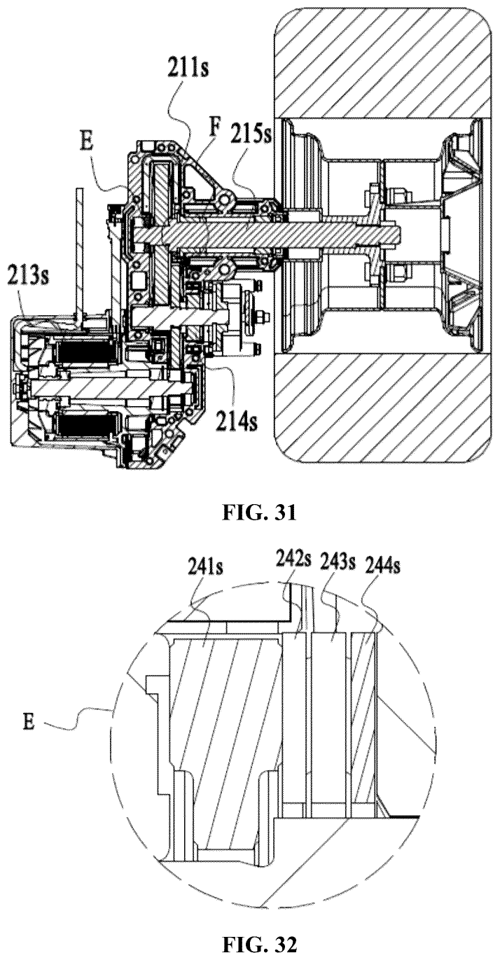

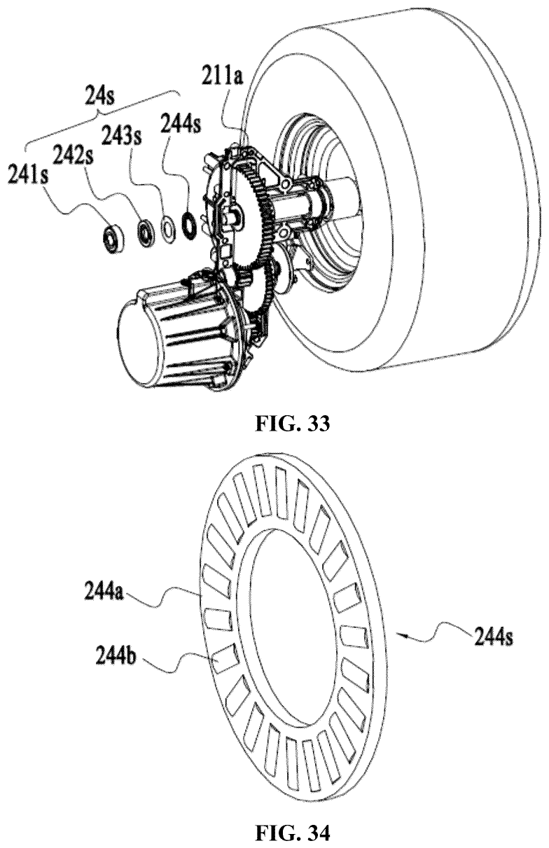

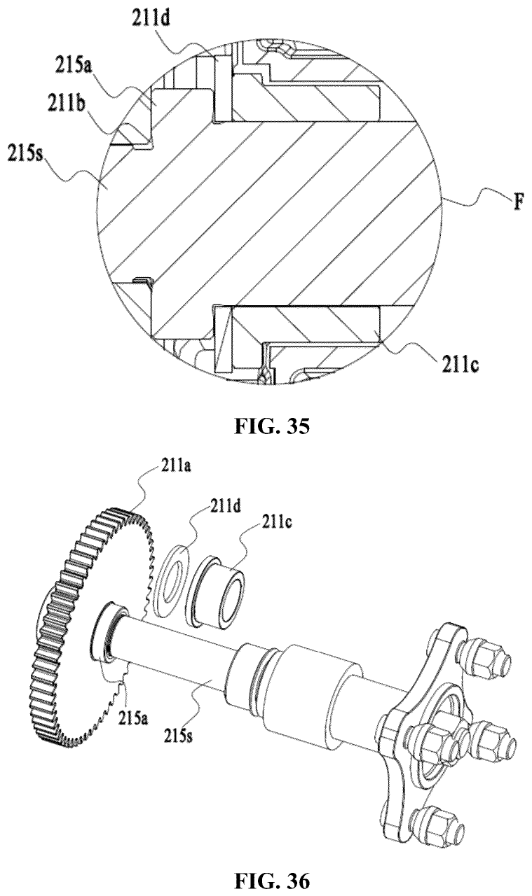

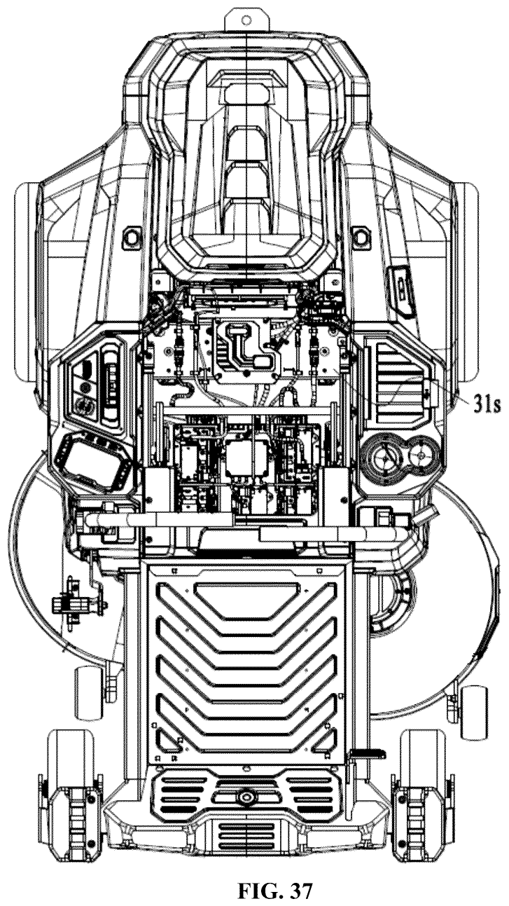

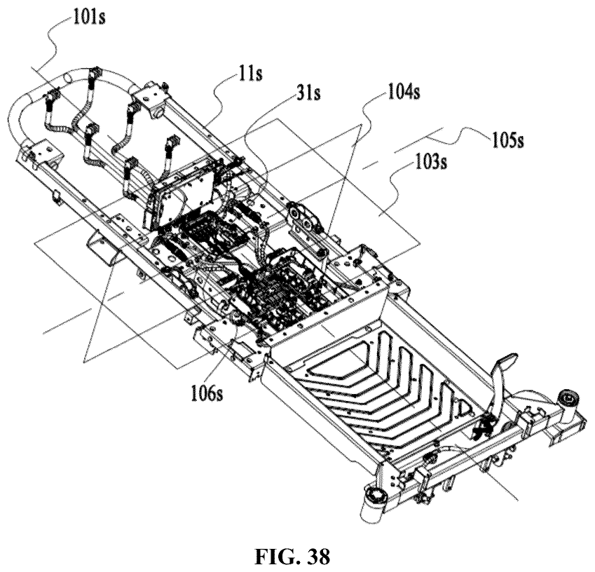

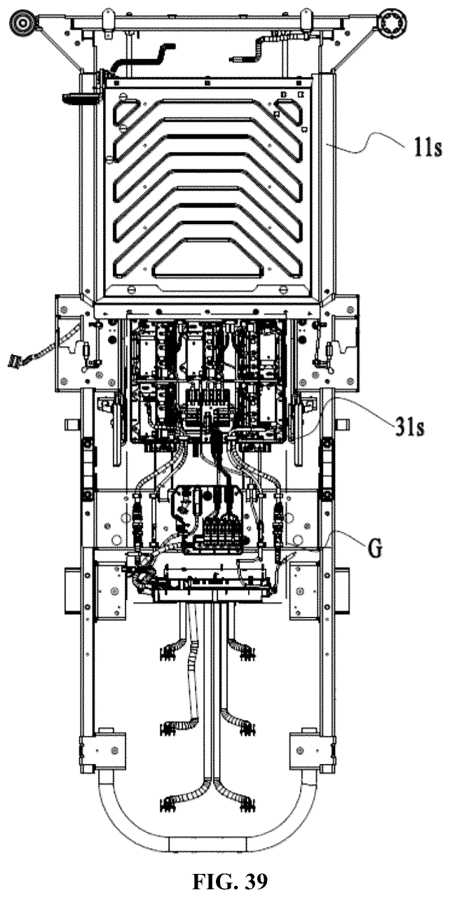

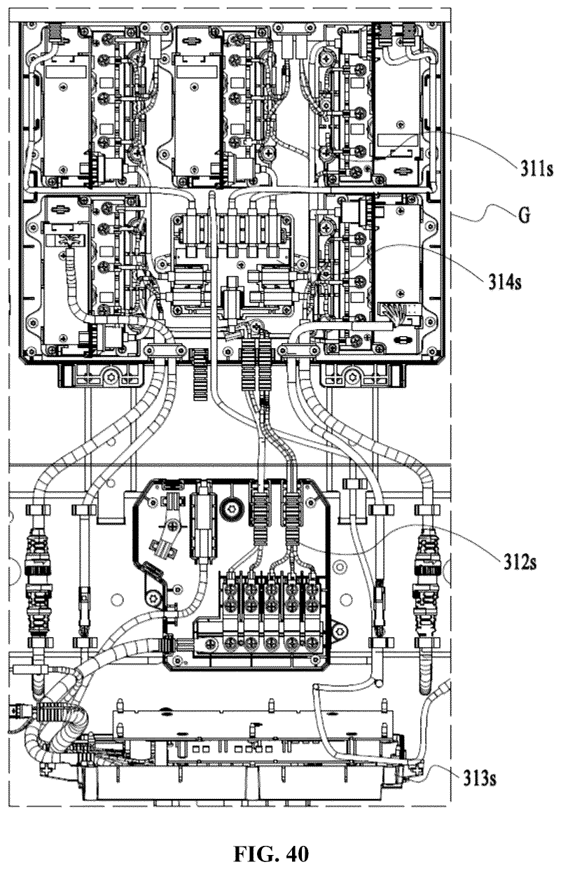

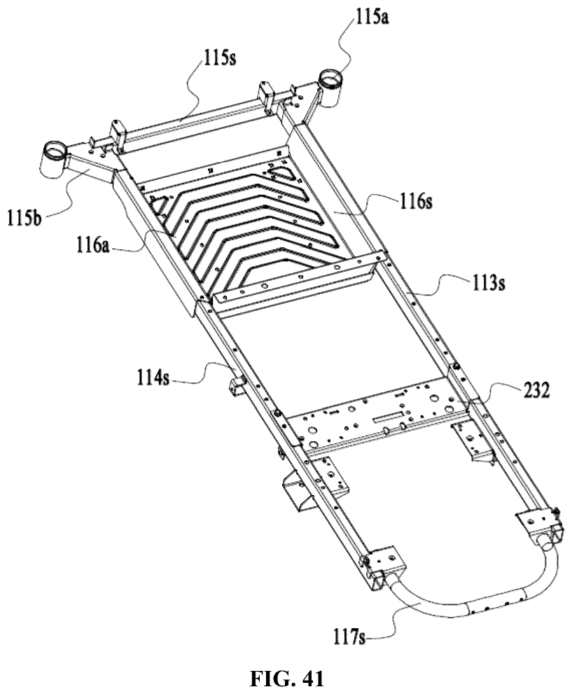

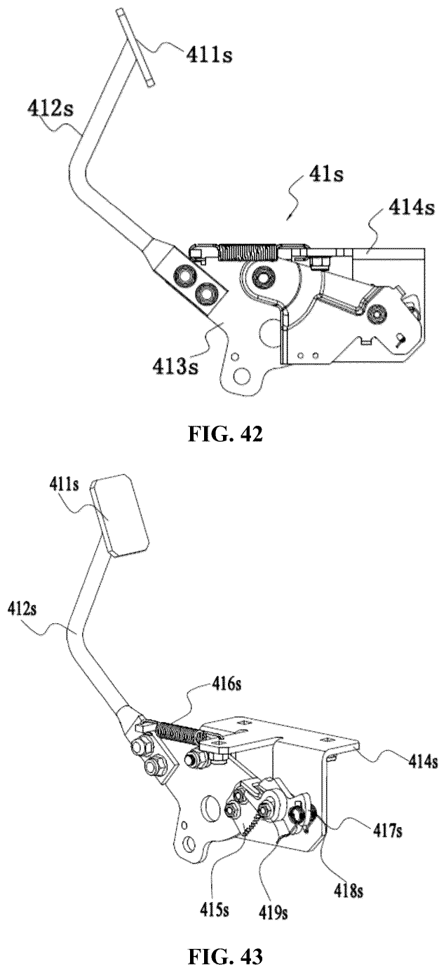

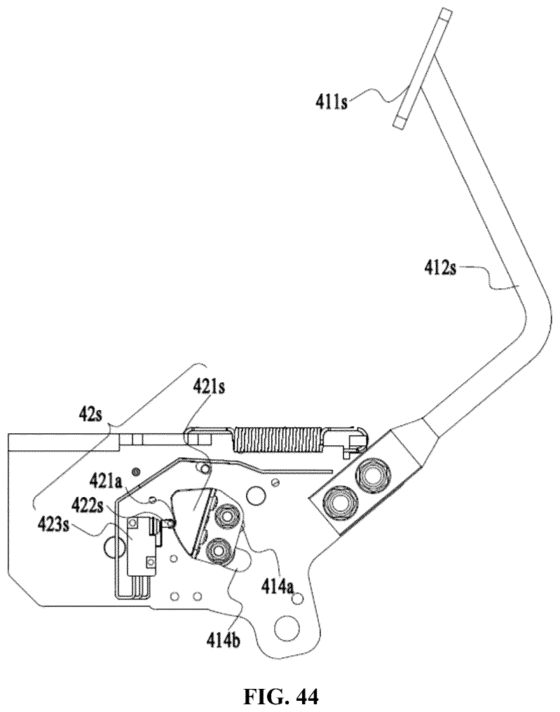

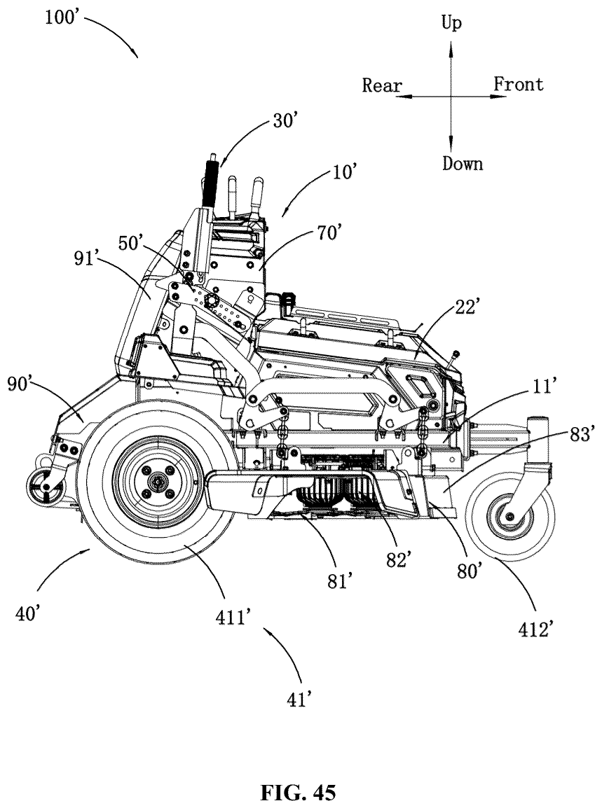

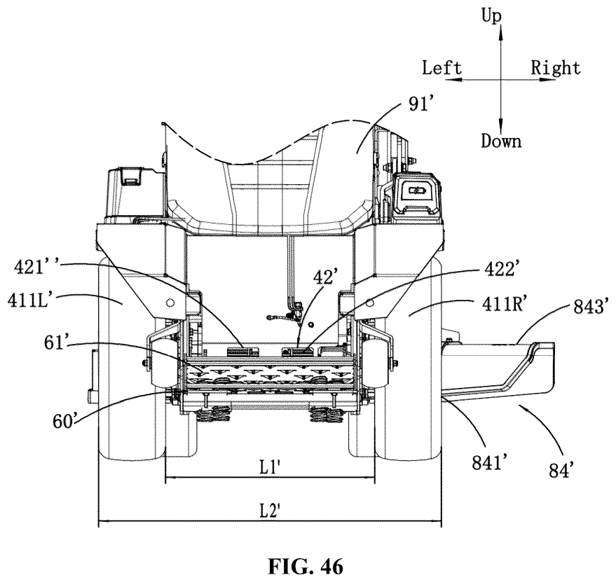

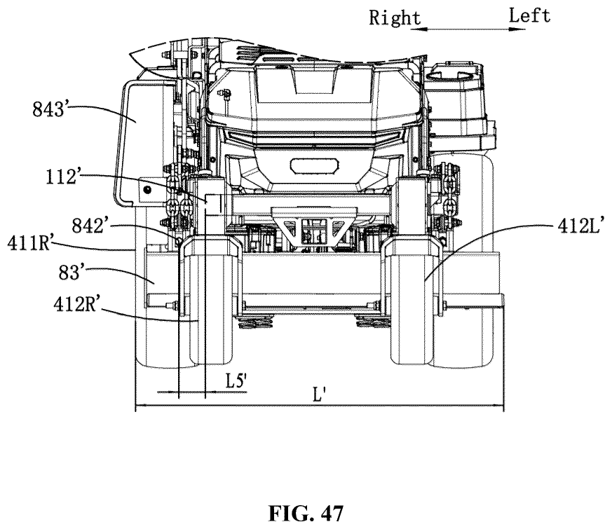

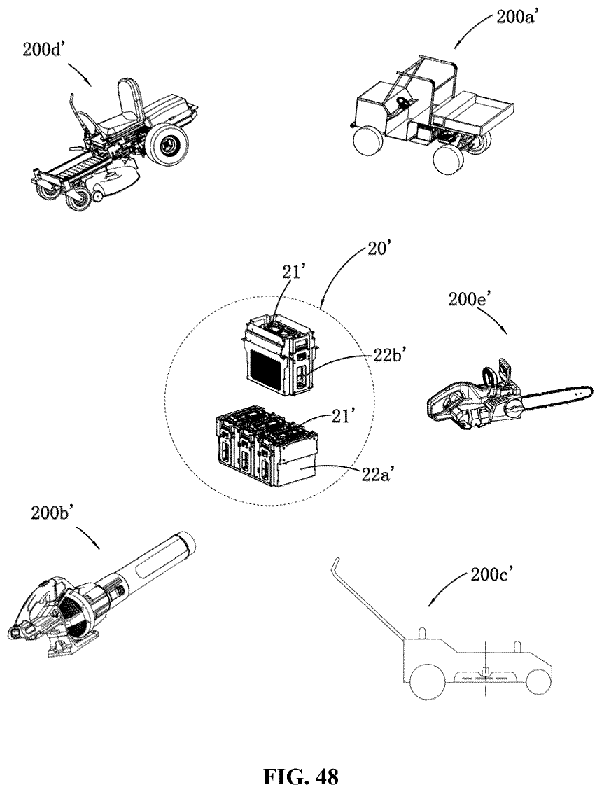

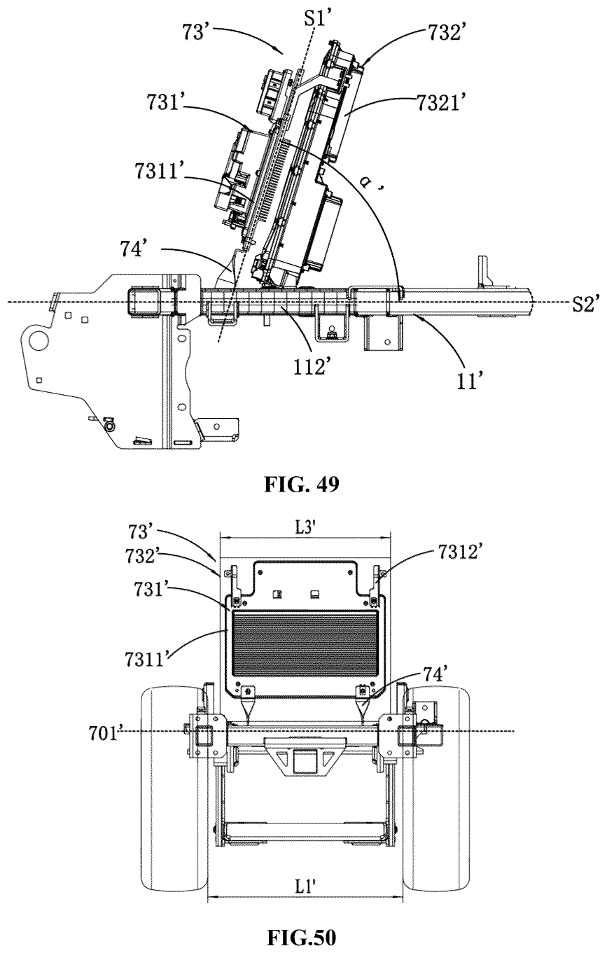

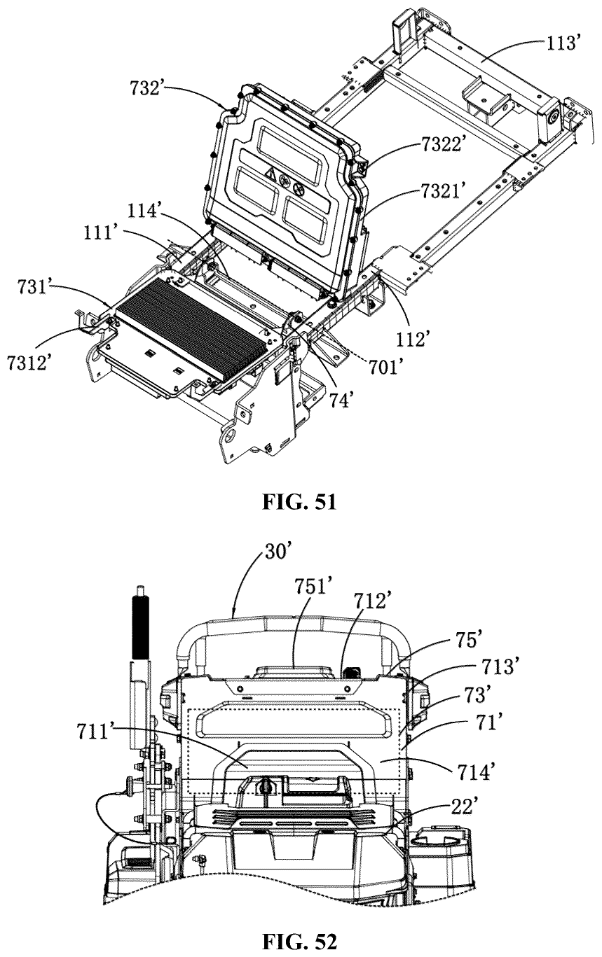

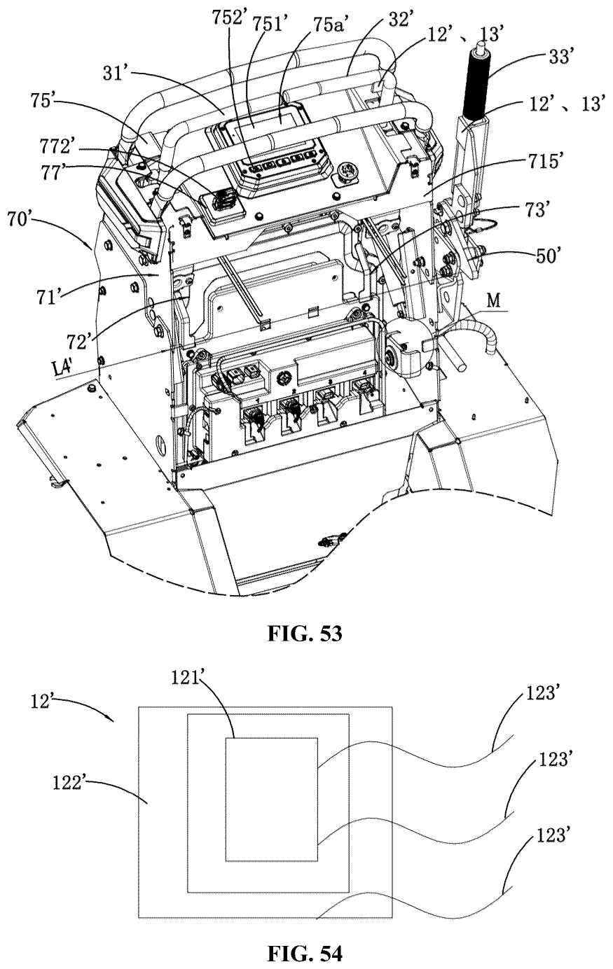

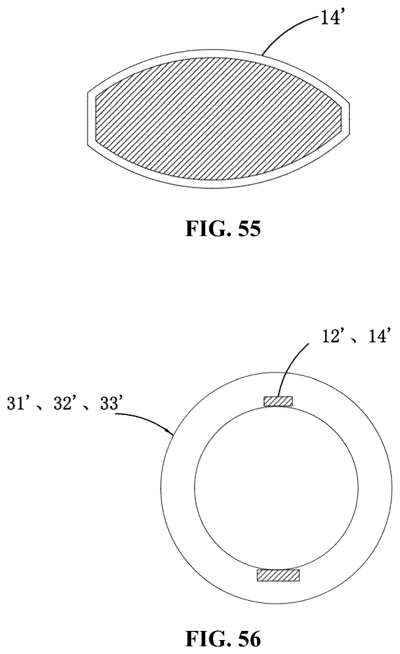

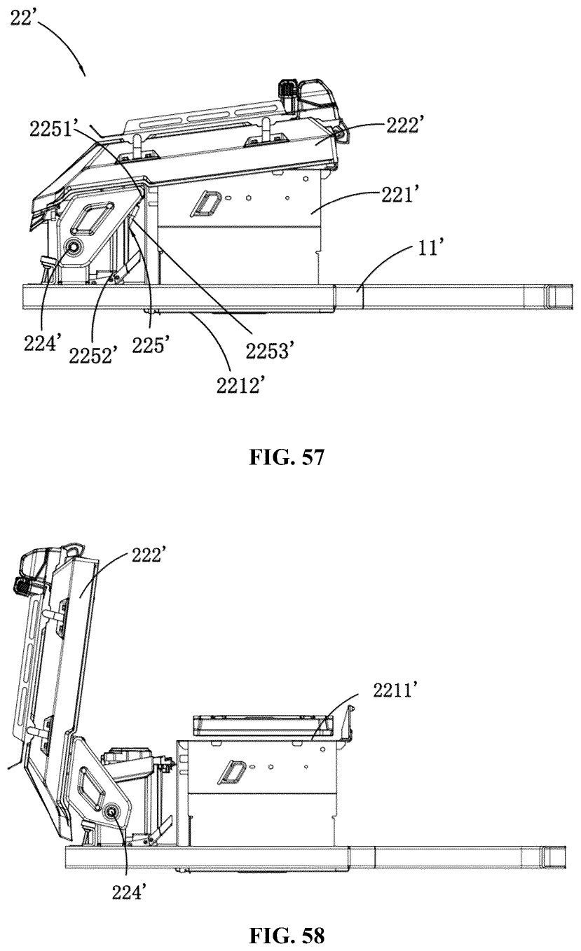

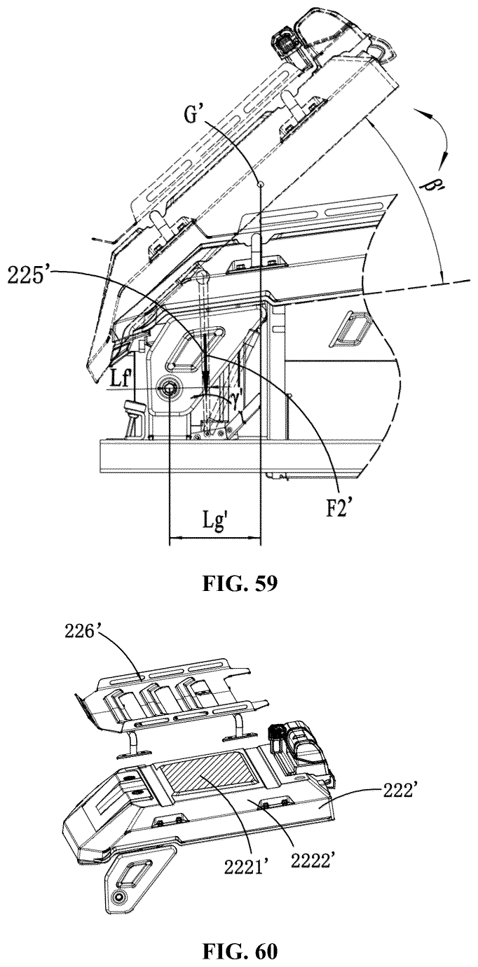

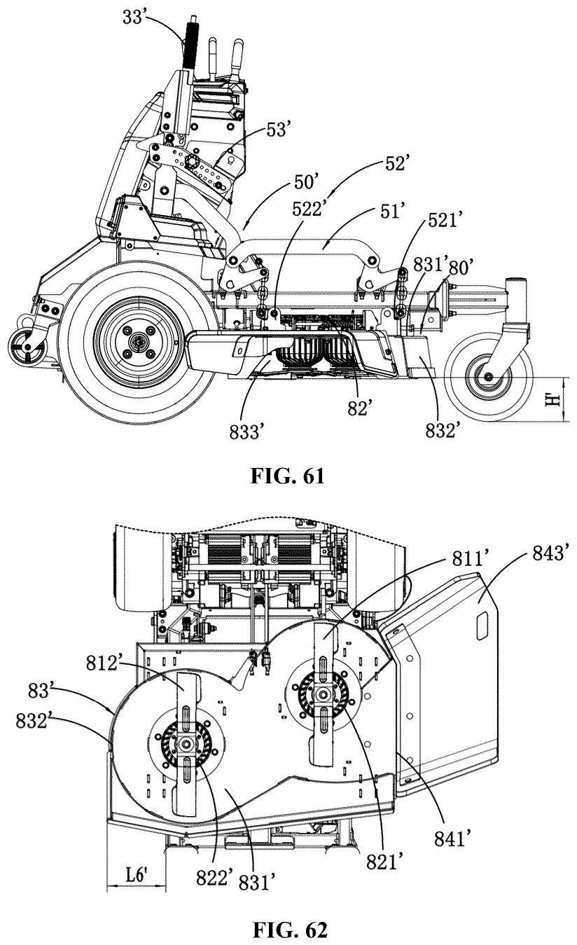

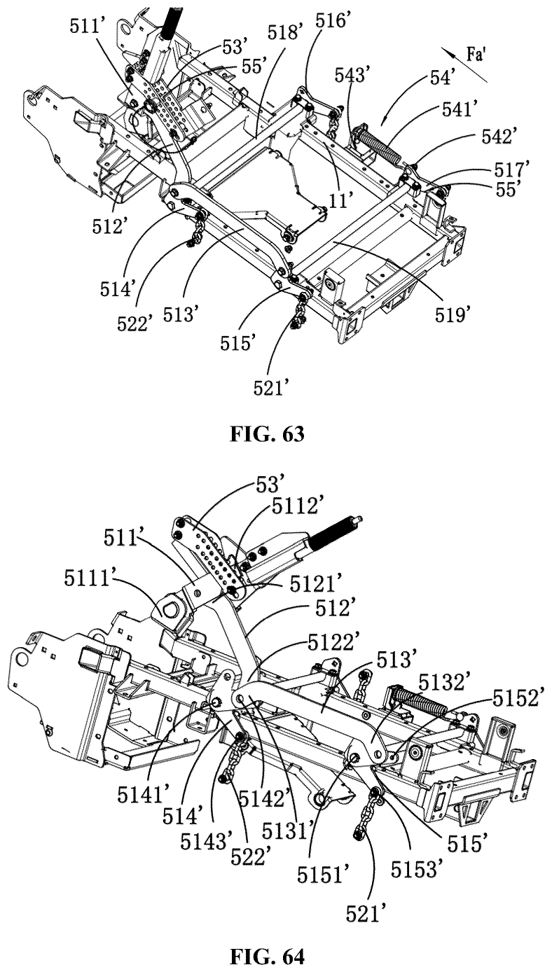

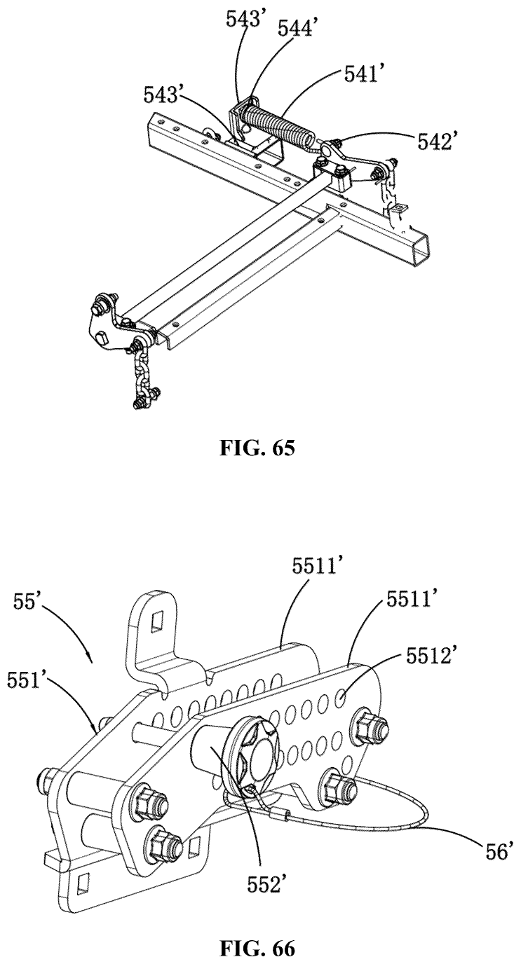

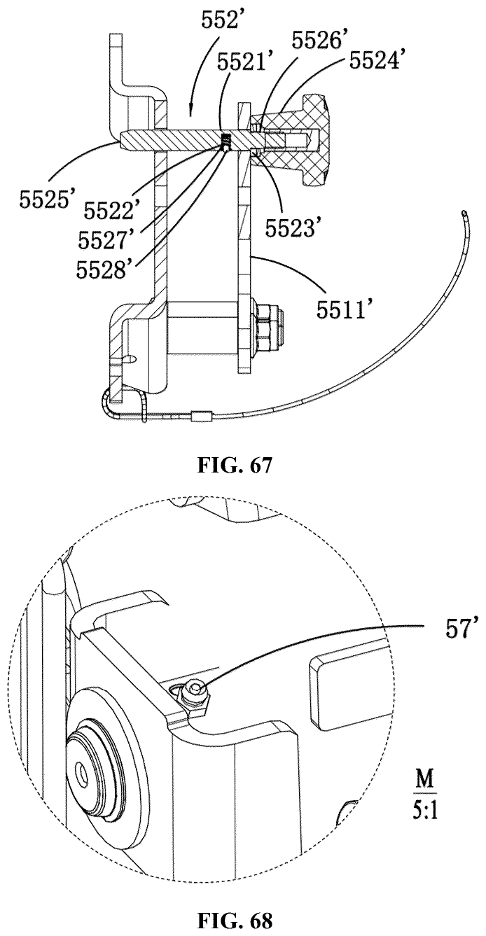

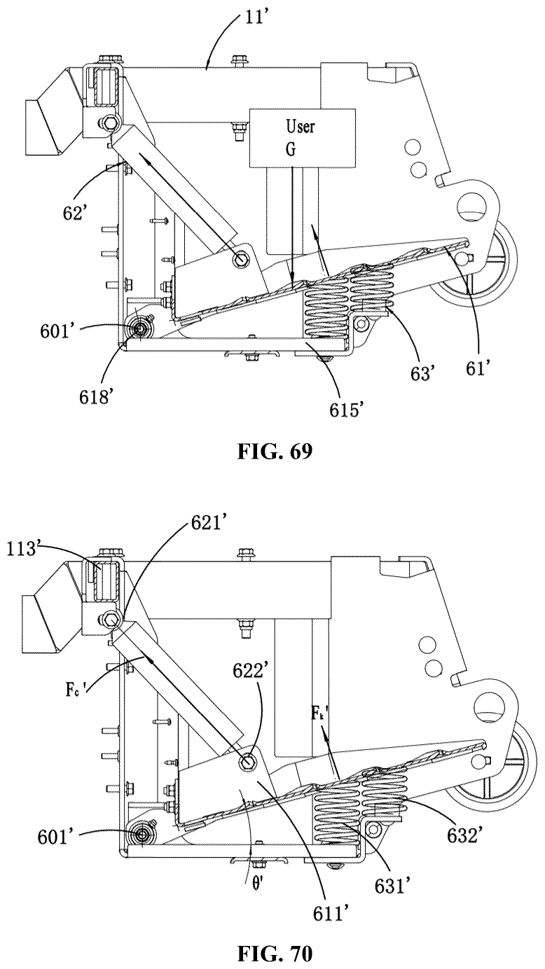

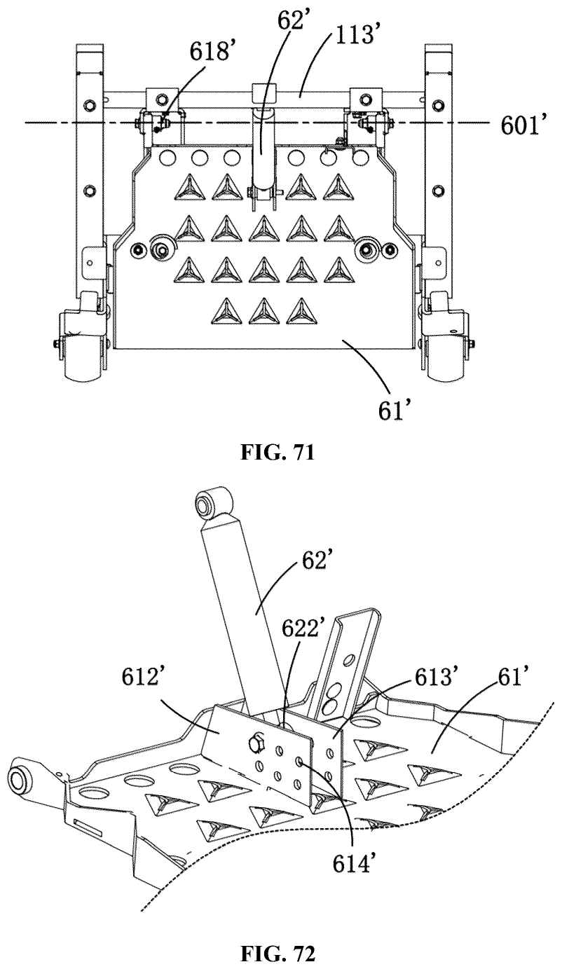

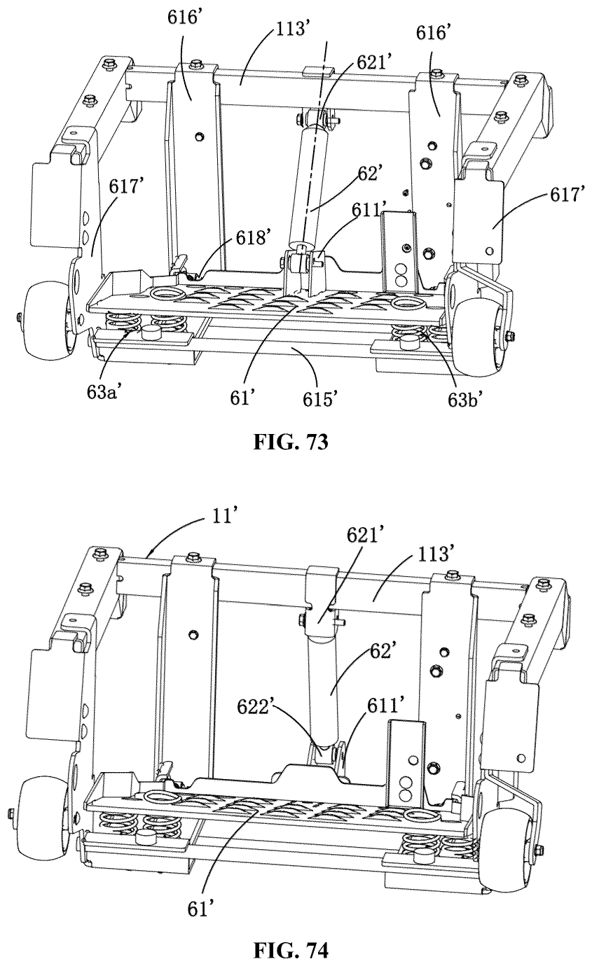

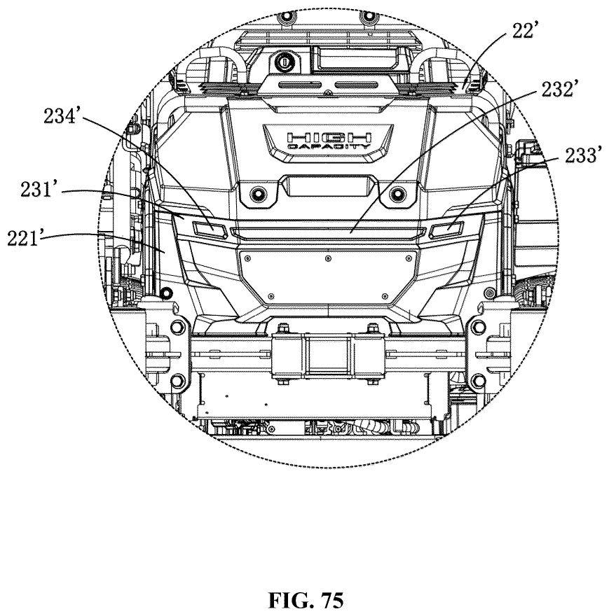

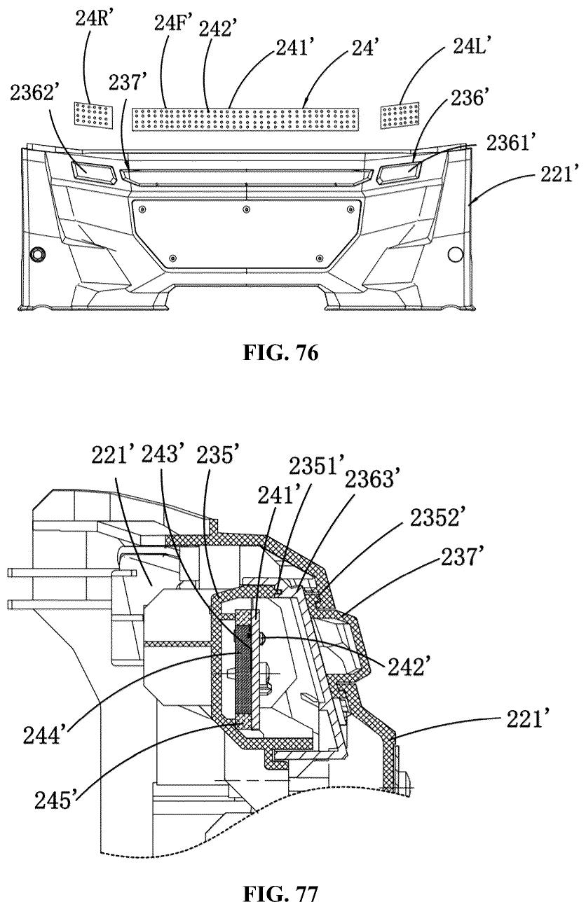

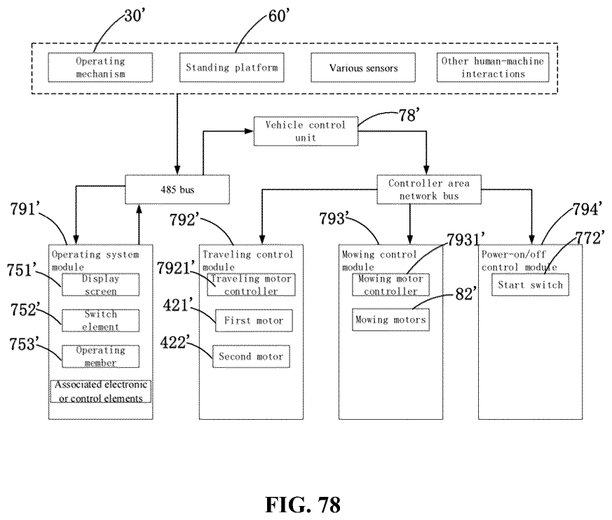

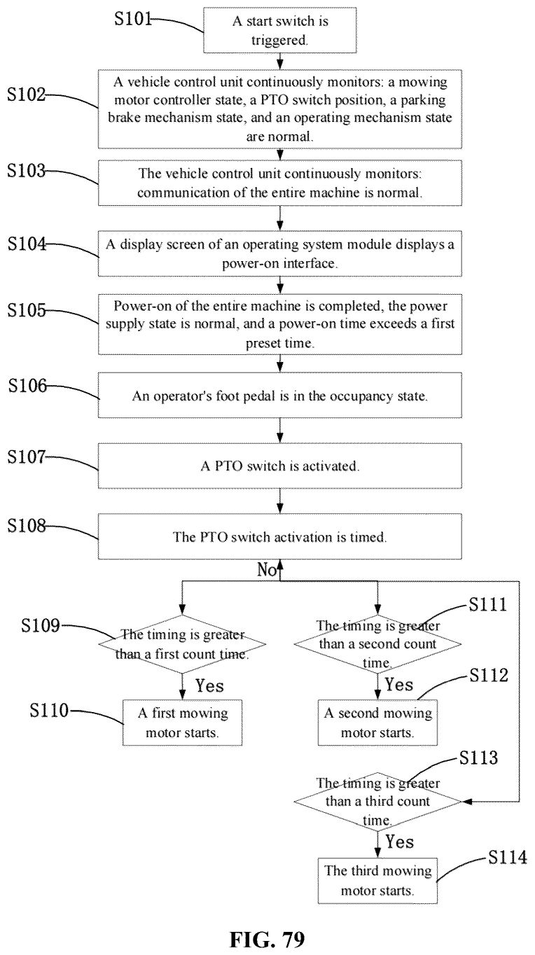

As shown in FIGS. 13 and 14, the power supply apparatus 16s is configured to supply power to the power output assembly 13s and the traveling assembly 14s. The power supply apparatus 16s is disposed on the main frame 11s and is detachable from the main frame 11s. In some examples, the power supply apparatus 16s is disposed in the rear of the main frame 11s. The power supply apparatus 16s matches other components disposed in the front and middle of the main frame 11s so that the center of gravity of the riding mower 100s is located between the first traveling wheels 141s and the second traveling wheels 142s and in the direction of the first straight line 101s. Accordingly, the center of gravity of the riding mower 100s is more stable, preventing the riding mower 100s from overturning when extending through a steep uphill or downhill.

As shown in FIGS. 15 and 16, the power supply apparatus 16s is connected to the main frame 11s by a group of support bases 17. A support base 17s includes a support portion 171s configured to support the power supply apparatus 16s, a first connection portion 172s, and a second connection portion 173s. The first connection portion 172s is configured to connect the power supply apparatus 16s. The second connection portion 173s is configured to connect the main frame 11s. The first connection portion 172s is connected to a bottom end of the power supply apparatus 16s through a connector. The second connection portion 173s is connected to the main frame 11s through a connector. Optionally, the main frame 11s is further provided with a connection mechanism 111s. The connection mechanism 111s serves as an intermediate member disposed on the main frame 11s, protecting the structural strength of the main frame 11s and guaranteeing the stability of the connection between the power supply apparatus 16s and the main frame 11s. It is to be understood that the main frame 11s may be provided with no connection mechanism and directly connected to the main frame 11s. In an alternative example, each connector may be a screw, and the first connection portion 172s and the second connection portion 173s may be each provided with a screw hole. It is to be understood that the first connection portion 172s and second connection portion 173s may be disposed in any manner as long as the power supply apparatus 16s can be detachably connected to the main frame 11s and a stable connection can be ensured.

During the running process of the riding mower, when the road condition is relatively complicated, the riding mower generates a relatively large vibration. When such vibration is transmitted to the main frame 11s and when the main frame 11s transmits the vibration to a connection piece of a battery pack 161s, it is easy to cause a poor contact between the battery pack 161s and the connection piece of the battery pack 161s, thereby causing a potential hazard of bad ignition. In order to avoid the existence of bad ignition, the power supply apparatus 16s is provided with a certain buffer function which can basically absorb the vibration from the main frame 11s. A buffer 112s is disposed in junctions between the support bases 17 and the main frame 11s so that the power supply apparatus 16s adapts to relatively violent vibration. The buffer 112s greatly mitigates the relative movement between the power supply apparatus 16s and the support bases 17. In some examples, the buffer 112s is disposed between second connection portions 173s and the main frame 11s, effectively absorbing the vibration from the main frame 11s and preventing the vibration from the main frame 11s from being transmitted to the power supply apparatus 16s. In another alternative example, the buffer 112s may be also disposed in any junction between the power supply apparatus 16s and the main frame 11s, as long as the vibration from the main frame 11s can be absorbed and prevented from being transmitted to the battery pack 161s. The buffer 112s may be an elastic member 1675s, a rubber member, or another component with the buffer function. When the buffer 112s is provided, the buffer function required by the power supply apparatus 16s is greatly weakened. This arrangement simplifies the structure of the power supply apparatus 16s and reduces the assembly requirements of the power supply apparatus 16s.

As shown in FIGS. 17 and 18, the power supply apparatus 16s includes the battery pack 161s and a battery compartment 162s. The battery compartment 162s is formed with an accommodation space configured to accommodate the battery pack 161s. The battery compartment 162s includes a main compartment 163s and a compartment cover 164s. The main compartment 163s is formed with the accommodation space configured to accommodate the battery pack 161s. The compartment cover 164s is configured to be rotatably connected to the main compartment 163s and is able to at least partially enclose the main compartment 163s. In some examples, the compartment cover 164s and the main compartment 163s include a first connector 165s and a second connector 166s. The first connector 165s is disposed on an end of the compartment cover 164s and on an end of the main compartment 163s. The compartment cover 164s is able to rotate around the first connector 165s. The second connector 166s includes a first connection end 166a and a second connection end 166b. The first connection end 166a is disposed in the middle of the compartment cover 164s. The second connection end 166b is disposed on the side of the main compartment 163s facing the first connector 165s. A gas spring 166c is disposed between the first connection end 166a and the second connection end 166b. The gas spring 166c can rotate around the first connection end 166a and the second connection end 166b. The gas spring 166c is pre-charged with gas. When the compartment cover 164s is lifted to a preset angle, the gas spring 166c outputs a thrust so as to support the compartment cover 164s to automatically rotate around the first connector 165s to a fully open state. In this case, the battery pack 161s can be detached or mounted. When the compartment cover 164s is closed to a preset angle, the gas spring 166c outputs a thrust so as to support the compartment cover 164s to make the compartment cover 164s to automatically rotate around the first connector 165s until the compartment cover 164s is fully closed. In fact, the second connector 166s has a stop of a thrust that cannot be output. When the user opens or closes the compartment cover 164s, the user needs to manually push the compartment cover 164s across the stop so that the gas spring 166c can automatically output a thrust.

As shown in FIGS. 19 to 24, in an example, the compartment cover 164s is further provided with a fastener 167s configured to lock the compartment cover 164s to the main compartment 163s. In some examples, the fastener 167s includes an operating portion 1671s, a pivot portion 1672s, and a locking portion 1673s. The operating portion 1671s is disposed between the pivot portion 1672s and the locking portion 1673s and is configured to be operated by the user to open or close the compartment cover 164s. The pivot portion 1672s is configured to connect the fastener 167s to the compartment cover 164s and is for the fastener 167s to rotate around. The locking portion 1673s is configured to lock the compartment cover 164s to the main compartment 163s. In some examples, the compartment cover 164s is provided with an accommodation recess 1641s. The accommodation recess 1641s is configured to accommodate at least part of the pivot portion 1672s and enable the pivot portion 1672s to rotate in the accommodation recess 1641s. The pivot portion 1672s is secured to the accommodation recess 1641s through a group of connection assemblies 1674s. In some examples, a connection assembly 1674s includes a pair of screws and a connection piece. The screws are configured to secure the connection piece to the compartment cover 164s and restrict the pivot portion 1672s from sliding out of the accommodation recess 1641s when the pivot portion 1672s is mounted onto the accommodation recess 1641s. The locking portion 1673s is a locking hook extending from the fastener 167s. The main compartment 163s is further formed with a through hole 1631s and a stop portion 1632s. The through hole 1631s is for the locking portion 1673s to extend through. The stop portion 1632s matches the locking hook. In some examples, the locking portion 1673s includes an inner side edge and an outer side edge. The inner side edge abuts the stop portion 1632s and includes a first edge 1673a and a second edge 1673b. The first edge 1673a and the second edge 1673b obliquely intersect each other and form an included angle. The included angle α between the first edge 1673a and the second edge 1673b may be an acute angle. In some examples, the included angle α is greater than or equal to 60° and less than or equal to 90°. In a preferred example, when the included angle α between the first edge 1673a and the second edge 1673b is 90°, the locking effect of the locking portion 1673s is relatively sound. The stop portion 1632s extends out of the through hole 1631s and is formed with a channel and a protrusion. The channel is for the locking portion 1673s to go through. The protrusion engages with the locking portion 1673s. In fact, the stop portion 1632s includes a first surface 1632a and a second surface 1632b. After extending through the through hole 1631s, the locking portion 1673s has a first position matching the stop portion 1632s and a second position away from the stop portion 1632s. When the locking portion 1673s is at the first position, the locking hook abuts the stop portion 1632s and is able to hook the stop portion 1632s. In this case, the locking hook slides from the first surface 1632a of the stop portion 1632s to the second surface 1632b of the stop portion 1632s and is at least partially held on the second surface 1632b, thereby enabling the compartment cover 164s to be locked to the main compartment 163s. When the locking portion 1673s is at the second position, the locking hook is disengaged from the stop portion 1632s. In this case, the locking hook is disengaged from the second surface 1632b of the stop portion 1632s to the first surface 1632a of the stop portion 1632s and is disengaged from the through hole 1631s of the main compartment 163s, and the compartment cover 164s is rotatable around the first connector 165s to any open position.

In an alternative example, the fastener 167s is further provided with an elastic member 1675s configured to provide an elastic force when the locking portion 1673s is at the second position so that the locking portion 1673s can be held at the second position, thereby enabling the compartment cover 164s to be locked to the main compartment 163s. In some examples, the fastener 167s is formed with a stop protrusion 1676s. One end of the elastic member 1675s is sleeved on the stop protrusion 1676s. The other end of the elastic member 1675s is disposed in the accommodation recess 1641s of the compartment cover 164s. In some examples, the elastic member 1675s is disposed on the end of the fastener 167s facing away from the locking portion 1673s and matches the locking portion to form a lever structure. That is, when the elastic member 1675s applies a downward elastic force to the fastener 167s, the fastener 167s takes the position of the through hole 1631s on the main compartment 163s as a pivot so that the locking portion 1673s applies an upward force to the stop portion 1632s, thereby enabling the locking portion 1673s to be locked to the stop portion 1632s.

When the user operates the operating portion 1671s, the elastic force of the elastic member 1675s is overcome first so that the locking portion 1673s is disengaged from the stop portion 1632s and slides from the second surface 1632b to the first surface 1632a. The operating portion is operated so that the fastener 167s is disengaged from the through hole 1631s of the main compartment 163s and the second connector 166s extends across the stop, thereby enabling the second connector 166s to directly drive the compartment cover 164s to automatically rotate to the fully open state. When the compartment cover 164s needs to be closed, the user operates the compartment cover 164s to make the compartment cover 164s extend across the stop so that the second connector 166s enables the compartment cover 164s to be automatically reset to the closed position. In this case, the locking portion 1673s extends through the through hole 1631s on the main compartment 163s and slides from the first surface 1632a of the stop portion 1632s to the second surface 1632b of the stop portion 1632s. Under the action of the elastic member 1675s, the compartment cover 164s is locked by the fastener 167s to the stop portion 1632s of the main compartment 163s.

As shown in FIG. 25, the compartment cover 164s includes a first cover 1642s and a second cover 1643s. The first cover 1642s is disposed on the side of the first cover 1642s facing the main compartment 163s. The second cover 1643s is disposed on the side of the first cover 1642s facing away from the main compartment 163s. The first cover 1642s is provided with a grid structure 1642a. On one hand, the battery pack 161s disposed in the main compartment 163s generates certain heat when working. The grid structure 1642a can effectively dissipate the heat in the main compartment 163s. On the other hand, when the riding mower works in the sun, optical radiation causes the temperature in the main compartment 163s to rise. In this case, the grid structure 1642a can block most of the optical radiation, thereby mitigating the temperature rise in the main compartment 163s. As an optional example, the grid structure 1642a may be formed by through holes 1631 disposed on the first cover 1642s. In the front and rear direction, the first cover 1642s has a Y-shaped body 1642b. The body 1642b plays a certain supporting role and can effectively maintain the structural strength of the first cover 1642s. The grid is disposed outside the body 1642b and connects the body 1642b and the edge of the first cover 1642s. The shape of the second cover 1643s fits the shape of the first cover 1642s and at least partially covers the first cover 1642s. In fact, the second cover 1643s is a transparent member and may be made of transparent material. On one hand, the second cover 1643s helps the user observe the situation in the main compartment 163s through the grid structure 1642a. On the other hand, the combination of the second cover 1643s and the first cover 1642s enhances the structural strength of the entire compartment cover 164s. In an example, the arrangement of the first cover 1642s and the second cover 1642 enhances the structural strength of the compartment cover 164s so that the compartment cover 164s better protects the battery pack 161s. Moreover, such a double-layer design enables different functions of the compartment cover 164s to be distributed to different cover bodies so that the first cover 1642s and the second cover 1643s generate different functions. In some examples, the combination of the first cover 1642s and the second cover 1643s implements the combination of different functions between different cover bodies. Moreover, different functions between different cover bodies do not affect each other.

As shown in FIG. 26, a first reinforcing rib 1642c is formed on the side of the first cover 1642s facing the main compartment 163s. The first reinforcing rib 1642c is mainly distributed in the body 1642b of the first cover 1642s. In some examples, the first reinforcing rib 1642c is disposed above the main compartment 163s to effectively enhance the structural strength of the compartment cover 164s so that the battery pack 161s disposed in the main compartment 163s can be effectively protected by the compartment cover 164s and is not damaged due to being exposed to the outside. Moreover, the arrangement of the first reinforcing rib 1642c helps effectively reduce the overall weight of the compartment cover 164s so that the compartment cover 164s is lighter as the strength increases. In an example, a second reinforcing rib 1643a is disposed on the side of the second cover 1643s facing the main compartment 163s. The second reinforcing rib 1643a can enhance the strength of the second cover 1643s and make the second cover 1643s lighter. When the second cover 1643s and the first cover 1642s are combined, the second cover 1643s and the first cover 1642s have a higher strength and become lighter.

As shown in FIG. 27, the traveling assembly 14s may include first traveling wheels 141s and second traveling wheels 142s. In the front and rear direction, the first traveling wheels 141s are disposed on the front side of the second traveling wheels 142s. The traveling assembly 14s further includes a first drive assembly 21s and a second drive assembly 22s that are configured to drive the second traveling wheels 142s to rotate. In this case, when the first drive assembly 21s and the second drive assembly 22s drive the corresponding second traveling wheels 142s to rotate at different rotational speeds, a speed difference is generated between the two second traveling wheels 142s, thereby causing the riding mower to turn. In some examples, in a symmetry plane extending in the direction of the first straight line 101s, the first drive assembly 21s and the second drive assembly 22s are disposed symmetrically about the symmetry plane.

As shown in FIGS. 27 to 29, the first drive assembly 21s and the second drive assembly 22s are disposed on the main frame 11s by a connector. Since the traveling assembly 14s connected to the main frame 11s carries all the weight from the main frame 11s, the second traveling wheels 142s disposed on the rear side carry most of the weight from the main frame 11s. Moreover, the second traveling wheels 142s are connected to the main frame 11s through the first drive assembly 21s and the second drive assembly 22s. Accordingly, the load from the main frame 11s is transmitted to the second traveling wheels 142s through the first drive assembly 21s and the second drive assembly 22s. The first drive assembly 21s and the second drive assembly 22s that are disposed on the main frame 11s serve as two independent assemblies and each bear the load from the main frame 11s to make the junction between the second drive assembly 22s and the main frame 11s. In an example, a connection plate assembly 23s connecting the first drive assembly 21s and the second drive assembly 22s is provided. Optionally, when the connection plate assembly 23s is connected to the first drive assembly 21s and the second drive assembly 22s, an accommodation space 231s that separates at least part of the upper space of the main frame 11s from at least part of the lower space of the main frame 11s and is located on the lower side of the main frame 11s is formed. The first drive assembly and the second drive assembly are disposed in the accommodation space 231s. In this case, the upper space of the main frame 11s is effectively separated from the lower space of the main frame 11s so as to prevent the first drive assembly 21s and the second drive assembly 22s from interfering with related components in the upper space of the main frame 11s.

In some examples, the connection assembly 23 includes a first connection plate 232s and a second connection plate 233s. The first connection plate 232s is disposed on the upper side of the first drive assembly 21s and the upper side of the second drive assembly 22s. The second connection plate 233s is disposed on the lower side of the first drive assembly 21s and the lower side of the second drive assembly 22s. In some examples, the first connection plate 232s and the second connection plate 233s are each connected to a gearbox 211s of the first drive assembly 21s and a gearbox 211s of the second drive assembly 22s. As an optional example, the first connection plate 232s and the second connection plate 233s are disposed in parallel in an up and down direction perpendicular to the first straight line 101s. Optionally, the first connection plate 232s and the second connection plate 233s may also be staggered in a straight-line direction perpendicular to the first straight line 101s. Accordingly, the separation of the upper space of the main frame 11s from the lower space of the main frame 11s is implemented in a relatively large range. The arrangement of the first connection plate 232s and the second connection plate 233s enables the first drive assembly 21s and the second drive assembly 22s to be connected to the main frame 11s to form a whole, thereby significantly enhancing the stiffness in the junction between the first drive assembly 21s and the main frame 11s and the stiffness in the junction between the second drive assembly 22s and the main frame 11s. Moreover, because the first drive assembly 21s and the second drive assembly 22s are connected to form a whole in this case, the stiffness of the first drive assembly 21s and the second drive assembly 22s is also enhanced. Accordingly, on the basis of not strengthening the original first drive assembly 21s and the second drive assembly 22s, the structural strength of the first drive assembly 21s and the second drive assembly 22s can be enhanced significantly so that the first drive assembly 21s and the second drive assembly 22s can bear heavier loads. Additionally, due to the arrangement of the first connection plate 232s and the second connection plate 233s, the accommodation space 231s that separates the upper space of the main frame 11s from the lower space of the main frame 11s is formed between the first connection plate 232s and the second connection plate 233s. The gearbox 211s of the first drive assembly 21s and the gearbox 211s of the second drive assembly 22s are at least partially enclosed in the space between the first connection plate 232s and the second connection plate 233s, preventing an external object from damaging a gearbox 211s and thus effectively extending the service life of the first drive assembly 21s and the service life of the second drive assembly 22s. Moreover, such an arrangement also increases the complexity of the working environment that the riding mower 100s is able to adapt to. In some examples, the arrangement of the first connection plate 232s and the second connection plate 233s also plays a good positioning role for the first drive assembly 21s and the second drive assembly 22s so that the first driving assembly 21 and the second driving assembly 22 have good coaxiality and can be effectively secured to a preset position.

As shown in FIG. 30, with an aim of effectively controlling the first drive assembly 21s and the second drive assembly 22s, the first drive assembly 21s and the second drive assembly 22s are further provided with a control circuit connected to the outside through a connection line 212s. In this example, the connection line 212s is disposed on the rear side of the first drive assembly 21s and on the rear side of the second drive assembly 22s and is located in the accommodation space 231s between the first connection plate 232s and the second connection plate 233s. The arrangement in which the connection line 212s is disposed on the rear side of the first drive assembly 21s and on the rear side of the second drive assembly 22s and is located in the accommodation space 231s between the first connection plate 232s and the second connection plate 233s, on one hand, enables the connection line 212s to be away from the power output assembly, prevents the connection line 212s from interfering with the power output assembly, and prevents the broken grass from being wound onto the connections line 212 and interfering with the connection line 212s in the working state. On the other hand, the arrangement in which the connection line 212s is disposed between the first connection plate 232s and the second connection plate 233s protects the connection line 212s, prevents the connection line 212s from being exposed to the outside, and makes full use of the space on the rear side of the first drive assembly 21s and on the rear side of the second drive assembly 22s so that the arrangement of the entire mower is more reasonable. Finally, the arrangement in which the connection line 212s is disposed on the rear sides also facilitates detachment and maintenance with no need of detaching a front-end structure.

As shown in FIGS. 31 to 34, the first drive assembly 21s is taken as an example. The first drive assembly 21s includes a drive motor 213s, a gear mechanism 214s, and an output shaft 215s. The drive motor 213s outputs power to the gear mechanism 214s. The gear mechanism 214s transmits the power from the drive motor 213s to the output shaft 215s and drives the output shaft 215s to rotate. A second traveling wheel 142 is disposed on the output shaft 215s and rotates synchronously with the output shaft 215s. When the riding mower 100s is in the working process, the first drive assembly 21s and the second drive assembly 22s are used for driving the riding mower 100s to travel forward or backward. When a differential is formed through the first drive assembly 21s and the second drive assembly 22s to implement a turning or when the riding mower 100s encounters a slope, the second traveling wheel 142 connected to the output shaft 215s transmits a relatively large axial force to the output shaft 215s. The axial force presses the output shaft 215s to move axially or causes the second traveling wheel 142 to generate the force of being disengaged from the output shaft 215s.

In order to prevent the axial force from pressing the output shaft 215s and causing severe wear in the junction between the output shaft 215s and the gearbox 211s under the action of the axial force, a first connection assembly 24s is further disposed in the junction between the output shaft 215s and the gearbox 211s. The first connection assembly 24s may include a first bearing 241s, a first gasket 242s, a second gasket 243s, and a retainer 244s. The first bearing 241s, the first gasket 242s, the second gasket 243s, and the retainer 244s are arranged sequentially in the direction of the output shaft 215s and are sleeved on the output shaft 215s. The first bearing 214 is configured to support the end of the output shaft 215s facing away from the second traveling wheel 142. In fact, the gearbox 211s further includes a second bearing configured to support the output shaft 215s and disposed on the end facing the second traveling wheel 142. The first gasket 242s is disposed between the first bearing 241s and the second gasket 243s and is configured to secure the first bearing 241s and enable the first bearing 241s to have a preset distance relative to a transmission gear 211a on the output shaft 215s. The retainer 244s is disposed between the second gasket 243s and the transmission gear 211a and configured to provide a reaction force opposite to the direction of the axial force so as to offset the wear of the transmission gear 211a, the first gasket 242s, and the second gasket 243s when the axial force acts on the transmission gear 211a and the first bearing 241s, that is, the first gasket 242s and the second gasket 243s. The retainer 244s may be arranged as a thrust bearing and another component that can provide axial sliding friction. As an optional example, the retainer 244s is a circular piece with thrust rollers 244b. As shown in FIG. 34, the retainer 244s is a ring 244a structure disposed around a central axis. The cylindrical rollers 244b are disposed on two sides of the ring 244a and around the central axis. In fact, the rollers 244b are embedded in the retainer 244s and at least partially exposed outside the surface of the ring 244a. It is to be understood that surfaces of the rollers 244b are smooth and continuous so that the rollers 244b are freely rotatable in the retainer 244s, converting the static friction between the retainer 244s and the second gasket 243s or the static friction between the retainer 244s and the transmission gear 211a into sliding friction. Additionally, because the rollers 244b protrude from the plane where the ring 244a of the retainer 244s is located, the rollers 244b convert the static friction caused by the axial force of the output shaft 215s acting on the second gasket 243s or the transmission gear 211a into sliding friction, thereby effectively preventing the worn second gasket 243s and the worn retainer 244s from entering a gap between the transmission gear 211a, jamming the transmission gear 211a, and disabling the traveling function of the riding mower 100s. Alternatively, it prevents the transmission gear 211a from being worn so as to affect the service life of the riding mower 100s. In some examples, the arrangement of the retainer 244s effectively resolves the effect of the axial force along the output shaft 215s generated when the riding mower 100s turns or encounters an oblique road condition, thereby effectively extending the service life of the gearbox 211s.

As shown in FIGS. 35 and 36, the output shaft 215s is further formed with a protrusion portion 215a. The protrusion portion 215a is disposed around the circumference of the output shaft 215s. The diameter of the circumference where the protrusion portion 215a of the output shaft 215s is located is greater than the diameter of another portion of the output shaft 215s. In an example, the gearbox 211s is formed with an accommodation recess 211b configured to accommodate the protrusion portion 215a. The protrusion portion 215a basically fits the accommodation recess 211b and is limited within the range where the accommodation recess 211b is located. One end of the output shaft 215s is connected to the gearbox 211s, and the other end is connected to the second traveling wheel 142. When the output shaft 215s encounters a slope, due to the action of the second traveling wheel 142, the relatively large axial force is applied to the output shaft 215s and causes a tendency for the output shaft 215s to be away from the gearbox 211s. When the axial force is excessively large, driven by the second traveling wheel 142, the output shaft 215s may be disengaged from the gearbox 211s, thereby causing the entire second traveling wheel 142 to be disengaged from the main frame 11s and thus causing a great potential safety hazard. In this case, the existence of the protrusion portion 215a offsets most of the axial force from the second traveling wheel 142, thereby effectively preventing the output shaft 215s from being disengaged from the gearbox 211s. To avoid relatively large friction between the protrusion portion 215a and the gearbox 211s, a sleeve 211c is disposed on the side of the protrusion portion 215a facing away from the transmission gear 211a. The sleeve 211c effectively restricts the axial displacement of the output shaft 215s. In some examples, a third gasket 211d is disposed between the protrusion portion 215a of the output shaft 215s and the sleeve 211c. The third gasket 211d effectively prevents the protrusion portion 215a and the sleeve 211c from being worn under the action of the axial force.

As shown in FIG. 12, the first traveling wheels 141s, the operating assembly, the power output assembly, the seat, the second traveling wheels 142s, the power supply apparatus, and a grass catcher 25s are sequentially disposed on the riding mower 100s from the front side to the rear side. It is to be understood that the first traveling wheels 141s and the second traveling wheels 142s are mainly configured to support the main frame 11s and other components disposed on the main frame 11s and enable the riding mower 100s to travel. Each first traveling wheel 141 is disposed on the front end of the main frame 11s. Each second traveling wheel 142 is disposed on the rear end of the main frame 11s. The operating assembly, the power output assembly, and the seat are disposed between the first traveling wheels 141s and the second traveling wheels 142s. Such an arrangement helps maintain the balance of the entire mower effectively, makes the coordination of various components more balanced, and facilitates the user in operating the riding mower 100s. Two first operating elements 151 are included in the operating assembly and are basically symmetrically disposed on two sides of the main frame 11s. In some examples, the first operating elements 151 are disposed at intermediate positions distributed in the front and rear direction and may be disposed on two sides of the seat. The second operating element in the operating assembly is disposed on the front side of the main frame 11s and may be located on the left side of the main frame 11s so that the user can control the riding mower 100s with just one foot. In an example, the arrangement in which the second operating element is disposed on the front side of the main frame 11s and located on the left side of the main frame 11s reserves a relatively large space on the front side of the main frame 11s, thereby enabling the user to move his leg freely.

As an optional example, the power supply apparatus and the grass catcher 25s are disposed on the rear side of the main frame 11s. In some examples, the power supply apparatus is disposed at a rear-side position adjacent to the second traveling wheels 142s, and the grass catcher 25s is disposed on the upper side of the power supply apparatus. In this example, since the power supply apparatus is provided with multiple battery packs, the power supply apparatus occupies a certain volume and has a certain mass. Because being provided with components including a cutting head and the drive motor 213s, the power output assembly disposed between the first traveling wheels 141s and the second traveling wheels 142s has a certain volume and mass and is disposed on the lower side of the main frame 11s. The power supply apparatus is disposed on the rear side adjacent to the second traveling wheels; accordingly, in a plane intersecting an extension plane of the main frame 11s, the power supply apparatus and the power output assembly are disposed symmetrically about the plane. Such an arrangement effectively adjusts the counterweight of the riding mower 100s, makes the ratio of the weight in the front and rear direction of the entire mower to the weight in the up and down direction of the entire mower more balanced, further stabilizes the riding mower 100s, and effectively improves the stability and security in the operating process.

Additionally, the grass catcher 25s is disposed on the upper side of the power supply apparatus and at least partially extends to the rear side of the power supply apparatus so that the upper space of the power supply apparatus and the rear space of the power supply apparatus are utilized effectively. Under the premise of not interfering with other components of the riding mower 100s, the space of the entire mower is utilized to the utmost extent. In an example, the grass catcher 25s is connected to the main frame 11s through a group of connection rods. Such an arrangement enables the grass catcher 25s to make full use of the stereoscopic space on the upper side of the power supply apparatus and on the rear side of the power supply apparatus, not to contact the power supply apparatus, and not to squeeze the battery compartment 162s of the power supply apparatus. Moreover, the power supply apparatus and the grass catcher 25s are disposed in different stereoscopic space ranges, facilitating the user in adjusting or maintaining the power supply apparatus or the grass catcher 25s separately. In some optional examples, the riding mower 100s includes a grass catching mode and a grass discharging mode. When the riding mower 100s is in the grass catching mode, the grass catcher 25s is mounted on the upper side of the power supply apparatus. When the riding mower 100s is in the grass discharging mode, the grass catcher 25s is detached. In an example, when the riding mower 100s is in the grass discharging mode, a sunshade may be disposed between the seat and the power supply apparatus. Through the connection rods, the sunshade is connected between the seat and the power supply apparatus. Accordingly, when the user operates the riding mower 100s, the sunshade plays a relatively sound shielding role; moreover, the gap space between the seat and the power supply apparatus is better utilized.

As shown in FIGS. 37 to 40, the riding mower 100s further includes a control module 31s. The control module 31s is disposed on the lower side of the seat and serves as a control center to control the operation of the entire riding mower 100s and the operation of components electrically connected to the control module 31s. The main frame 11s extends in a first plane 103s. The first straight line 101s is located in the first plane 103s. The main frame 11s is basically symmetrical about the first straight line 101s. In the direction of a second straight line 105s extending in the left and right direction and parallel to the first axis 102s, the main frame 11s is further basically symmetrical about the second straight line 105s. The second straight line 105s is also located in the first plane 103s. On a second plane 104s extending through the second straight line 105s and perpendicular to the first plane 103s, the seat is disposed on the main frame 11s and at least partially extends through the second plane 104s. The first straight line 101s and the second straight line 105s have an intersection 106s. The control module 31s is basically located in the range of the intersection 106s between the first straight line 101s and the second straight line 105s. That is, the control module 31s is basically disposed in the middle of the main frame 11s so that the wiring distance of a connection line connecting various components to the control module 31s is reduced. In some examples, the control module 31s includes a drive control board 311s, a fuse 312s, and a power supply management module 313s. The drive control board 311s is configured to control components including the power output assembly and the traveling assembly 14s. The power output assembly is disposed between the first traveling wheels 141s and the second traveling wheels 142s and adjacent to the intersection 106s between the first straight line 101s and the second straight line 105s. The arrangement in which the drive control board 311s configured to control the power output assembly is disposed above the power output assembly helps effectively reduce the length of a connection line connecting the drive control board 311s and the power output assembly. On one hand, such an arrangement effectively simplifies wiring arrangement, fully utilizes the space, and reduces wiring complexity; on the other hand, such an arrangement facilitates maintenance. It is to be understood that a fault can be positioned rapidly on a relatively short connection line, thereby greatly shortening maintenance time and increasing the continuity of the user's operation of the riding mower 100s.

The fuse 312s is connected between the drive control board 311s and the power supply management module 313s. The fuse 312s is configured to protect a drive circuit and prevent a current overload from burning out, for example, a circuit or a motor. In some examples, the fuse 312s is at least partially located on the lower side of the seat and between the drive control board 311s and the power supply management module 313s, thereby facilitating the user in maintenance or repair. In some examples, the power supply management module 313s is disposed on the rear side of the main frame 11s, and the drive control board 311s is disposed on the lower side of the seat and is at least partially located at the intersection 106s between the first straight line 101s and the second straight line 105s. Accordingly, the arrangement in which the fuse 312s is disposed between a power supply control module 31s and the drive control board 311s effectively reduces the length of a connection line between the fuse 312s and the power supply control module 31s and the length of a connection line between the fuse 312s and the drive control board 311s, facilitating the user in maintenance or repair.

The power supply management module 313s is disposed on the rear side of the seat and is located between the seat and the power supply apparatus. The arrangement in which the power supply management module 313s has the closest position to the power supply apparatus enables the space between the seat and the power supply apparatus to be fully utilized and effectively reduces the length of a connection line between the power supply apparatus and the power supply management module 313s, thereby simplifying the wiring arrangement of the entire control module 31s and effectively reducing the complexity of assembly and maintenance.

The control module 31s further includes a junction box 314s configured to connect a connection line from each component and connected to the drive control board 311s through the junction box 314s. In some examples, the junction box 314s is disposed on the upper side of the drive control board 311s, facilitating the electrical connection between the drive control board 311s and the power supply management module 313s and fully utilizing the space on the upper side of the drive control board 311s. Through such a stereoscopic interactive design, under the premise of no interference between the junction box 314s and the drive control board 311s, the space on the lower side of the seat can be effectively utilized, simplifying the assembly process, optimizing the design of wiring arrangement, and thereby greatly facilitating the user in use and maintenance.

As shown in FIG. 41, the main frame 11s extends in the front and rear direction. In a projection plane perpendicular to the up and down direction, the projection of the main frame 11s in the up and down direction in the projection plane is basically rectangular. In some examples, the main frame 11s extends basically in a plane and is an integrated structure. The arrangement in which the main frame 11s extends in a plane effectively lowers the center of gravity of the main frame 11s and enables the center of gravity of the entire mower to be at a relatively low position when the main frame 11s is provided with various components. Additionally, the arrangement in which the main frame 11s is an integrated structure enhances the structural strength of the main frame 11s and reduces assembly steps. The main frame 11s also adopts a modular design and thus can meet the needs of different platforms.

In some examples, the main frame 11s includes a first rod 113s, a second rod 114s, and a third rod 115s. The first rod 113s and the second rod 114s are parallel to each other and are parallel to the direction of the first straight line 101s. The third rod 115s connects the first rod 113s and the second rod 114s and is located on the front side of the main frame 11s. The first rod 113s, the second rod 114s, and the third rod 115s are securely connected or integrally formed. As an optional example, the third rod 115s is provided with a connection hole 115a configured to connect the first traveling wheels 141s. The connection hole 115a and the third rod 115s are securely connected or integrally formed. The junction between the third rod 115s and the first rod 113s and the junction between the third rod 115s and the second rod 114s are each provided with a reinforcing portion 115b. The reinforcing portion 115b may be a connection block in the shape of a right triangle and can increase the connection area between the third rod 115s and the first rod 113s and the connection area between the third rod 115s and the second rod 114s, thereby enhancing the structural strength of the main frame 11s. It is to be understood that the first rod 113s, the second rod 114s, and the third rod 115s may be securely connected or integrally formed. A third connection plate 116s is disposed between the first rod 113s and the second rod 114s. The third connection plate 116s is disposed on the front side of the main frame 11s and is parallel to or intersects the second connection plate 233s. The third connection plate 116s can match the first connection plate 232s and the second connection plate 233s, making the main frame 11s more stable, enhancing the structural strength of the main frame 11s, and enabling the main frame 11s to form a stable whole. The third connection plate 116s extends in a plane and is formed with a pedal portion 116a configured for being pressed down. An anti-collision rod 117s is disposed on the rear side of the first rod 113s and on the rear side of the second rod 114s. The cross section of the anti-collision rod 117s is circular. When the power supply apparatus is mounted on the main frame 11s, the anti-collision rod 117s is configured to surround the space where the power supply apparatus is located and is at least partially located outside the space where the power supply apparatus is located. In this case, when an external object impacts the riding mower 100s, especially the power supply apparatus, the anti-collision rod 117s effectively avoids the direct impact of the external object and bears most of the kinetic energy, preventing the power supply apparatus, when being impacted, from being damaged and causing a certain potential safety hazard.

The main frame 11s is an enclosed frame structure surrounded by pipes with a rectangular section. The arrangement of the rectangular pipes enables each component connected to the pipes to have a relatively large connection surface with the main frame 11s, thereby making the connection between each component and the main frame more stable. Moreover, such an arrangement facilitates the welding of the main frame 11s so that the main frame 11s has a large welding surface, thereby ensuring the overall stiffness of the main frame 11s.

As shown in FIG. 42, in this example, the riding mower 100s further includes a parking system. The parking system 41s includes a pedal 411s, a pedal arm 412s, a first rotatable member 413s, a base 414s, a ratchet 415s, a first elastic member 416s, a second elastic member 417s, a second rotatable member 418s, and a third rotatable member 419s. The pedal 411s, the pedal arm 412s, and the first rotatable member 413s constitute a pedal assembly. In this example, the pedal assembly is the second operating element. The pedal arm 412s includes two running sections. When the pedal 411s enables the pedal arm 412s to be in the first section, the riding mower 100s is in the non-parking state. When the pedal 411s enables the pedal arm 412s to be in the second section, the riding mower 100s is in the parking state.

As shown in the figure, a rotation stop system 42s matching the parking is disposed on the right side of the base 414s. In some examples, the rotation stop system 42s includes a triggering member 421s, a contact member 422s, and a rotation stop switch 423s. The triggering member 421s and the first rotatable member 413s are configured to rotate synchronously. In the rotation process of rotating with the first rotatable member 413s, when rotating to the preset position, the triggering member 421s triggers the contact member 422s. The contact member 422s triggers the rotation stop switch 423s. The rotation stop switch 423s controls a second motor to stop rotation so that the power of the second traveling wheels 142s is cut. The second traveling wheels 142s are only subject to the braking action and thus can be braked quickly. It is to be explained here that the rotation stop switch 423s only controls the second motor to stop rotation in the triggered state. The rotation stop switch 423s does not control the rotation of the second motor in the case where the rotation stop switch 423s is not triggered or in the case where the contact member 422s is reset after the rotation stop switch 423s is triggered; that is, the rotation stop switch 423s can only pause the second motor. The triggering member 421s is formed with or is connected to a triggering portion 421a disposed at the preset position. In this example, the triggering member 421s has a first section and a second section. The triggering portion 421a is disposed on the second section. In fact, the entire second section can trigger the triggering member 421s; that is, the second section can be considered as the triggering portion 421a. The triggering member rotates in the first section and does not trigger the triggering contact 422. In some optional examples, the triggering portion 421a is disposed at a critical position for the riding mower 100s entering the parking state from the non-parking state. In fact, the triggering portion 421a may further be arranged before the riding mower 100s enters the parking state, thereby facilitating the user in braking.

In some examples, the base 414s is further formed with a slide rail extending through the base 414s in the left and right direction. The triggering member 421s is securely connected to the first rotatable member 413s by a fastening piece. The triggering member 421s rotates synchronously with the first rotatable member 413s and is within the range of the slide rail. In some optional examples, the slide rail includes a first slide rail 414a and a second slide rail 414b that are located in different rotation radii. The first slide rail 414a and the second slide rail 414b are each an arc centered on a point where the first central axis 102 extends through the base 414s. The first slide rail 414a is closer to the preceding center compared with the second slide rail 414b. Therefore, the length of the first slide rail 414a is less than the length of the second slide rail 414b. The arrangement of two slide rails can make the connection between the triggering member 421s and the first rotatable member 413s more stable. In the rotation process of rotating with the first rotatable member 413s, the triggering member 421s has no relative displacement from the first rotatable member 413s.

As shown in FIG. 45, an electric working device 100′ disclosed in the present application can be operated by a user riding or standing thereon. For example, the electric working device 100′ may be an electric mowing device or an outdoor mowing device for mowing a lawn and other vegetation. For example, the electric working device 100′ may also be a ride-on snowplow or an electric motorcycle. In some examples, the electric working device 100′ may also be a utility vehicle (UTV). The utility vehicle includes an all-terrain vehicle (ATV), a multi-purpose utility vehicle, and a recreational off-highway vehicle. In some examples, the electric working device 100′ may also be a walk-behind working device. When a user operates the walk-behind working device, the user stands behind the walk-behind working device and pushes the walk-behind working device to travel on a ground.

The directions of front, rear, left, right, up and down are described as the directions shown in FIGS. 45-47. Specifically, when a user rides or stands on the electric working device 100′ on the ground or stands behind the electric working device 100′ on the ground, the direction the user faces is defined as front, the direction the user's back faces is defined as rear, the left-hand direction is defined as left, the right-hand direction is defined as right, the direction toward the ground is defined as down, and the direction away from the ground is defined as up.

As shown in FIGS. 45 to 47, in this example, the electric working device 100′ is an electric mowing device or an outdoor mowing device, taking a stand-on mower as an example. The stand-on mower is for a user to stand on and operate. In the following disclosure, the stand-on mower will be used to refer to the electric mowing device. Similarly, the stand-on mower will be used to refer to the outdoor mowing device. Also, the stand-on mower is used to refer to the electric working device 100′. The above references are for convenience of description and do not limit the electric working device 100′ to other products described above.

The stand-on mower 100′ includes: a vehicle body 10′ and a power supply 20′. The power supply 20′ is disposed on the vehicle body 10′. The power supply 20′ includes a plurality of battery packs 21′ configured to supply power to at least a traveling mechanism 40′ or a working mechanism 80′. Compared with fuel-powered stand-on mowers, the electric stand-on mower 100′ is more environmentally friendly and energy-saving. As shown in FIG. 48, at least one of the plurality of battery packs 21′ is detachably mounted to a coupling portion 22a′ and/or a coupling portion 22b′ of the stand-on mower 100′. The coupling portion 22a′ is provided with a plurality of battery pack receiving cavities, and can simultaneously detach and mount the plurality of battery packs 21′. The coupling portion 22b′ is provided with one battery pack receiving cavity, for detaching and mounting a single battery pack 21′. In some examples, the above coupling portion 22a′ and/or coupling portion 22b′ are disposed in a battery compartment 22′. In some examples, the plurality of battery packs 21′ are configured to be detachable from the stand-on mower 100′ to supply power to other power tools or an utility vehicle 200a′. In some examples, FIG. 48 shows a power supply platform of the battery pack 21′. It can be understood that the battery pack 21′ can supply power to power tools on the power supply platform. In some examples, the power tools may be garden tools, such as a string trimmer, a blower 200b′, a mower 200d′ with a seat, etc. The power tool 200′ may also be a hand-held power tool, such as a chain saw 200e′, a pruner, etc. The power tool may be a walk-behind power tool, such as a walk-behind snowplow, a walk-behind mower 200c′, etc. The power tool may also be a drilling tool, a sawing tool, an electric garden tool, etc., and the power tool may also be a four-wheel utility vehicle 200a′.

As shown in FIGS. 45 to 47 and FIG. 51, the vehicle body 10′ includes a frame 11′, a traveling mechanism 40′, an operating mechanism 30′, a support mechanism 90′, and a working mechanism 80′. The frame 11′ is used to mount the traveling mechanism 40′, the operating mechanism 30′, the support mechanism 90′, and the working mechanism 80′. As shown in FIG. 51, the frame 11′ extends substantially in a front-rear direction, and the frame 11′ includes: longitudinal beams and cross beams. The frame includes a first longitudinal beam 111′ and a second longitudinal beam 112′, which extend in the front-rear direction respectively. The first longitudinal beam 111′ and the second longitudinal beam 112′ are arranged left and right. The frame includes at least a first cross beam 113′ and a second cross beam 114′, wherein the first cross beam 113′ and the second cross beam 114′ extend in a second direction, the second direction intersects the front-rear direction, and the first cross beam 113′ and the second cross beam 114′ intersect the first longitudinal beam 111′ and the second longitudinal beam 112′ respectively. In some examples, the first cross beam 113′ extends in a left-right direction, and the second cross beam 114′ extends in the left-right direction. The first cross beam 113′ is configured as a front end of the frame. In some examples, the first cross beam 113′ is configured as a front bumper. The second cross beam 114′ is disposed at a rear side of the first cross beam 113′.

The traveling mechanism 40′ includes a wheel set 41′ and a drive mechanism 42′. The wheel set 41′ supports the vehicle body 10′, and the drive mechanism 42′ is configured to drive the stand-on mower 100′ to travel. The wheel set 41′ includes rear wheels 411′ and front wheels 412′. In some examples, the rear wheels 411′ include a left rear wheel 411L′ and a right rear wheel 411R'. The front wheels 412′ include a left front wheel 412L′ and a right front wheel 412R'. The left rear wheel 411L′ and the left front wheel 412L′ are disposed outside the first longitudinal beam 111′, and the right rear wheel 411R′ and the right front wheel 412R′ are disposed outside the second longitudinal beam 112′.

The drive mechanism 42′ includes a traveling motor for driving the wheels to rotate. The traveling motor drives the rear wheels 411′ or the front wheels 412′ to rotate, to implement the traveling function of the stand-on mower 100′. In some examples, the number of traveling motors may be one, two, three or four. In some examples, the traveling mechanism 40′ includes a first drive wheel and a second drive wheel that receive power from the traveling motor and are driven to travel. In this example, the first drive wheel is the left rear wheel 411L', and the second drive wheel is the right rear wheel 411R'. The traveling motor includes a first motor 421′ providing driving force to the left rear wheel 411L', and a second motor 422′ providing driving force to the right rear wheel 411R'. For convenience of reference, in the following description, the first drive wheel 411L′ is used to refer to the left rear wheel, and the second drive wheel 411R′ is used to refer to the right rear wheel. The traveling mechanism 40′ adopts independent driving to provide driving force to the first drive wheel 411L′ and the second drive wheel 411R′ respectively. In some examples, the front wheels 412′ are configured as universal wheels, so that the stand-on mower 100′ can turn in other directions deviating from the front-rear direction.

In some examples, the traveling mechanism 40′ includes a traveling track and other components that drive the stand-on mower 100′ to travel, and a drive mechanism, the drive mechanism drives the traveling track to circulate. The first motor drives the left traveling track to rotate, and the second motor drives the right traveling track to rotate. The left traveling track can be understood as the first drive wheel, and the right traveling track can be understood as the second drive wheel.

The operating mechanism 30′ is operated by a user and indicates the user's desired operation to change a working state of the stand-on mower 100′. The operating mechanism 30′ includes a first operating lever 31′ and a second operating lever 32′ for controlling forward, backward, and turning of the stand-on mower 100′. The turning and straight traveling speed of the stand-on mower 100′ are controlled according to tilt angles of the first operating lever 31′ and the second operating lever 32′. In other alternative examples, the operating mechanism 30′ includes a steering wheel, including a circular standard steering wheel, a flat-bottom or flat-top steering wheel, a rectangular steering wheel, a multifunctional steering wheel, a foldable steering wheel, a touch steering wheel, etc.

The support mechanism 90′ is used to support an operator, and the support mechanism 90′ is mounted on the vehicle body 10′. The support mechanism 90′ includes a standing platform 60′, and the standing platform 60′ has a standing surface configured to support the operator. The standing platform 60′ is disposed at a rear portion of the frame 11′, connected to the frame 11′, and at least partially located between the two rear wheels 411′ (the first drive wheel 411L′ and the second drive wheel 411R'). When a user stands on the standing platform 60′ of the support mechanism 90′ and operates the stand-on mower 100′ to work, the stand-on mower 100′ is in a manned state. In some examples, the support mechanism 90′ includes a seat. The seat is mounted to the frame 11′ for a user to sit on. With continued reference to FIG. 46, in some examples, the standing platform 60′ is a foot pedal 61′, which is disposed at a rear portion of the frame 11′, connected to the frame 11′, and located between the two rear wheels 411′.

As shown in FIGS. 45 to 46, the support mechanism 90′ further includes a pad 91′. The pad 91′ provides support for the user's body when the user stands on the foot pedal 61′, and the user can lean against the pad 91′ for control. In this example, the pad 91′ is inclined forward. When the user leans against the pad 91′, more support can be obtained, facilitating operation, reducing the risk of falling, and improving operating comfort.

The working mechanism 80′ is at least partially disposed in a region between the first drive wheel 411L′ and the second drive wheel 411R'. It should be explained that the working mechanism 80′ can be arranged side by side with the first drive wheel 411L′ and the second drive wheel 411R′ along a specific direction (such as the vehicle traveling direction), or can be arranged offset relative to the first drive wheel 411L′ and the second drive wheel 411R′. That is, in a top projection view, a projection of the working assembly 80′ at least partially falls within a longitudinal strip region bounded by the center points of the first drive wheel 411L′ and the second drive wheel 411R′ as left and right boundaries. For example, the main body or key part of the working mechanism 80′ may be disposed at a front side of the first drive wheel 411L′, a front side of the second drive wheel 411R′, or arranged obliquely between the two wheels (partially close to one wheel, partially close to the other wheel), etc.

As shown in FIGS. 45 to 46 and FIG. 62, the working mechanism 80′ is a mowing mechanism. The mowing mechanism is mounted at a bottom of the frame 11′, and at least part of the mowing mechanism is mounted between the first drive wheel 411L′ and the second drive wheel 411R′. In some examples, the mowing mechanism is also mounted between the rear wheels 411′ and the front wheels 412′. In some examples, the working mechanism 80′ is a snowplow mechanism. The snowplow mechanism is mounted at a front of the frame, at least part of the snowplow mechanism is mounted between the first drive wheel 411L′ and the second drive wheel 411R′, and the snowplow mechanism is mounted in front of the front wheels 412′. In some examples, the mowing assembly 80′ may not be provided, for example when the outdoor traveling device is the VTU. For convenience of reference, in the following description, the mowing mechanism 80′ is used to refer to the working mechanism. As shown in FIG. 47, the mowing mechanism 80′ includes a mowing element for mowing grass and a mowing motor 82′ for driving the mowing element. In this example, the mowing element is a mowing blade 81′, and the mowing motor 82′ is specifically configured as a mowing electric motor. In the following, the mowing electric motor 82′ will be used instead of the mowing motor, but this is not to be taken as a limitation of the present invention.

As shown in FIG. 45 and FIGS. 49 to 53, the stand-on mower further includes a central control mechanism 70′. The central control mechanism 70′ includes a housing 71′, and the housing 71′ surrounds to form an accommodating space 72′. The housing 71′ is connected above the frame 11′. In some examples, the housing 71′ is disposed above the standing platform 60′. The operating mechanism 30′ is movably connected to the housing 71′ of the central control mechanism 70′. The support mechanism 90′ is at least partially disposed at a rear side of the central control mechanism 70′.

As shown in FIGS. 49 to 53, the stand-on mower 100′ further includes a circuit board assembly 73′. In the left-right direction, the circuit board assembly 73′ is at least partially disposed between the first longitudinal beam 111′ and the second longitudinal beam 112′. The stand-on mower further includes a mounting member 74′. The mounting member 74′ is connected to the frame 11′. The mounting member 74′ is configured to mount the circuit board assembly 73′, and the mounting member 74′ is movable relative to the frame 11′. In this example, the mounting member 74′ and at least part of the circuit board assembly 73′ are operated to move relative to the frame 11′, so that the circuit board assembly 73′ can be moved to a suitable position to expose the circuit board assembly 73′ without being completely detached from the frame 11′ or completely leaving the frame 11′, providing greater convenience and accessibility for installing, inspecting, and maintaining the circuit board assembly 73′ in the limited space of the stand-on mower 100′.

With continued reference to FIG. 49, the mounting member 74′ is mounted on the frame 11′ and rotatable relative to the frame 11′ about a first axis 701′. In an up-down direction, the first axis 701′ is not higher than the frame 11′. The mounting member 74′ is disposed on the second cross beam 114′, and the mounting member 74′ is rotatable relative to the second cross beam 114′. In the up-down direction, the first axis 701′ is not higher than the second cross beam 114′, thereby ensuring structural compactness and center of gravity controllability. This ensures that key electronic components are physically protected by the frame 11′ without encroaching on the layout space of other systems, achieving an organic integration of mechanical support, dynamic stress decoupling, and core electrical functions.

In some examples, the circuit board assembly 73′ includes a printed circuit board and a housing assembly accommodating the printed circuit board. In some examples, the circuit board assembly 73′ includes a first circuit board assembly 731′. The first circuit board assembly 731′ is configured as a power supply management module, configured to manage the power supply 20′. The power supply management module includes a power supply management board, which is a printed circuit board. In some examples, the power supply management board is electrically connected to the power supply 20′, and includes at least one controller for controlling charging or discharging of the plurality of battery packs in the power supply. The circuit board assembly 73′ further includes a second circuit board assembly 732′ configured to at least control the traveling mechanism 40′. The second circuit board assembly 732′ includes a drive circuit board, which is a printed circuit board, and includes at least one controller for controlling the first motor 421′ and/or the second motor 422′. The controller uses a dedicated control chip, such as a single-chip microcomputer, a microcontroller unit (MCU). The circuit board includes: a printed circuit board (PCB) and a flexible printed circuit (FPC).

In this example, the mounting member 74′ mounts the first circuit board assembly 731′. That is, the first circuit board assembly 731′ rotates relative to the frame 11′ about the first axis 701′ via the mounting member 74′. In this example, the first circuit board assembly 731′ includes at least a first position and a second position relative to the frame 11′. It should be explained that the first position and the second position of the first circuit board assembly 731′ relative to the frame 11′ are positions where the first circuit board assembly 731′ can maintain positioning after being released from operation. In some examples, the first circuit board assembly 731′ may further include a plurality of positions that can maintain positioning. In this example, when the first circuit board assembly 731′ is in the first position, the first circuit board assembly 731′ is connected to the second circuit board assembly 732′, and the first circuit board assembly 731′ at least partially covers the second circuit board assembly 732′. That is, when the first circuit board assembly 731′ moves to the first position, the first circuit board assembly 731′ and the second circuit board assembly 732′ approach each other. In this example, when the first circuit board assembly 731′ is in the second position, the first circuit board assembly 731′ has completed rotation away from the second circuit board assembly 732′. In this example, a limiting support is provided on the frame 11′. When the first circuit board assembly 731′ is in the second position, the limiting support holds the first circuit board assembly 731′. In some examples, when the first circuit board assembly 731′ is in the second position, the first circuit board assembly 731′ and the second circuit board assembly 732′ simultaneously complete rotation about the first axis 701′, that is, the second circuit board assembly 732′ also moves relative to the frame 11′.

In this example, the first circuit board assembly 731′ includes a first control box 7311′, and the second circuit board assembly 732′ includes a second control box 7321′. The housing assembly includes the first control box 7311′ and the second control box 7321′. The power supply management board is disposed in the first control box 7311′, and the drive circuit board is disposed in the second control box 7321′. The mounting member 74′ is connected to the first control box 7311′. In some examples, the first control box 7311′ and the second control box 7321′ are correspondingly provided with a locking portion and a receiving portion. Taking the first control box 7311′ provided with a locking portion 7312′ and the second control box 7321′ provided with a receiving portion 7322′ as an example, when the first circuit board assembly 731′ is in the first position, the locking portion 7312′ engages with the receiving portion 7322′, the position of the second circuit board assembly 732′ relative to the frame 11′ is fixed, and the first circuit board assembly 731′ and the second circuit board assembly 732′ are restricted from relative movement by the engagement of the locking portion 7312′ and the receiving portion 7322′, thereby holding the first circuit board assembly 731′ in the first position. When the first circuit board assembly 731′ needs to move away from the second circuit board assembly 732′, the connection between the locking portion 7312′ and the receiving portion 7322′ is unlocked. In some examples, the locking portion 7312′ and the receiving portion 7322′ can be connected by fasteners. In some examples, the locking portion 7312′ and the receiving portion 7322′ can also be mechanically engaged by a snap-fit structure, an interlocking structure, a binding structure, etc., or can be an electronic locking structure such as magnetic or electromagnetic attraction.

In some examples, the circuit board assembly 73′ is arranged obliquely. In some examples, when the first circuit board assembly 731′ is in the first position, the circuit board assembly 73′ as a whole is arranged obliquely. The circuit board assembly 73′ extends along a first plane S1′, and the housing assembly extends along the first plane S1′. An angle α′ between the first plane S1′ and a second plane S2′ where the frame 11′ (i.e., the first longitudinal beam 111′ or the second longitudinal beam 112′) is located is greater than 0° and less than 90°. In some examples, the angle α′ between the first plane S1′ and the second plane S2′ where the frame 11′ (i.e., the first longitudinal beam 111′ or the second longitudinal beam 112′) is located is greater than or equal to 20° and less than or equal to 80°. In some examples, the angle α′ between the first plane S1′ and the second plane S2′ where the frame 11′ is located is greater than or equal to 15° and less than or equal to 55°. In some examples, the angle α′ between the first plane S1′ and the second plane S2′ where the frame 11′ is located is greater than or equal to 30° and less than or equal to 45°. In some examples, the angle α′ between the first plane S1′ and the second plane S2′ where the frame 11′ is located may also be equal to 10°, 20°, 30°, 40°, 50°, 60°, 80°, 90°. The above second plane S2′ where the frame 11′ (i.e., the first longitudinal beam 111′ or the second longitudinal beam 112′) is located can be understood as a plane parallel to the ground plane and supporting the wheels. In some examples, the circuit board assembly 73′ extends in a horizontal direction or a vertical direction.

As shown in FIG. 53, the circuit board assembly 73′ includes wiring harnesses for connecting to controlled components and for transmission functions, such as a power wiring harness, a communication wiring harness, and a bus wiring harness. In this example, terminals leading out from the wiring harnesses are disposed on front or rear wall surfaces of the first control box or the second control box. The terminals leading out from the wiring harnesses are disposed on wall surfaces of the first control box or the second control box that are parallel to a board surface of the circuit board. In this example, at least some of the terminals leading out from the wiring harnesses are disposed on a rear wall surface of the second control box, and the rear wall surface of the second control box is closer to an opening of the support mechanism 90′ after disassembly, facilitating maintenance.

In some examples, the power supply management board and the drive circuit board are placed in a control box. In this example, the circuit board assembly 73′ includes a first circuit board assembly 731′. The first circuit board assembly 731′ includes a housing assembly, a power supply management board, and a drive circuit board. The first circuit board assembly 731′ rotates relative to the frame 11′ about the first axis 701′ via the mounting member 74′. In this example, the first circuit board assembly 731′ includes at least a first position and a second position relative to the frame 11′. It should be explained that the first position and the second position of the first circuit board assembly 731′ relative to the frame 11′ are positions where the first circuit board assembly 731′ can maintain positioning after being released from operation. In some examples, the first circuit board assembly 731′ may further include a plurality of positions that can maintain positioning.

As shown in FIGS. 45 and 52 to 56, the central control mechanism 70′ further includes a console 75′ for a user to operate to control the stand-on mower 100′. The console 75′ is disposed above the foot pedal 61′. The housing 71′ surrounds to form an accommodating space 72′, and at least a portion of the circuit board assembly 73′ is disposed in the accommodating space 72′. As shown in FIG. 52, an air vent 711′ is formed on the housing 71′ to allow airflow to enter the housing 71′ through the air vent 711′ to dissipate heat from the circuit board assembly 73′ when the stand-on mower 100′ is traveling. In some examples, in the front-rear direction, the air vent 711′ is located at a front side of the circuit board assembly 73′. The air vent 711′ is provided on a windward side of the housing 71′ to dissipate heat from a heat sink of the circuit board assembly 73′.

With continued reference to FIG. 53, the operating mechanism 30′ is disposed on the console 75′. In this example, the first operating lever 31′ and the second operating lever 32′ are disposed on the console 75′. The console 75′ is further provided with an operator interface 75a′. The operator interface 75a′ includes a display screen 751′ having a display plane. In some examples, the console 75′ further includes switch elements 752′. The switch elements 752′ are operated to input user commands. The switch elements 752′ are disposed on a periphery of the display screen 751′. The switch element 752′ include at least one of a mechanical switch or an electronic switch. In some examples, the display screen 751′ is a touch screen, and user command input is implemented through the touch screen.

In this example, the console 75′ further includes a plurality of operating members 77′. The circuit board assembly 73′ is connected to the operating members 77′ respectively. The plurality of operating members 77′ include a start switch 772′. When the start switch 772′ is activated, powered components of the stand-on mower are powered on or start running. In some examples, the start switch 772′ is a physical switch such as a button, a knob, a lever, or a key. In some examples, the start switch 772′ may be an electronic switch with an electronic identification function, such as password recognition, chip recognition, NFC recognition, and biometric recognition like facial recognition, fingerprint recognition. In some examples, the start switch 772′ is an electronic switch, and a trigger instruction of the electronic switch is sent to the start switch 772′ via a non-contact signal transmission method such as IoT, Bluetooth, remote control. In this example, the stand-on mower 100′ has at least two types of start switches 772′. In some examples, it includes a physical switch and an electronic switch with an electronic identification function. In some examples, it includes a physical switch and a non-contact signal transmission electronic switch. In some examples, it includes all three types of switches.

As shown in FIGS. 52 to 53, the housing 71′ of the console 75′ includes an upper surface 712′, side surfaces 713′, a front surface 714′, and a rear surface 715′. The display screen 751′ is disposed on the upper surface 712′. The rear surface 715′ is close to the user, and the front surface 714′ is disposed in front of the rear surface 715′. In this example, the first operating lever 31′ and the second operating lever 32′ are movably disposed on the upper surface 712′, and extend out of the upper surface 712′ for easy operation by the user. The air vent 711′ is disposed on the front surface 714′.

The battery compartment 22′ is disposed between the front wheels 412′ and the central control mechanism 70′. In this example, the battery compartment is disposed in front of the console 75′, that is, the circuit board assembly 73′ is disposed at a rear of the power supply 20′. In this example, the circuit board assembly 73′ is disposed at a rear of the battery compartment 22′, and the air vent 711′ is disposed at a rear of the battery compartment 22′. In the up-down direction, the air vent 711′ is at least partially disposed above the battery compartment 22′, so that when the stand-on mower 100′ is running, the battery compartment does not completely cover the air vent 711′ on the housing 71′, affecting airflow from entering the housing 71′ through the air vent 711′.

In this example, the standing platform at least partially extends to the rear of the central control mechanism. The pad 91′ is detachably connected to the vehicle body 10′. The pad 91′ can be detached from the vehicle body 10′ during transportation or when cleaning is required. The pad 91′ is detachably connected to the housing 71′ of the console 75′. In some examples, the pad 91′ is connected to the rear surface 715′. The pad 91′ and the housing 71′ of the console 75′ are cooperatively provided with a limiting structure. When the pad 91′ needs to be fixed to the housing 71′, the limiting structure locks the pad 91′ and the housing 71′. When the pad 91′ needs to be detached, the limiting structure is released by an unlocking operation, and the pad 91′ can be separated from the housing 71′, exposing the accommodating space 72′, so that the user can operate some components in the accommodating space 72′. In some examples, the limiting structure includes a movable snap-fit structure, or a threaded structure, or a hook-hole structure. The unlocking operation drives the limiting structure to release the limit, including one-key unlocking, for example, a single press or a single toggle changes the limiting structure from a limiting state to a released state, or includes linear release unlocking, for example, the limiting state of the limiting structure changes linearly toward the released state with each operation. At the same time, the above unlocking operations do not require tools or specialized tools, enabling tool-free installation and detachment of the pad 91′.

As shown in FIGS. 53 to 56, the operating mechanism 30′ further includes a height adjustment handle 33′. The height adjustment handle 33′ is connected to a height adjustment mechanism 50′. The height adjustment mechanism 50′ is configured to adjust a distance of the mowing mechanism 80′ from the ground. In order to facilitate an operator standing on the mower to adjust the height of the mowing mechanism 80′, the height adjustment handle 33′ is configured to extend outside the frame 11′ of the stand-on mower 100′. The height adjustment handle 33′ is movably connected to the frame 11′. The height of the height adjustment handle 33′ is greater than or equal to the height of the first operating lever 31′ and the second operating lever 32′. The height adjustment handle 33′ is disposed on the right side of the central control mechanism 70′, so that the user standing on the standing platform 60′ can still operate the height adjustment handle 33′ to drive the height adjustment mechanism 50′ to adjust the height of the mowing mechanism 80′. The specific adjustment method and principle of the height adjustment mechanism 50′ will be described in detail below.

The stand-on mower 100′ further includes a cooling device 12′. The cooling device 12′ is powered by the power supply 20′ and attached to the operating mechanism 30′ to lower a temperature of the operating mechanism 30′. As known from related art, the stand-on mower 100′ is usually used for outdoor lawn maintenance work. When working in an open-air environment, the operating mechanism 30′ (such as operating levers, handles) of the stand-on mower 100′ is exposed to direct sunlight for a long time, causing its surface temperature to rise sharply. Excessively high temperature not only reduces the user's operating comfort, but also has a potential risk of scalding the user's hands. In the present application, the cooling device 12′ is provided on the operating mechanism 30′ to actively lower the temperature of a key grip region of the operating mechanism 30′. When the user drives and operates the stand-on mower 100′ in a high-temperature environment (such as summer noon), the cooling device 12′ can be quickly activated and effectively cool down, thereby significantly improving user comfort and avoiding scalding risk.

As shown in FIG. 54, the cooling device 12′ is connected to the power supply 20′ of the stand-on mower 100′ via a wire harness 123′ to achieve power supply. After the cooling device 12′ is powered on and activated, it can significantly lower the temperature of a target region of the operating mechanism 30′ within 180 seconds, with a temperature reduction amplitude of up to 30° C. The cooling device 12′ includes: a cooling element 121′ and a heat sink 122′ for dissipating heat from a hot side of the cooling element 121′. The cooling element 121′ may be a thermoelectric cooling chip (i.e., a Peltier effect device). The cooling element 121′ has a cold side and a hot side. When powered on, the cold side absorbs heat from the surface of the operating mechanism 30′ in contact therewith, achieving active cooling. The heat sink 122′ is in close thermal coupling with the hot side of the cooling element 121′. The heat sink 122′ efficiently dissipates waste heat generated on the hot side of the cooling element 121′ during operation to the surrounding environment, ensuring that the cooling element 121′ can work continuously and stably. The heat sink 122′ is generally made of a metal material with high thermal conductivity (such as aluminum alloy) and is designed with fin structures that increase the heat dissipation surface area. In some examples, the heat sink 122′ is combined with an active heat dissipation element such as a fan (not shown) to enhance heat dissipation efficiency.

In this example, the cooling device 12′ is disposed on the first operating lever 31′, the second operating lever 32′, and the height adjustment handle 33′. In some examples, the first operating lever 31′, the second operating lever 32′, and the height adjustment handle 33′ each include an operating region for the user to stably grip. The cooling device 12′ is disposed in the operating region. In some examples, the cooling element 121′ (e.g., a cooling chip) is directly attached or fixedly mounted to an outer surface of the operating mechanism 30′ (e.g., an operating lever, a handle), with its cold side in close contact with the user grip region. The structure is simple and easy to implement. In some examples, at least part of the first operating lever 31′, the second operating lever 32′, and the height adjustment handle 33′ are hollow, and the cooling element 121′ (e.g., a cooling chip) can be arranged in an internal cavity of the operating mechanism 30′. In this configuration, the cold side of the cooling element 121′ conducts heat to the user grip region through an inner wall of the operating mechanism 30′, for example, a well thermally conductive metal or composite material layer is provided below the operating region. Such an embedded design better protects the cooling element 121′ and makes the appearance of the operating region neater and the grip smoother.

The cooling device 12′ is connected to the circuit board assembly 73′. The circuit board assembly 73′ controls the working state of the cooling device 12′, for example, receiving user commands (such as via a specific button) or automatically turning the cooling device 12′ on or off according to preset conditions (such as an ambient temperature sensor signal). It precisely controls the operating parameters of the cooling device 12′, for example, adjusting the cooling power of the cooling element 121′ by adjusting an input current or voltage, to adapt to different ambient temperatures and user needs, achieving energy efficiency optimization. It can monitor the operating status (such as temperature, current) of the cooling device 12′ and implement protective measures (such as power reduction operation or shutdown) in abnormal situations (such as overheating, overload).

In some examples, the circuit board assembly 73′ is provided with a communication device 733′ for receiving operation signals from an external device. In some examples, the communication device 733′ includes a wireless communication device such as a remote wireless network. The wireless communication device communicates using other protocols (e.g., Wi-Fi, cellular protocols, proprietary protocols, etc.) over different types of wireless networks. For example, the wireless communication device can be configured to communicate via the Internet, a local area network (LAN), a wide area network (WAN), or a combination thereof via Wi-Fi, or via a piconet (e.g., using infrared or NFC communication). In other examples, the wireless communication device can be a short-range communication protocol (such as Bluetooth), and in other examples, the wireless communication device can be a wired network using, for example, a serial protocol (e.g., USB, USB-C, FireWire, etc.).

In this example, the circuit board assembly 73′ is provided with a Bluetooth module to communicate with an external device. The external device includes a mobile device, such as a smartphone, a tablet computer, a cellular phone, a laptop computer, a smart wearable device, etc. The user communicates with the Bluetooth module via the external device, and the Bluetooth module sends received operation instructions in the form of digital signals to the circuit board assembly 73′, and the circuit board assembly 73′ controls the operation of the stand-on mower 100′. The circuit board assembly 73′ can also feed back the device status of the stand-on mower 100′ to the external device for user viewing.

In this example, at least starting or stopping, temperature, or adaptive working mode of the cooling device 12′ can be set and/or adjusted via the external device. For example, the temperature of the cooling device 12′ is set, the circuit board assembly 73′ adjusts the cooling power of the cooling device 12′, or the adaptive working mode is set to automatically adjust the cooling temperature according to the ambient temperature.

A working mode and other functions of the stand-on mower 100′ can also be set and/or adjusted via the external device. The battery status, device parameters of the stand-on mower 100′, component status, power supply status, and fault information can also be queried via the external device. The fault information also includes the number of faults, fault or abnormality information content (e.g., motor temperature too high, or battery power too low, etc.), fault handling method, etc.

In some examples, the stand-on mower 100′ includes a temperature reduction device 13′. The temperature reduction device 13′ is configured to establish a heat transfer relationship with the operating region (i.e., the user grip portion) of the operating mechanism 30′ to absorb heat from the operating mechanism 30′. Through this heat transfer relationship, heat from the operating region is actively absorbed or dissipated, thereby lowering its temperature, improving user grip comfort and preventing scalding. In some examples, the temperature reduction device 13′ is capable of generating a thermoelectric effect or a phase change effect. In some examples, the temperature reduction device 13′ includes the cooling device 12′ described above that works using the thermoelectric effect (Peltier effect). When the device is powered on, its cold side is in close thermal coupling with the operating region, directly absorbing heat from the region and transferring it to the hot side, and then dissipating the heat to the ambient air via a heat dissipation system (such as the heat sink 122′ and a fan). In some examples, the temperature reduction device 13′ includes a phase change material 14′, a passive structure that absorbs heat. The phase change material 14′ is configured to undergo a phase change (e.g., from solid to liquid) when the temperature of the operating region rises to its phase change point (e.g., melting point), thereby absorbing and storing a large amount of latent heat during the process, effectively suppressing a rapid temperature rise of the operating region. In some examples, a container or flexible bag encapsulating the phase change material 14′ is sleeved (i.e., mounted by covering) on the outer surface of the operating region. In some examples, for an operating lever/handle with a cavity structure (e.g., a hollow rod), the phase change material 14′ is arranged (filled or encapsulated) in the cavity inside the operating region.. In some examples, a dedicated interlayer cavity is provided inside the housing structure of the operating region, and the phase change material 14′ is arranged in the interlayer cavity.

In some examples, the support mechanism 90′ includes a temperature reduction device 13′. The temperature reduction device 13′ is configured to establish a heat transfer relationship with the operating region (i.e., the user contact region) of the support mechanism 90′ to absorb heat from the operating mechanism 30′. Through this heat transfer relationship, heat from the operating region is actively absorbed or dissipated, thereby lowering its temperature. In some examples, taking the stand-on mower 100′ as an example, the temperature reduction device 13′ is disposed on the pad 91′. For example, the temperature reduction device 13′ is disposed on an outer surface of the pad 91′. Or the temperature reduction device 13′ is disposed inside the pad 91′. In some examples, taking a ride-on tool or an outdoor vehicle (such as an electric motorcycle or an all-terrain vehicle) as an example, it is equipped with a seat, and the temperature reduction device 13′ is disposed on the seat. For example, the temperature reduction device 13′ is disposed on an outer surface of the seat. Or the temperature reduction device 13′ is disposed inside the seat. In some examples, taking a walk-behind tool as an example, the operating mechanism 30′ is configured as a push handle for the user to push the machine, the temperature reduction device 13′ is configured to establish a heat transfer relationship with the push handle to absorb heat from the operating mechanism 30′. Through this heat transfer relationship, heat from the operating region is actively absorbed or dissipated, thereby lowering its temperature, improving user grip comfort and preventing scalding.

As shown in FIGS. 57 to 60, the battery compartment 22′ includes a main compartment 221′ and a compartment cover 222′. The main compartment 221′ forms an accommodating space 2211′ for accommodating the battery pack 21′. The compartment cover 222′ is rotatably connected to the main compartment 221′ and can at least partially enclose the main compartment 221′. As described above, the stand-on mower 100′ is usually used for outdoor lawn maintenance work. When working in an open-air environment, the battery compartment 22′ of the stand-on mower 100′ is exposed to direct sunlight for a long time, causing the temperature inside the battery compartment 22′ to rise sharply. Excessively high temperature affects the performance of the battery. For example, the high-temperature environment will cause electrolyte decomposition, increased internal resistance, and cycle life decay of lithium batteries. As shown in FIG. 60, in this example, an infrared reflective coating 2221′ is added on a surface of the compartment cover 222′. The infrared reflective coating 2221′ reflects infrared radiation energy in the 780-2500 nm band of the solar spectrum, effectively blocking the heat radiation conduction path, thereby maintaining the temperature inside the compartment within a safety threshold. For example, the infrared reflective coating 2221′ reflects solar heat radiation, thereby lowering the temperature inside the compartment. In some examples, the infrared reflective coating 2221′ includes a rare earth-based composite coating, a silver-plated coating, a radiative cooling type nanoporous coating. In some examples, the infrared reflective coating 2221′ is applied on an outer surface of the compartment cover 222′ to directly block incident radiation. In some examples, the infrared reflective coating 2221′ is further applied on an inner surface of the compartment cover 222′ to reduce heat absorption through secondary reflection. In some examples, the internal temperature of the battery compartment 22′ using the technical solution of this example is reduced by 5.2 to 10.6° C. compared with an untreated compartment body.

The battery compartment 22′ is connected to the frame 11′. In some examples, the battery compartment 22′ is connected to the frame 11′ via a set of support bases. In some examples, the main compartment 221′ is connected to the frame 11′ via a set of support bases. The support base may include fasteners (such as bolts), mounting brackets, and necessary damping elements (such as rubber pads) to ensure that the battery compartment 22′ remains stable during vehicle travel or working vibrations. In this example, at least part of the main compartment 221′ is disposed below the frame 11′ in the vertical direction. In some examples, at least a bottom 2212′ of the main compartment 221′ is disposed below the frame 11′ in the vertical direction. That is, a bottom portion of the main compartment 221′ extends downward to a position below the frame 11′ in the mounted state. In some examples, compared with a solution where a bottom of the main compartment is mounted above the frame, the installation height of the battery compartment 22′ in this example is lowered by a height value greater than or equal to 50 mm.

The bottom 2212′ of the battery compartment 22′ is lowered to a position below the frame 11′ and suspended above the mowing mechanism 80′, which can effectively utilize the space between the battery pack and the mowing mechanism 80′, lowering the installation height of the battery compartment 22′ and the battery pack 21′. Since the weight of the battery pack 21′ accounts for a large proportion of the entire machine, the downward extension of the bottom 2212′ of the battery compartment 22′ directly causes the center of gravity of the battery pack 21′ to significantly shift downward. A lower center of gravity greatly enhances the lateral and longitudinal stability of the mower during traveling, turning, and slope operation, effectively suppressing rollover risk and improving handling safety. It fully utilizes the vertical space, significantly lowers the overall center of gravity, thereby greatly improving traveling stability and handling safety, while optimizing the operator's field of view, reflecting good space layout and performance optimization effects. Lowering the installation position of the battery pack 21′ effectively lowers the center of gravity, making the center of gravity lower, traveling more stable, and optimizing the field of view.

In some examples, a first connector 224′ and a second connector 225′ are disposed between the compartment cover 222′ and the main compartment 221′. The first connector 224′ is disposed at ends of the compartment cover 222′ and the main compartment 221′, and the compartment cover 222′ is rotatable about an axis of the first connector 224′. The second connector 225′ includes a first connection end 2251′ and a second connection end 2252′. The first connection end 2251′ is disposed at a middle portion of the compartment cover 222′, and the second connection end 2252′ is disposed at the end of the main compartment 221′ near the first connector 224′. A gas spring 2253′ is disposed between the first connection end 2251′ and the second connection end 2252′, and the gas spring 2253′ is rotatable about the first connection end 2251′ and the second connection end 2252′.

The gas spring 2253′ is pre-charged with gas. When the compartment cover 222′ is lifted to a first preset angle, the gas spring 2253′ outputs a thrust to support the compartment cover 222′ to automatically rotate about the first connector 224′ to a fully open state, at which time the battery pack 21′ can be detached or mounted. In this example, when the compartment cover 222′ needs to be closed, after the compartment cover 222′ is lowered to a second preset angle, the gas spring 2253′ outputs a thrust to support the compartment cover 222′ to automatically rotate about the first connector 224′ to a fully closed state. In some examples, the first preset angle corresponds to or is the same as the second preset angle. In some examples, the first preset angle and the second preset angle may not correspond or be the same.

In fact, the second connector 225′ has a stop point at which thrust cannot be output. When the user opens or closes the compartment cover 222′, the user needs to manually push the compartment cover 222′ across the stop point, and then the gas spring 2253′ can automatically output a thrust. By calculating the balance point (i.e., the above stop point) between a spring support force of the gas spring 2253′ and a gravity of the compartment cover 222′, the compartment cover 222′ can automatically open after being turned over a certain angle (i.e., the stop point), and can automatically close after being turned to a certain angle (i.e., the stop point) during closing. The specific calculation method is as follows:

As shown in FIG. 59, it assumed that the gravity mg′ of the compartment cover and the elastic force F2′ of the gas spring 2253′ (which actually has some variation) are substantially constant. The gravity mg′ and the elastic force F2′ of the gas spring 2253′ serve as a driving force or a resisting force, respectively. During the movement process of the compartment cover 222′ from the closed state to the stop point, the angular change value β′ is greater than the angular change value γ′ of the gas spring 2253′ in this movement process. Assume that the distance from the center of mass G′ of the compartment cover 222′ to the axis of the first connector 224′ is Lg′, and the distance from the elastic force F2′ of the gas spring 2253′ to the axis of the first connector 224′ is Lf'. It can be understood that Lg′ is the moment arm of the gravity mg′ of the compartment cover 222′ during the rotation of the compartment cover 222′, and Lf′ is the moment arm of the elastic force F2′ of the gas spring 2253′ during the rotation of the compartment cover 222′.

During the process of opening the compartment cover 222′, Lg′ gradually decreases; during the process of closing the compartment cover 222′, Lg′ gradually increases, and Lg′ is maximum when the compartment cover 222′ is fully closed. During the process of opening the compartment cover 222′, the moment of the elastic force F2′ first increases and then decreases. At the stop point, according to a lever principle, F2′*Lf′ and mg′*Lg′ reach equilibrium, i.e., F2′ * Lf′ =mg′*Lg′. During the process of opening the compartment cover 222′, when the position of the compartment cover 222′ is above the stop point, the moment of the gas spring 2253′ increases, and F2′*Lf′ is greater than mg′*Lg′, so the compartment cover 222′ flips outward. At the same time, after crossing the stop point, the moment of the elastic force F2′ also gradually decreases, so that the force for automatically opening the compartment cover 222′ is reduced, reducing noise and impact. During the process of closing the compartment cover 222′, when the position of the compartment cover 222′ is below the stop point, the moment of gravity increases, and mg′*Lg′ is greater than F2′*Lf', so the compartment cover 222′ moves toward closure. In some examples, the balance point, i.e., the stop point, is configured in a range where the variation angle β′ of the compartment cover 222′ is 40° to 50°. The maximum value of the variation angle β′ of the compartment cover 222′, i.e., the maximum opening angle of the compartment cover 222′, ranges from 70° to 80°.

As shown in FIG. 60, the compartment cover 222′ of the battery compartment 22′ is provided with a storage basket 226′. The storage basket 226′ is positioned and mounted on an upper surface 2222′ of the compartment cover 222′, providing a carrying space for the user to temporarily store tools, accessories, or other small items. The storage basket 226′ is detachably connected to the compartment cover 222′, allowing the user to flexibly assemble or remove this component according to actual working needs.

In some examples, the storage basket 226′ can be detached using tools. The storage basket 226′ is connected to the compartment cover 222′ via threaded fasteners (e.g., stainless steel bolts or screws). The upper surface of the compartment cover 222′ is pre-embedded with mounting posts having internal threads. Corresponding through holes are provided at the bottom of the storage basket 226′. During assembly, the fasteners pass through the through holes of the storage basket 226′ and are screwed into the mounting posts to achieve reliable fixation; during detachment, the fasteners are loosened using tools (such as a wrench or screwdriver) to separate the storage basket 226′. This method is structurally robust and has good vibration resistance.

In some examples, the installation of the storage basket 226′ and the compartment cover 222′ can also be made into a tool-free quick-release structure. For example, an elastic snap-lock mechanism is used to achieve quick assembly and disassembly. At least two sets of positioning sockets are provided on the upper surface 2222′ of the compartment cover 222′, with wedge-shaped guide grooves inside the sockets. Corresponding positions at the bottom of the storage basket 226′ are provided with elastic claws, and the ends of the claws have protrusions matching the wedge-shaped grooves. During assembly, the storage basket 226′ is pressed onto the surface of the compartment cover 222′, and the claws slide along the wedge-shaped grooves until the protrusions engage into the locking recesses of the sockets. During detachment, the claw release levers are pulled outward to disengage the protrusions from the recesses, and then the storage basket 226′ can be lifted up. This solution requires no tools and has high operation efficiency.

In some examples, the storage basket 226′ is at least partially made of metal. In some examples, the storage basket 226′ is made of a metal material, such as lightweight aluminum alloy, stainless steel, galvanized steel plate, etc. Under the premise of ensuring a load-bearing capacity (≥5 kg), the weight is reduced by a perforated mesh plate structure (mesh diameter 8-15 mm) and folded edge reinforcement ribs.

In this example, the weight of the storage basket 226′ accounts for 35% of the weight of the battery compartment 22′. The compartment cover 222′ has the storage basket 226′, which can be used when short-term transportation of items is required. When the storage function is not needed, the storage basket 226′ can be removed to reduce the overall weight of the machine.

As shown in FIGS. 61 to 65, the mowing mechanism 80′ includes a mowing deck 83′. The mowing deck 83′ has a cutting chamber 833′ that opens downward. The cutting chamber 833′ accommodates at least part of the mowing blade 81′. The mowing deck 83′ includes a top wall 831′, a side wall 832′ extending downward from the top wall 831′ and forming a circumferential enclosure, and an opening facing downward. The mowing motor 82′ is disposed above the top wall 831′, and an output shaft of the mowing motor 82′ passes through the top wall 831′ to drive the mowing blade 81′.

The height adjustment mechanism 50′ connects the height adjustment handle 33′ and the mowing deck 83′. By operating the height adjustment handle 33′, the posture or position of the height adjustment mechanism 50′ is changed to drive the mowing deck 83′ to move, thereby adjusting the distance H of the mowing mechanism 80′ from the ground. As shown in FIG. 61, the height adjustment mechanism 50′ includes a linkage assembly 51′ and a deck hanging assembly 52′. The deck hanging assembly 52′ includes a first hanging member 521′ connecting a front portion of the mowing deck 83′ and the linkage assembly 51′, and a second hanging member 522′ connecting a rear portion of the mowing deck 83′ and the linkage assembly 51′. This ensures that when the position of the mowing deck 83′ is adjusted, the mowing deck 83′ is balanced in force.

As shown in FIG. 64, it is a schematic structural view of the mower height adjustment mechanism 50′ in a first state according to this example. In this state, the mowing deck 83′ reaches a lowest position within its travel range, and the distance H of the mowing mechanism 80′ from the ground is the minimum value. At this time, the height adjustment handle 33′ is stably positioned at a first position marked on an operation panel 53′ (usually marked as “Min” or “1” scale position) through the transmission action of the linkage assembly 51′. This position constitutes a reference zero point for height adjustment operations. As shown in FIGS. 61 and 63, a typical working condition where the height adjustment mechanism 50′ is switched to a second state is presented. The operator moves the height adjustment handle 33′, and through the displacement or posture change of the linkage assembly 51′, the mowing deck 83′ is driven to deflect upward. When the height adjustment handle 33′ is positioned at a second position on the operation panel 53′, the mowing mechanism 80′ as a whole is lifted, and this height corresponds to a recommended cutting height for medium grass conditions. It should be noted that the second position is only an exemplary representation of a plurality of optional height positions. In practical applications, the height adjustment mechanism 50′ can achieve at least four discrete working heights such as a third state, a fourth state, etc., and the height adjustment handle 33′ synchronously has corresponding third position, fourth position, etc. that can be precisely locked. The height intervals of each state typically have a predetermined height gradient unit to meet the needs of diverse working scenarios.

As shown in FIGS. 63 and 65, the height adjustment mechanism 50′ further includes an assist assembly 54′. When the height adjustment mechanism 50′ changes from the first state to the second state, the assist assembly 54′ applies a driving force to the linkage assembly 51′ to move toward the second state. In this example, when the height adjustment mechanism 50′ is in the first state, the assist assembly 54′ applies a driving force to the linkage assembly 51′ to move toward the second state, and a limiting force that restricts the movement of the linkage assembly 51′ is greater than the driving force, so that the height adjustment mechanism 50′ is held in the first state, avoiding accidental lifting. In this example, the driving force of the assist assembly 54′ is adjustable, which can match the self-weight differences of mowing mechanisms 80′ of different specifications and adapt to the physical strength differences of different operators. For example, a female operator can increase the driving force to reduce the operating load.

As shown in FIGS. 63 to 65, the assist assembly 54′ includes an elastic member 541′, a connecting arm 542′, and a support arm 543′. The elastic member 541′ is pre-tensioned to store energy. The connecting arm 542′ is connected to the linkage assembly 51′. One end of the elastic member 541′ is connected to the connecting arm 542′, and the other end of the elastic member 541′ is connected to the support arm 543′. The support arm 543′ is connected to the frame 11′. When the height adjustment mechanism 50′ is in the first state (FIG. 64), the elastic member 541′ is pre-tensioned and stores energy, and applies a continuous lifting moment Fa′ (shown in FIG. 63) to the linkage assembly 51′ via the connecting arm 542′. The lifting moment Fa′ points toward the movement trajectory of the second state. The linkage assembly 51′ is locked by a limiting assembly 55′, i.e., the static friction resistance of the linkage assembly 51′ by the limiting assembly 55′ is greater than Fa', so that the entire height adjustment mechanism 50′ is stably held in the first state without external force intervention. When the operator releases the lock of the limiting assembly 55′ and operates the height adjustment handle 33′, the force applied by the user and the driving force Fa′ of the assist assembly 54′ form a superimposed effect, and the combined resultant force overcomes the gravity of the mowing mechanism 80′.

The assist assembly 54′ further includes a preload adjustment assembly, including an adjustment bolt and a pressing plate 544′. The preload adjustment assembly is connected to the support arm 543′. The pressing plate 544′ is connected to the elastic member 541′. The adjustment bolt is connected to the pressing plate 544′. By adjusting the position of the pressing plate 544′ on the adjustment bolt, the preload of the elastic member 541′, i.e., the lifting moment, is adjusted. In this example, the elastic member 541′ is a tension spring. When the height adjustment mechanism 50′ is in the first state (FIG. 64), the tension spring is stretched. When adjustment is required, the stretched length of the tension spring is adjusted via the adjustment bolt. In some examples, a scale indicating ring is further included, configured to indicate the adjustment level or preload magnitude of the current preload adjustment assembly. In some examples, the elastic member 541′ also includes a torsion spring, a gas spring, a leaf spring, etc.

With continued reference to FIGS. 62 to 64, the linkage assembly 51′ includes a first link 511′, a second link 512′, a third link 513′, a first rotating member 514′, a second rotating member 515′, a third rotating member 516′, a fourth rotating member 517′, a first connecting shaft 518′, and a second connecting shaft 519′. The first link 511′ is formed with or connected to the height adjustment handle 33′. A first end 5111′ of the first link 511′ is rotatably connected to the frame 11′, and a second end 5112′ of the first link 511′ is formed with or connected to the height adjustment handle 33′. The second link 512′ is rotatably connected to the first link 511′. In some examples, a hinge portion between the first end 5111′ and the second end 5112′ of the first link 511′ is provided for connection with a first end 5121′ of the second link 512′. A second end 5122′ of the second link 512′ is rotatably connected to a first end 5131′ of the third link 513′ at the first rotating member 514′. The first rotating member 514′ includes a first hinge hole 5141′, a second hinge hole 5142′, and a third hinge hole 5143′, which are eccentrically arranged. The first hinge hole 5141′ is connected to the frame 11′ and serves as a rotation center of the first rotating member 514′, i.e., a hinge hole through which a rotation shaft of the first rotating member 514′ passes. The second hinge hole 5142′ is a hinge hole for rotatably connecting the second end 5122′ of the second link 512′ and the first end 5131′ of the third link 513′, i.e., the second link 512′, the third link 513′, and the first rotating member 514′ are connected at the second hinge hole 5142′. The third hinge hole 5143′ is connected to the mowing deck 83′. In some examples, the third hinge hole 5143′ is connected to the second hanging member 522′ of the mowing deck 83′. A second end 5132′ of the third link 513′ is rotatably connected to the second rotating member 515′. The second rotating member 515′ includes a first hinge hole 5151′, a second hinge hole 5152′, and a third hinge hole 5153′. The first hinge hole 5151′ is connected to the frame 11′ and serves as a rotation center of the second rotating member 515′, i.e., a hinge hole through which a rotation shaft of the second rotating member 515′ passes. The second hinge hole 5152′ is a hinge hole for rotatably connecting the second end 5132′ of the third link 513′. The third hinge hole 5153′ is connected to the mowing deck 83′. In some examples, the third hinge hole 5153′ is connected to the first hanging member 521′ of the mowing deck 83′. In this example, the third link 513′, the first rotating member 514′, the second rotating member 515′, and the mowing deck 83′ utilize the principle of topological transformation of a four-bar linkage. When the height adjustment handle 33′ is operated to rotate, the second link 512′ pulls the first rotating member 514′, thereby changing the angles between the rods of the above four-bar linkage, thus achieving height adjustment of the mowing deck 83′ from the ground.

In this example, a third rotating member 516′ is provided substantially symmetrically left and right with respect to the first rotating member 514′, and a fourth rotating member 517′ is provided substantially symmetrically left and right with respect to the second rotating member 515′, to ensure stable height adjustment of the mowing deck 83′. The third rotating member 516′ connects the frame 11′ and another second hanging member. The first rotating member 514′ and the third rotating member 516′ are connected via the first connecting shaft 518′ to drive both the first rotating member 514′ and the third rotating member 516′ to rotate simultaneously through one height adjustment handle 33′. The fourth rotating member 517′ connects the frame 11′ and another first hanging member. The second rotating member 515′ and the fourth rotating member 517′ are connected via the second connecting shaft 519′ to drive both the second rotating member 515′ and the fourth rotating member 517′ to rotate simultaneously through one height adjustment handle 33′. In this example, the first connecting shaft 518′ and the second connecting shaft 519′ are disposed above the frame 11′. In some small-sized stand-on mowers, due to the small wheel size, the frame 11′ has a low ground clearance. When the mowing deck 83′ is adjusted to a higher cutting height, some components on the mowing mechanism 80′ may be close to the frame 11′, posing a risk of hitting the connecting shafts. In the present application, the first connecting shaft 518′ and the second connecting shaft 519′ are disposed above the frame 11′, increasing the layout space between the mowing deck 83′ and the frame 11′ and reducing the risk of collision.

As shown in FIGS. 63, 64, 66 to 67, the limiting assembly 55′ is configured to constrain the movement of the linkage assembly 51′. After the user completes adjustment of the distance between the mowing mechanism 80′ and the ground via the height adjustment mechanism 50′, the limiting assembly locks the degree of freedom of movement of the height adjustment handle 33′, so that the linkage assembly 51′ maintains the current state, thereby ensuring that the mowing mechanism 80′ is stably maintained at the set working height.

The limiting assembly 55′ includes a mating member 551′ and a limiting pin 552′. In some examples, the limiting pin 552′ is detachably inserted with the mating member 551′ to form a mechanical interlock. The limiting pin 552′ directly locks the height adjustment handle 33′, making it completely incapable of movement or restricting the movement of the height adjustment handle 33′ toward the first position. The operation panel 53′ is disposed on the mating member 551′.

In this example, the limiting pin 552′ is inserted into the mating member 551′ along an axis perpendicular to the movement direction of the height adjustment handle 33′. The mating member 551′ includes mating plates 5511′ disposed on two sides of the movement path of the height adjustment handle 33′. Each mating plate 5511′ is machined with an array of insertion holes 5512′, with hole spacing corresponding to the mowing height adjustment positions, so that the limiting pin 552′ can restrict the height adjustment handle 33′ at multiple positions, achieving multi-stage travel restriction of the height adjustment handle 33′.

The limiting pin 552′ includes a pin body 5521′, a limiting portion 5522′, a magnetic attraction portion 5523′, and a pin head 5524′. The pin body 5521′ is configured as a cylindrical main body structure, with a diameter that is a clearance fit with the insertion holes 5512′. A first end 5525′ of the pin body 5521′ extends into the insertion hole 5512′ of the mating plate 5511′, and a second end 5526′ of the pin body 5521′ is connected to the pin head 5524′. The pin head 5524′ is configured to be exposed outside the mating plate 5511′ for easy operation of the limiting pin 552′ by the user. In some examples, the diameter of the pin head 5524′ is larger than the insertion hole 5512′, and its inner end surface serves as an axial limiting surface, restricting the insertion depth of the pin body 5521′. The magnetic attraction portion 5523′ is disposed at an end of the pin head 5524′, and the magnetic attraction portion 5523′ magnetically attracts the mating plate 5511′ to prevent the limiting pin 552′ from falling out of the insertion hole 5512′. The limiting portion 5522′ is disposed on the pin body 5521′ and between the magnetic attraction portion 5523′ and the first end 5525′ of the pin body 5521′. The limiting portion 5522′ is retractably disposed on the pin body 5521′. When the pin body 5521′ extends into the insertion hole 5512′ of the mating plate 5511′, the limiting portion 5522′ extends out of the pin body 5521′ to restrict the limiting pin 552′ from falling out of the insertion hole 5512′. In this example, the limiting portion 5522′ includes a spring 5527′ and a steel ball 5528′. The pin body 5521′ is radially provided with a receiving cavity, in which a compression spring 5527′ and a steel ball 5528′ having a diameter larger than the cavity opening are disposed. The limiting portion 5522′ is positioned on the pin body 5521′ closer to the pin head 5524′. When the pin body 5521′ is inserted into the insertion hole 5512′, the steel ball 5528′ is compressed and retracts. After insertion is in place, the steel ball 5528′ pops out under the action of the spring 5527′ and engages into the mating plate 5511′, forming a mechanical lock. At the moment of insertion in place, the steel ball pops out to produce a single clear “click” sound, providing an audible feedback of successful assembly. In this example, the pin head 5524′ is connected to the frame via a rope 56′ to prevent loss of the pin head 5524′. In some examples, the pin head 5524′ is connected to the mating member 551′ via a steel wire rope.

In this example, the user operates the height adjustment handle 33′ to drive the linkage assembly 51′, causing the mowing mechanism 80′ to be raised or lowered to a target height. The user selects the insertion hole 5512′ corresponding to the target gear position and pushes the limiting pin 552′ vertically into the mating plate 5511′. During the process: the steel ball 5528′ briefly retracts when sliding over the edge of the hole and then pops out to lock after being in place (accompanied by a “click” sound); the magnetic attraction portion 5523′ on the end surface of the pin head 5524′ adsorbs to the surface of the mating plate 5511′. At this time, the pin body 5521′ of the limiting pin 552′ straddles the movement path of the height adjustment handle 33′, physically blocking its displacement, and the linkage assembly 51′ and the mowing mechanism 80′ are forcibly held at the set height. The limiting portion 5522′ provides a primary locking force to resist vibration and impact, and the magnetic attraction portion 5523′ provides a secondary anti-disengagement force to prevent accidental loosening. One-handed operation can complete insertion and removal, and the auditory feedback clearly indicates the operation state.

As shown in FIG. 53 and FIG. 68, in this example, an oil injection fitting 57′ is further included, through which lubricating oil is injected into the height adjustment mechanism 50′. In some examples, lubricating oil is injected into the linkage assembly 51′. In this example, the oil injection fitting 57′ is disposed above the foot pedal 61′. In this example, the oil injection fitting 57′ is disposed in the housing 71′ of the central control mechanism 70′ and adjacent to the installation position of the pad 91′, located in a rearward region of the entire machine. The oil injection fitting 57′ is an elbow grease fitting, wherein a directional bending angle between the axis of the oil injection fitting 57′ and the axis of the oil passage is 30° -45°, and the bending direction is toward the rear of the vehicle body 10′, so that the oil injection port faces the maintenance operation side. The oil injection fittings 57′ for injecting oil into the front and rear structures of the linkage assembly 51′ are located at a rearward position of the entire machine. This facilitates refilling of grease by a grease gun. Compared with the straight grease fitting in the related art, which requires removing components such as the circuit board assembly 73′ to insert the grease gun for refilling lubricating oil, in this example, using an elbow grease fitting, only the pad 91′ needs to be removed to expose an operation window of the oil injection fitting 57′, and the lubricating grease filling device (e.g., grease gun) can be linearly inserted from the rear of the vehicle body into the oil injection fitting 57′ to complete the oil injection operation without interference.

As shown in FIGS. 69 to 74, the standing platform 60′ is In some examples a foot pedal 61′. The foot pedal 61′ is disposed at a rear portion of the frame 11′, connected to the frame 11′, and located between the two rear wheels 411L′ and 411R′. The foot pedal 61′ is rotatably connected to the frame 11′ via a first rotation shaft 618′. The centerline of the first rotation shaft 618′ is a third axis 601′, wherein the third axis 601′ is parallel to the axes of the rear wheels.

A damper 62′ is disposed between the foot pedal 61′ and the frame 11′. The damping value of the damper 62′ is greater than or equal to 500 N·s/m. In some examples, the damping value of the damper 62′ is greater than or equal to 1000 N·s/m. In some examples, the damping value of the damper 62′ is greater than or equal to 1500 N·s/m. In some examples, the damping value of the damper 62′ is greater than or equal to 2000 N·s/m. In some examples, the damping value of the damper 62′ is greater than or equal to 2500 N·s/m. In some examples, the damping value of the damper 62′ is greater than or equal to 3000 N·s/m. In some examples, the damping value of the damper 62′ is greater than or equal to 3500 N·s/m. In some examples, the damping value of the damper 62′ is greater than or equal to 4000 N·s/m.

The damper 62′ connects the foot pedal 61′ and the frame 11′. Unlike an outdoor working machine with a seat, a user of the stand-on mower 100′ needs to stand on the foot pedal 61′ to operate the machine. During long-term standing, the comfort of the foot pedal 61′ supporting the user's feet is required. When the stand-on mower 100′ travels on a bumpy road, the vibration frequency and amplitude of the foot pedal 61′ following the entire machine will cause a great impact on the user, affecting the user's operation and observation on one hand, and causing safety hazards to the user on the other hand. In this example, the damper 62′ is used to connect the foot pedal 61′ and the frame 11′, utilizing the resistance provided by the damper 62′ to reduce vibration of the foot pedal 61′ together with the frame 11′. At the same time, the damper 62′ provides a damping value greater than or equal to 500 N·s/m to provide better vibration attenuation. If the damping value is too small, the vibration damping effect cannot be achieved; if the damping value is too large, the vibration damping of the foot pedal 61′ may become too stiff. At the same time, after the damping value of the damper 62′ reaches equilibrium with the overall force on the foot pedal 61′, the degree of vibration attenuation will gradually decrease, and even if the damping value continues to increase, the increase in the damping effect may instead decrease.

A support plate 615′ is disposed below the foot pedal 61′, and an elastic assembly 63′ is disposed between the foot pedal 61′ and the support plate 615′. In some examples, the standing platform 60′ includes at least one elastic assembly 63′, and the elastic assembly 63′ is symmetrically distributed about the axis of the damper 62′. In some examples, when the standing platform 60′ includes one elastic assembly 63′, the elastic assembly 63′ itself is symmetrical about the axis of the damper 62′, that is, the central axis of the elastic assembly 63′ coincides with the axis of the damper 62′. In some examples, when the standing platform 60′ includes two or more elastic assemblies 63′, the two or more elastic assemblies 63′ are symmetrically distributed about the axis of the damper 62′. In some examples, the standing platform 60′ includes an elastic assembly 63′, and the elastic assembly 63′ is disposed substantially centrally relative to the foot pedal 61′. In some examples, the standing platform 60′ includes one elastic assembly 63′, and the elastic assembly 63′ is disposed on the axis of the foot pedal 61′. In this example, in the front-rear direction, the damper 62′ and the elastic assembly 63′ are respectively connected to a front side and a rear side of the foot pedal 61′. In some examples, in the front-rear direction, the damper 62′ and the elastic assembly 63′ are offset in the front-rear direction. In this example, the damper 62′ is used to provide better vertical vibration attenuation, and the elastic assembly 63′ below the foot pedal 61′ balances the weight of the human body, achieving a better damping effect. In this example, the elastic assembly 63′ includes a first elastic assembly 63a′ disposed on the left side of the damper 62′ and a second elastic assembly 63b′ disposed on the right side of the damper 62′. The first elastic assembly 63a′ and the second elastic assembly 63b′ each use compression elastic members, such as compression springs.

When a user stands on the foot pedal 61′ of the stand-on mower 100′, the foot pedal 61′ assembly is in a static equilibrium state. In this state, selection and calculation are performed. The load is the user's weight G'. In this example, as uniformly defined above, the user's weight is 90 kg. Fc′ is the damping force provided by the damper 62′, and Fk′ is the elastic force provided by the elastic assembly 63′. The moment of the foot pedal 61′, the moment of gravity G', the elastic moment of the elastic force Fk′ of the elastic assembly 63′, and the damping moment of the damping force Fc′ of the damper 62′ constitute a static equilibrium.

Under the above static equilibrium, the elastic assembly 63′ mainly plays a supporting role, balancing the user's gravity, and secondly, the elastic assembly 63′ provides partial resistance to play a vibration isolation role. The damper 62′ plays a damping role, mainly used to absorb vibration energy of the foot pedal 61′.

The damping moment provided by the damper 62′ is adjusted by adjusting the moment arm of the damper 62′. In an unloaded state, i.e., when the user is not standing on the foot pedal 61′, the moment arm of the damper 62′ is a trigonometric function relationship with the vertical distance from the connection fulcrum of a first end 621′ of the damper 62′ to the frame 11′ to the third axis 601′ and the inclination angle of the damper.

In this example, the vertical distance from the connection fulcrum of the first end 621′ of the damper 62′ to the frame 11′ to the third axis 601′ is taken as a fixed value, i.e., without changing the vertical distance from the connection fulcrum of the first end 621′ of the damper 62′ to the frame 11′ to the third axis 601′, the moment arm of the damper 62′ is adjusted by adjusting the inclination angle of the damper 62′.

The frame 11′ includes a cross beam 113′. The foot pedal 61′ includes a connecting piece 611′. The first end 621′ of the damper 62′ is connected to the cross beam 113′, and the second end 622′ is connected to the connecting piece 611′. The connecting piece 611′ is detachably connected to the damper 62′. As shown in FIG. 72, the connecting piece 611′ includes a plurality of connection points 614′. When the second end 622′ of the damper 62′ is connected to any one of the connection points 614′, the damper 62′ has different inclination angles respectively. By changing the connection position of the damper 62′, the moment arm of the damper 62′ is adjusted. In some examples, the second end 622′ of the damper 62′ is connected to the connection point 614′ via a detachable fastener, such as a bolt and a nut. In some examples, the connecting piece 611′ includes two plate-like structures, including a first connecting plate 612′ and a second connecting plate 613′, which are respectively disposed on left and right sides of the damper 62′. Taking the first connecting plate 612′ as an example, a plurality of connection points 614′ are arranged on the first connecting plate 612′ in transverse and longitudinal directions. The opening direction of the connection points 614′ extends in the left-right direction.

As shown in FIG. 73, in this example, the connecting piece 611′ is disposed inside the foot pedal 61′. That is, in a projection in the up-down direction, the orthogonal projection of the connecting piece 611′ lies within the orthogonal projection of the foot pedal 61′. In some examples, as shown in FIG. 74, the connecting piece 611′ extends out of the foot pedal 61′, and the second end 622′ of the damper 62′ is connected to a front side of the foot pedal 61′. That is, in the projection in the up-down direction, the orthogonal projection of the connecting piece 611′ lies outside the orthogonal projection of the foot pedal 61′, for example, in the projection in the up-down direction, the orthogonal projection of the connecting piece 611′ lies in front of the orthogonal projection of the foot pedal 61′. Disposing the connecting piece 611′ outside the foot pedal 61′ and fixing the damper 62′ outside the frame 11′ and the foot pedal 61′ releases more standing space for the user, and the damper 62′ does not block the user's standing position.

In some examples, the moment arm of the damper 62′ is adjusted by adjusting the vertical distance from the connection fulcrum of the first end 621′ of the damper 62′ to the frame 11′ to the third axis 601′. In some examples, the damper 62′ is detachably connected to the cross beam 113′ of the frame 11′, and the cross beam 113′ is provided with a plurality of connection points (not shown) at different heights, so that the moment arm of the damper 62′ is adjusted by changing the connection position of the damper 62′.

As shown in FIG. 70. The angle between the foot pedal 61′ and the horizontal plane is defined as θ′. In an unloaded state, i.e., when the user is not standing on the foot pedal 61′, the angle between the foot pedal 61′ and the horizontal plane is defined as the initial position angle θ0′ of the foot pedal 61′. In this example, θ0′-10°≤θ′≤θ0′, to ensure that the foot pedal 61′ does not bottom out during traveling. In this example, θ0′ is greater than or equal to 10°. In some examples, θ0′ is defined as 15°.

In some examples, the movement angle of the foot pedal 61′ when carrying a person and during traveling is less than or equal to 10°. When the user's weight is 60 kg to 90 kg, when the foot pedal 61′ is in a manned state, θ′ is greater than or equal to 5° and less than or equal to 10°. The vertical height from the highest point of the foot pedal 61′ to the ground is defined as the ground clearance of the pedal. In the unloaded state, i.e., when the user is not standing on the foot pedal 61′, it is the initial ground clearance, wherein the initial ground clearance is greater than or equal to 200 mm. In some examples, the initial ground clearance is 250 mm.

As shown in FIGS. 71 to 74, taking the first elastic assembly 63a′ as an example, the first elastic assembly 63a′ includes a first elastic member 631′ and a second elastic member 632′, which are distributed in the front-rear direction of the stand-on mower 100′. In some examples, the first elastic member 631′ and the second elastic member 632′ are offset front and rear. In some examples, the first elastic member 631′ and the second elastic member 632′ include at least two specifications of compression springs. Two compression springs of different specifications are used. In some examples, the first elastic member 631′ and the second elastic member 632′ include two compression springs of the same specification. In the unloaded state, the first elastic member 631′ and the second elastic member 632′ are respectively connected to the foot pedal, and the first elastic member 631′ and the second elastic member 632′ have different heights. So that when the load is less than a preset value, any one of the first elastic member 631′ or the second elastic member 632′ provides a supporting force to support the user, to adapt to users of different weights. When the user's weight is low, only one compression spring is subjected to the load of the user's weight. When the user's weight is high, both compression springs are subjected to the load of the user's weight. The preset value of the load can be preset and cannot be adjusted or set by the user. In some examples, the preset value of the load can be adjusted by the user. According to changes in the user's weight and load, the user can adjust the preset value of the load. In some examples, the first elastic member 631′ and the second elastic member 632′ provide different stiffnesses. The first elastic member 631′ is disposed in front of the second elastic member 632′, and the stiffness of the first elastic member 631′ is greater than the stiffness of the second elastic member 632′. In some examples, the first elastic member 631′ and the second elastic member 632′ provide the same stiffness, but the unloaded heights of the first elastic member 631′ and the second elastic member 632′ are different.

Since the second elastic assembly 63b′ is symmetrically disposed with respect to the first elastic assembly 63a′, the structures are substantially the same, and the structure of the second elastic assembly will not be described one by one.

In this example, the standing platform 60′ uses a combination of a separately provided damper 62′ and an elastic assembly 63′ for vibration damping. The elastic assembly 63′ mainly plays a supporting role, balancing the user's gravity. The damper 62′ plays a damping role, configured to absorb vibration energy of the foot pedal 61′. The elastic assemblies 63′ are symmetrically disposed on two sides of the damper 62′, providing independent support for the user's feet, and can also provide independent adaptive support when the user applies different forces with the feet. The elastic assembly 63′ is configured as a multi-spring structure adapted to different body weights, and the damper 62′ is configured with an appropriate damping value. The supporting force provided by the elastic assembly 63′ and the resistance provided by the damper 62′ cooperate with each other to achieve a stand-on mower 100′ with all-round damping support suitable for various body weights.

As shown in FIG. 73, the standing platform 60′ further includes a first connecting member 616′ connecting the frame 11′ and the foot pedal 61′, and a second connecting member 617′ connecting the support plate 615′ and the frame 11′. One end of the first connecting member 616′ is connected to the cross beam 113′ of the frame 11′, and the other end is rotatably connected to the foot pedal 61′ via the first rotation shaft 618′. In some examples, the first connecting member 616′ is formed with the frame 11′, and the foot pedal 61′ is rotatably connected to the first connecting member 616′ via the first rotation shaft 618′. In this example, the first connecting member 616′ extends in a direction perpendicular to the third axis 601′. In some examples, the first connecting member 616′ extends in the up-down direction. The first connecting member 616′ is symmetrically disposed about the centerline of the damper 62′. The second connecting members 617′ are respectively disposed on left and right sides of the foot pedal 61′, and extend in a direction perpendicular to the third axis 601′. In some examples, the second connecting members 617′ extend in the up-down direction.

In some alternative examples, the damper is configured to provide resistance according to the movement or movement tendency of the foot pedal; the damper is configured with a preload, and the preload is configured as the resistance provided by the damper to the foot pedal when the foot pedal is not supporting an operator; the preload can be adjusted.

As shown in FIGS. 75 to 77, the stand-on mower 100′ includes a lighting assembly configured to improve the visibility brightness of the stand-on mower 100′. The lighting assembly includes a front lighting assembly 231′, the front lighting assembly 231′ extends in the left-right direction and is disposed on a front side of the stand-on mower 100′, and light emitted by the front lighting assembly 231′ can change the forward viewing environment of the stand-on mower 100′.

In this example, the front lighting assembly 231′ is disposed on the battery compartment 22′. In some examples, the front lighting assembly 231′ is at least partially disposed in a front side housing of the main compartment 221′. In this example, the front lighting assembly 231′ includes a lamp board assembly 24′. The lamp board assembly 24′ includes a circuit board 241′, a light emitter 242′, and a control element 243′. The light emitter 242′ is configured to emit light, and the control element 243′ at least controls turning on and off of the light emitter 242′. The light emitter 242′ and the control element 243′ are respectively mounted on the circuit board 241′ and are respectively mounted on two sides of the circuit board 241′. In some examples, the control element 243′ is soldered to a surface of the circuit board 241′.

The light emitter 242′ includes Light Emitting Diode (LED) lamp beads, and may also be COB (Chip On Board) lamp beads. The number of lamp beads and the distance between two adjacent lamp beads can be adjusted according to requirements. The circuit board 241′ includes a Printed Circuit Board (PCB) and a Flexible Printed Circuit board (FPC). The control element 243′ includes a dedicated control chip, such as a single-chip microcomputer or a microcontroller unit (MCU). The control element 243′ includes a processor and a memory. The processor is configured to programmably control the corresponding functions, and the memory can store programs to be executed and related data. It should be noted that the control chip may be integrated into the control element 243′, or may be provided independently of the control element 243′. The structural relationship between the driver chip and the controller is not limited in this example.

In some examples, a surrounding member 245′ is provided on a periphery of the lamp board assembly 24′. The surrounding member 245′ extends in a direction perpendicular to a board surface of the circuit board 241′. One end of the surrounding member 245′ extends out of the board surface of the circuit board 241′ by a preset height, thereby forming a closed fence structure circumferentially on the surface of the circuit board 241′. A gluing process is performed on an inner side region of the fence structure, and a poured sealant 244′ covers at least the body and pin roots of the control element 243′, and a glue level height is lower than an upper edge height of the surrounding member, so as to form a cofferdam anti-overflow structure. After curing, the sealant 244′ forms an elastic protective layer, which can significantly improve the waterproof, moisture-proof, and vibration-resistant performance of the control element 243′, so as to adapt to the outdoor working environment of the stand-on mower 100′ in rainy, high-humidity, and bumpy lawn conditions.

In some examples, a foam material is provided on the control element 243′. The foam material is made of closed-cell foamed polyurethane or silicone foam material, prefabricated into a box-shaped covering structure having an internal cavity, and a bottom opening edge of the foam material has a self-adhesive layer. The foam covering is directly bonded and fixed to the surface of the circuit board 241′, surrounding and covering the body of the control element 243′. An inner wall of the foam material maintains zero clearance or a slight interference fit with a side surface of the control element 243′. A top surface of the foam material is a completely closed surface, enclosing a space above the control element 243′ to prevent water droplets and grass clippings from directly impacting the element. The top surface of the foam material forms an elastic restraint layer on the element, with a compression rate controlled between 10% and 15%, so as to eliminate micro-motion wear and pin fatigue risks under high-frequency vibration. Microporous ventilation structures may be provided on side walls of the foam material to balance internal and external air pressure, preventing condensation accumulation in the sealed cavity. Through the closed-cell sealing property and elasticity of the foam material itself, waterproof, dustproof, and vibration protection are achieved, suitable for protection scenarios of low-power control elements 243′.

In this example, the front lighting assembly 231′ includes a headlight 232′ disposed at a front center, and a left side light 233′ and a right side light 234′ disposed on two sides of the headlight 232′. In some examples, the lamp board assembly 24′ correspondingly includes a headlight lamp board 24F', a left side light lamp board 24L′, and a right side light lamp board 24R′, each lamp board including at least one circuit board 241′. In some examples, the lamp board assembly 24′ includes a single integral circuit board 241′, and the light emitters 242′ are respectively disposed at positions corresponding to the headlight 232′, the left side light 233′, and the right side light 234′, thereby forming the effect of three sets of lights with one circuit board 241′ and unevenly arranged light emitters 242′. In some examples, a first preset angle is formed between a plane of a light exit surface of the left side light 233′ and a plane of a light exit surface of the headlight 232′, and a second preset angle is formed between a plane of a light exit surface of the right side light 234′ and the plane of the light exit surface of the headlight 232′. The first preset angle and the second preset angle are equal in magnitude and opposite in direction. By inclining the light exit surfaces of the left side light 233′ and the right side light 234′ outwardly relative to the light exit surface of the headlight 232′, the light beam of the left side light 233′ is deflected toward a left-front area of the vehicle, the light beam of the right side light 234′ is deflected toward a right-front area of the vehicle, and the light beam of the headlight 232′ continues to project straight forward, together forming a continuous and wide-angle lateral illumination range, reducing blind spots on both sides.

The front lighting assembly 231′ includes a mounting base 235′, a first lamp cover 236′, and a second lamp cover 237′. The mounting base 235′ is formed on or connected to the main compartment 221′, and the mounting base 235′ and the main compartment 221′ form a forward-facing accommodating space, in which the lamp board assembly 24′ is disposed. The first lamp cover 236′ and the second lamp cover 237′ are disposed in front of the light emitter 242′ of the lamp board assembly 24′, and at least one of the first lamp cover 236′ and the second lamp cover 237′ forms a sealed connection with the main compartment 221′, thereby preventing external dirt, muddy water, and moisture from intruding into the accommodating space.

In this example, the first lamp cover 236′ is a transparent lamp cover made of polycarbonate or acrylic material with high light transmittance. The second lamp cover 237′ is a light-guiding lamp cover, and the material contains light diffusing particles to uniformly scatter incident light. The first lamp cover 236′ is at least configured as the light exit surfaces of the left side light 233′ and the right side light 234′, i.e., light emitted by the left side light 233′ and the right side light 234′ exits to the external environment through the first lamp cover 236′. The second lamp cover 237′ is at least configured as the light exit surface of the headlight 232′, i.e., light emitted by the headlight 232′ exits through the second lamp cover 237′ to present a desired lighting effect. In some examples, the first lamp cover 236′ includes a left light exit portion 2361′, a right light exit portion 2362′. The left light exit portion 2361′ and the right light exit portion 2362′ are respectively embedded or snap-fitted into corresponding window openings provided on the front side housing of the main compartment 221′. The left light exit portion 2361′ forms the light exit surface of the left side light 233′, and the right light exit portion 2362′ forms the light exit surface of the right side light 234′. The normal directions of the two light exit surfaces are respectively deflected outwardly to expand the lateral illumination range. In some examples, the first lamp cover 236′ includes a left light exit portion 2361′, a right light exit portion 2362′, and a front light exit portion 2363′ connected therebetween. In this case, the first lamp cover 236′ is formed as an integral transparent cover structure, respectively covering the light emitters 242′ of the headlight 232′, the left side light 233′, and the right side light 234′, i.e., the first lamp cover 236′ is integrally disposed in front of the lamp board assembly 24′. In this example, the first lamp cover 236′ and the mounting base 235′ are sealedly connected using a labyrinth structure 2351′. The first lamp cover 236′ and the mounting base 235′ form a substantially sealed accommodating space in which the lamp board assembly 24′ is disposed. The labyrinth seal structure forms a tortuous gap path by mutually engaging ribs and grooves, thereby forming a substantially sealed protective interface without using additional sealant. In this example, the second lamp cover 237′ is further disposed in front of the front light exit portion 2363′. The second lamp cover 237′ is used to convert light emitted by the headlight 232′ into a milky white uniform light effect, so as to reduce glare and improve visual effect. The second lamp cover 237′ is sealedly connected to the front side housing of the main compartment 221′ via a labyrinth structure 2352′, so as to effectively block the path of moisture penetration along the gap. In this example, a micro-prism optical structure array is provided on inner surfaces of the left light exit portion 2361′ and the right light exit portion 2362′. The micro-prism structure is used to change a light exit angle and control beam distribution, thereby preventing glare that may interfere with the operator or the surrounding environment on two sides of the mower traveling direction.

In this example, the window openings correspondingly provided on the front side housing cooperate with the mounting base 235′ to form a cross rib structure, preventing light from adjacent light emitters 242′ from interfering with each other, thereby preventing mutual light interference between the left side light 233′ and the right side light 234′ and with the headlight 232′.

In some examples, a mowing motor start switch is further included for mowing motor start control and safety protection. In some examples, the mowing motor start switch includes a non-contact switch. In some examples, the mowing motor start switch includes a Hall effect sensor. In some examples, the mowing motor start switch includes an inductive proximity switch, a capacitive proximity switch. In some examples, the Hall effect sensor is fixedly mounted on the mowing deck. In some examples, a plurality of strong permanent magnets (such as neodymium iron boron) are uniformly embedded in the mowing deck. The number of magnets is determined according to the required resolution (pulses/revolution) and sensor performance (e.g., 4-8). In this example, the mowing motor start switch is connected to the second circuit board assembly 732′, and performs rotation state detection and safety start control of the mowing motor or the mowing blade based on the Hall effect. In some examples, the Hall effect sensor is used to detect a condition for allowing the mowing motor to start. When the sensor detects that the mowing motor or the mowing blade is stationary, it sends an allow-start signal to the second circuit board assembly. In some examples, the Hall effect sensor is used for monitoring and protection during operation of the mowing motor, such as stall, overspeed, or signal loss, sending a stop or brake signal to the second circuit board assembly. In this example, non-contact detection is adopted, avoiding mechanical wear and spark risk; fail-safe design.

In some examples, a foot pedal switch is further included, configured to detect the state (depressed/not depressed) of the standing pedal of the stand-on mower and output an electrical signal for judgment. In some examples, the foot pedal switch includes a non-contact switch, such as a Hall effect switch. In some examples, the Hall effect switch is mounted on a pedal support structure/fixed frame to avoid cable fatigue caused by movement with the pedal, facing a preset magnet position below or on the side of the pedal. In some examples, a plurality of Hall effect switches are provided, so that the depressed state, the not depressed state, and the one-foot standing/two-foot standing state can be judged. In this example, the foot pedal switch is connected to the second circuit board assembly 732′. In this example, non-contact detection is adopted, achieving reliable and safe detection of the standing pedal state of the stand-on mower, meeting the core safety requirement of “stop when unattended”.

In this example, the number of battery compartments 22′ is one, and the plurality of battery packs 21′ are disposed in one battery compartment 22′. In some examples, the number of coupling portions is the same as the number of battery packs 21′, and each battery pack 21′ is disposed in a corresponding coupling portion. In some examples, the number of coupling portions and the number of battery packs 21′ are both multiple, and the number of battery packs 21′ disposed in at least one of the multiple coupling portions is greater than or equal to 2. In some examples, an input terminal for transmitting electrical signals or communication signals is provided in the battery compartment 22′. The battery pack 21′ is detachably mounted via slide rails and a locking mechanism. Since the working principle of detachably mounting the battery pack 21′ via slide rails and a locking mechanism has been fully disclosed to those skilled in the art, detailed description is omitted here for the purpose of brevity.

In this example, the stand-on mower 100′ has a minimum start-up state. In the minimum start-up state, the weight of the stand-on mower 100′ is less than or equal to 320 kg, to improve portability and transportation convenience of the device. The minimum start-up state of the stand-on mower 100′ is configured such that at least one battery pack 21′ is mounted to a coupling portion and capable of providing current to the stand-on mower 100′. This allows the device to achieve basic functions with only a single battery pack 21′ installed, without relying on all battery packs 21′, thereby lowering the usage threshold and improving flexibility. In some examples, the minimum start-up state of the stand-on mower 100′ is configured such that at least one battery pack 21′ is installed and capable of supplying power to the traveling mechanism 40′ to implement the traveling function of the stand-on mower 100′. This enables the stand-on mower 100′ to move autonomously, facilitating short-distance transportation or position adjustment by the user. In some examples, the minimum start-up state of the stand-on mower 100′ is configured such that at least one battery pack 21′ is installed and capable of performing a work function other than starting the mowing motor 82′. For example, a single battery pack 21′ can supply power to one or several auxiliary functions among the circuit board assembly 73′, a lighting module, the communication device 733′, the temperature reduction device 13′, or some sensors, so that the device can perform tasks other than mowing (such as path planning, obstacle detection, etc.). In the minimum startup state, the number of battery packs installed in the battery compartment just meets the minimum requirement for the stand-on mower 100′ to start, such that if any one more battery pack is removed, the stand-on mower 100′ cannot start.

By optimizing the configuration of the battery packs 21′, the overall weight in the minimum start-up state is controlled within 300 kg, reducing the requirements of the device on transportation tools and working sites, and being particularly suitable for use in courtyards or narrow spaces. The user can select the number of battery packs 21′ to be installed according to actual needs, for example, using only a single battery pack 21′ in light-load tasks to save energy, and installing multiple battery packs 21′ in high-intensity work to extend endurance. The setting of the minimum start-up state allows the device to operate in a low-power mode, reducing energy waste, and is particularly suitable for standby or short-distance movement scenarios.

In some examples, the frame 11′ or the housing 71′ of the stand-on mower 100′ is made of a weight-reducing material. For example, the frame 11′ is made of a metal material such as high-strength steel, aluminum alloy, magnesium alloy, or titanium alloy. For example, the frame 11′ is made of a carbon fiber reinforced composite material, or a glass fiber reinforced polymer.

In this example, the stand-on mower 100′ has a bare machine state. In the bare machine state, the weight of the stand-on mower is less than or equal to 300 kg. The bare machine state is a machine state after removing components defined as user-detachable from the stand-on mower 100′, for example, all detachable battery packs 21′ are removed, or a storage rack 200′ fixed by quick-release pins is removed, and modular accessories (such as a grass catcher 201′, a lamp bracket 202′) are removed. However, it should be noted that core components such as the wheel set 41′, the pad 91′ or the seat, and hydraulic lines that require special tools for detachment are not within the detachable range and are retained in the bare machine state.

In this example, the stand-on mower 100′ has a fully loaded state. In the fully loaded state, the weight of the stand-on mower 100′ is greater than 320 kg and less than or equal to 380 kg. In some examples, in the fully loaded state, the weight of the stand-on mower 100′ is less than or equal to 350 kg. The fully loaded state is a state after all standard interfaces 211′ in the battery compartment 22′ of the stand-on mower 100′ are respectively equipped with adapted battery packs 21′.

In this example, the weight of the battery pack 21′ is greater than or equal to 9 kg and less than or equal to 25 kg. In one example, the weight of the battery pack 21′ is greater than or equal to 10 kg and less than or equal to 25 kg, or the weight of the battery pack 21′ is greater than or equal to 11 kg and less than or equal to 25 kg, the weight of the battery pack 21′ is greater than or equal to 12 kg and less than or equal to 25 kg. The weight of the battery pack 21′ is greater than or equal to 13 kg and less than or equal to 25 kg. The weight of the battery pack 21′ is greater than or equal to 14 kg and less than or equal to 25 kg. The weight of the battery pack 21′ is greater than or equal to 15 kg and less than or equal to 25 kg. The weight of the battery pack 21′ is greater than or equal to 16 kg and less than or equal to 25 kg. The weight of the battery pack 21′ is greater than or equal to 17 kg and less than or equal to 25 kg.

In this example, the capacity of the battery pack 21′ is greater than or equal to 20 Ah. In one example, the capacity of the battery pack 21′ is greater than or equal to 30 Ah, or the capacity of the battery pack 21′ is greater than or equal to 40 Ah, or the capacity of the battery pack 21′ is greater than or equal to 50 Ah. For example, it can be 20 Ah, 30 Ah, 40 Ah, 50 Ah, etc. In some examples, the total capacity of the power supply 20′ is greater than or equal to 120 Ah. In some examples, the total capacity of the power supply 20′ is greater than or equal to 160 Ah. In some examples, the total capacity of the power supply 20′ is greater than or equal to 200 Ah.

In some examples, the battery pack 21′ includes a plurality of battery cells, and the battery cells include lithium iron phosphate battery cells. In some examples, the battery pack 21′ may also be a supercapacitor, also known as an electrochemical capacitor. In some examples, the battery pack 21′ may also be a lithium battery pack. In some examples, the nominal voltage of the battery pack 21′ is greater than or equal to 20 V and less than or equal to 800 V. In one example, or the nominal voltage of the battery pack 21′ is greater than or equal to 24 V. Or the nominal voltage of the battery pack 21′ is greater than or equal to 36 V. Or the nominal voltage of the battery pack 21′ is greater than or equal to 40 V. Or the nominal voltage of the battery pack 21′ is greater than or equal to 48 V. Or the nominal voltage of the battery pack 21′ is greater than or equal to 50 V. In some examples, the nominal voltage of the battery pack 21′ is greater than or equal to 56 V.

In this example, the plurality of battery packs 21′ may be the same or different. For example, the plurality of battery packs 21′ may have differential configurations in physical structure and electrical characteristics. In some examples, the plurality of battery packs 21′ include a first battery pack 21a′ and a second battery pack 21b′. The first battery pack 21a′ and the second battery pack 21b′ may adopt exactly the same technical specifications (e.g., the same nominal voltage) or different technical routes (e.g., the first battery pack 21a′ is a lithium iron phosphate battery cell, and the second battery pack 21b′ is a supercapacitor cell), or have different voltage/capacity parameters even if using the same technical route (e.g., both are lithium iron phosphate systems but configured as 24 V and 56 V respectively). In this example, the plurality of battery packs 21′ are connected in parallel with each other. The positive output terminals of each battery pack 21′ are commonly connected to a system positive bus, and the negative output terminals are commonly connected to a system negative bus, thereby achieving autonomous distribution and cooperative operation of current among the multiple battery packs 21′. This parallel architecture allows the system to dynamically expand the total energy storage capacity while maintaining the total output voltage.

In some examples, the nominal voltage of the first battery pack 21a′ is greater than or equal to 40 V. The nominal voltage of the first battery pack 21a′ may be greater than or equal to 40 V and less than or equal to 800 V. In some examples, the nominal voltage of the first battery pack 21a′ is 40 V, 48 V, 56 V, 60 V, 80 V, 100 V, 400 V, 800 V. In some examples, the first battery pack 21a′ is configured to be detachable from the stand-on mower 100′ to supply power to an utility vehicle 200a′, a walk-behind power tool, an electric garden tool, etc. The nominal voltage of the second battery pack 21b′ is greater than or equal to 20 V. The nominal voltage of the second battery pack 21b′ is greater than or equal to 20 V and less than or equal to 40 V. In some examples, the nominal voltage of the second battery pack 21b′ is 20 V, 24 V, 36 V, 40 V. In some examples, the second battery pack 21b′ is configured to be detachable from the stand-on mower 100′ to supply power to a hand-held power tool such as a drilling tool, a light, a grinding tool. In some examples, the first battery pack 21a′ is capable of charging the second battery pack 21b′. In some alternative examples, the second battery pack 21b′ is capable of charging the first battery pack 21a′. In some examples, when the total capacity of the first battery pack 21a′ is greater than the total capacity of the second battery pack 21b′, when the remaining power of the second battery pack 21b′ is insufficient, the first battery pack 21a′ can supplementarily charge the second battery pack 21b′.

In some examples, at least one of the first battery pack 21a′ and the second battery pack 21b′ is configured to be built into the battery compartment. The design of a built-in fixed pack significantly enhances the overall structural rigidity of the battery compartment, helping to resist impact and vibration, and reducing the risk of poor contact or internal damage due to loosening. At the same time, the built-in pack can generally achieve better thermal management design integration (e.g., close contact with a heat dissipation structure), which is beneficial for temperature control. The presence of the built-in battery pack ensures that the device always has a minimum basic power supply. Even if the detachable battery pack is removed for charging, replacement, or as a backup power source, the core functions or minimum operation of the device can usually be maintained, improving system reliability and availability. It can be understood that at least one of the first battery pack 21a′ and the second battery pack 21b′ is configured as a built-in fixed pack, and at least one of the first battery pack 21a′ and the second battery pack 21b′ is configured to be detachably connected. Under the premise of ensuring the safety and reliability of using the built-in battery pack, the provision of the detachable battery pack greatly facilitates the user to replace, charge, or carry a backup power source. The user can “hot-swap” a depleted battery pack without shutting down or interrupting use, or quickly install a fully charged backup pack, effectively extending the continuous operation time of the device, which is particularly suitable for mobile or outdoor working scenarios. This design also simplifies the process of battery maintenance, upgrade, or recycling. In some alternative examples, the power supply 20′ includes a plurality of battery packs 21′, each of which is configured as a built-in battery pack and is non-detachably connected in the battery compartment. This simplifies user operation and maintenance, as the user does not need to worry about battery insertion, removal, matching, or storage, reducing usage complexity. The entire power supply system is managed as an integrated unit (e.g., charged through a unified charging port), simplifying the user experience and maintenance process. The built-in non-detachable design effectively prevents the user from using non-original, incompatible, or inferior third-party battery packs, avoiding potential performance degradation, safety risks (overcharge, overdischarge, short circuit), and possible warranty disputes, ensuring that the device operates strictly according to the design specifications and guarantees user safety.

In this example, at least one first interface is further included. The first interface is electrically connected to an electrical device for transmitting electric energy provided by the power supply 20′ to the electrical device. In some examples, one or more first interfaces are provided. The electrical device is electrically connected to the first interface, and obtains electric energy provided by the power supply through the first interface to achieve charging. The output power of the first interface is adjustable between W1 and W2, capable of meeting the power demands of various electrical devices. In some examples, the minimum output power of the first interface is greater than or equal to 10 W. In some examples, the minimum output power of the first interface is greater than or equal to 15 W. In some examples, the output power of the first interface is greater than or equal to 10 W and less than or equal to 250 W. In some examples, the output power of the first interface is greater than or equal to 20 W and less than or equal to 200 W. In some examples, the output power of the first interface is greater than or equal to 30 W and less than or equal to 150 W. In some examples, the output power of the first interface can be 10 W, 30 W, 50 W, 70 W, 90 W, 110 W, 130 W, 150 W, 170 W, 190 W, 210 W, 230 W. In some examples, the output power of the first interface is adjustable between 10 W and 250 W, capable of achieving wide-range voltage output and high-power transmission, meeting the user's fast charging needs.

The first interface is disposed on at least one of the vehicle body 10′, the frame 11′, or the housing 71′. In some examples, an opening adapted to the first interface may be provided on the housing, so that the first interface can be correspondingly embedded into the opening, enabling the installation of the first interface on the housing and fixing the position of the first interface. The side of the first interface connected to the electrical device is exposed outside the housing assembly for user convenience.

The electrical device may include: a fan, a mobile phone, a lighting device. It may also include a battery pack or a charger, where the charger may refer to a small-capacity energy storage device. In some feasible examples, the electrical device includes: a hand-held tool with a battery pack, such as a hand-held electric drill, a hand-held electric wrench, etc.

In some examples, the first interface is a Type-C interface. The Type-C interface can achieve high data transmission and high power transmission, meeting the charging needs of various electrical devices.

As shown in FIG. 78, in another example of the present application, the outdoor mowing device 100′ includes a vehicle control unit (VCU) 78′. The VCU 78′ serves as a central control unit of the entire vehicle. In this example, an operating system module 791′ is provided, including a display screen 751′, a switch element 752′, an operating member 77′, and associated electronic or control elements. A traveling control module 792′ includes a traveling motor controller 7921′ on the second circuit board assembly 732′, and the first motor 421′ and/or the second motor 422′. A mowing control module 793′ includes the mowing motor 82′, a mowing motor controller 7931′, and associated electronic components. A power-on/off control module 794′ is configured to control the power-on and power-off procedures of the entire machine.

The VCU 78′ collects input signals from the operating mechanism 30′, the standing platform 60′, various sensors, and the human-machine interaction interface to interpret the operator's control intention, and performs comprehensive analysis through internally preset control strategies and algorithms to make response judgments. In this example, the VCU 78′ monitors the traveling state and working state of the vehicle in real time, and coordinates and manages the work of various subsystem controllers including the operating system module 791′, the traveling control module 792′, the mowing control module 793′, and the power-on/off control module 794′, thereby ensuring that the vehicle operates stably with good working performance, high energy economy, and reliability.

The VCU 78′ obtains status information of each subsystem via a controller area network bus, and sends information to be displayed to the operating system module 791′. At the same time, the VCU 78′ receives operation commands from the operating system module 791′ and forwards them to corresponding actuators. When detecting that safety conditions are met, the VCU 78′ sends enable commands and speed commands to the traveling motor controller 7921′ and the mowing motor controller 7931′, driving the respective motors to work. The power-on/off control module 794′ manages the power state of the entire machine, and controls the system to enter a wake-up, working, or sleep state according to user operations and preset conditions. The beneficial effect of this centralized control architecture is that it achieves coordinated management and information exchange of each functional module, improving the operational safety, working efficiency, and energy utilization of the entire machine.

In some examples, the VCU 78′ is configured to communicate with each sub-module of the outdoor mowing device via a controller area network bus and obtain operating status information of the outdoor mowing device. The VCU 78′ is configured to forward the operating status information to the display screen 751′ of the operating system module 791′ via a 485 bus. Information input by the user through operations of the switch element 752′, the operating member 77′, or the display screen 751′ is sent to the VCU 78′ via the 485 bus. After receiving the information, the VCU 78′ converts it into a message conforming to the controller area network bus protocol and forwards it to the corresponding controller for execution. In some examples, the information input by the user through operations of the switch element 752′, the operating member 77′, or the display screen 751′ includes: lighting control information, mode information, gear position information, and setting information.

The VCU 78′ is configured to receive a wake-up or shutdown signal from a start switch 772′ button. When the user activates the start switch 772′, the VCU 78′ executes a corresponding power-on or power-off sequence according to the remaining power of the power supply and the current state of the entire machine, controlling the entire machine and each sub-module to enter a working or sleep state. This provides a unified and reliable power-on and power-off process, ensuring stable initialization and safe power-off of the system.

In some examples, the VCU 78′ is configured with a sleep timer function; in the power-on interface, when it is monitored that there is no operation on the entire machine and the operating system module 791′ for a preset period, the VCU 78′ instructs the operating system module 791′ to turn off the display screen 751′, reducing energy consumption of the system in standby mode and extending the usage time of the device.

In some examples, when the entire machine is in a password input interface, the VCU 78′ determines that the machine is in a power-on state; in this state, the user needs to long-press the start switch 772′, and the VCU 78′ will instruct the display screen 751′ to turn off only after receiving the long-press signal, ensuring safe interaction and preventing accidental shutdown in a critical operation interface. The VCU 78′ is configured to continuously monitor the occupancy state of the seat or the foot pedal 61′ and the user's operation activities. After the machine is powered on, if it is detected that the operator has left the foot pedal 61′ and there is no operation on the entire machine and the operating system module 791′ for a subsequent preset period, the VCU 78′ will control the entire machine to power off and simultaneously instruct the display screen 751′ to turn off. This avoids ineffective energy waste and improves device safety.

In this example, the VCU 78′ is configured to, after the entire machine is powered on, continuously monitor multiple conditions including the state of the traveling motor controller 7921′, the position of the operating mechanism 30′, the current interface state fed back by the operating system module 791′, the occupancy state of the operator's foot pedal 61′, and the state of a charging system. When the VCU 78′ confirms that all the above states are normal, the operating system module 791′ is in a power-on interface, and no charging event is occurring, the VCU 78′ sends a motor enable command to the traveling motor controller 7921′ via the controller area network bus. This ensures that the device is only allowed to travel under absolutely safe conditions, fundamentally preventing the risk of accidental startup.

In some examples, the VCU 78′ is configured to receive and process a position signal of the operating mechanism 30′; when the operating mechanism 30′ is operated or unlocked for operation and an operation amount applied by the operator is detected, the VCU 78′ unlocks a parking brake mechanism 44′ of the traveling system via the traveling motor controller 7921′; when the operating mechanism 30′ is disconnected or operation is locked and continues for a preset period, the VCU 78′ instructs the traveling motor controller 7921′ to lock the parking brake mechanism 44′. This safety interlock method combining mechanical and electrical control provides dual protection for vehicle parking, enhancing system reliability.

The VCU 78′ is configured to, after receiving an unlocked state signal of the parking brake mechanism 44′ and an activated state signal of the drive mechanism fed back by the traveling motor controller 7921′, send a corresponding motor speed command to the traveling motor controller 7921′ via the controller area network bus according to an input signal of an accelerator pedal, to control the traveling motor to accelerate or decelerate smoothly; the sequential execution of the control logic ensures that power output is strictly synchronized with hydraulic (or mechanical) release, avoiding impact or unexpected movement of the traveling system.

In some examples, the VCU 78′ is configured to monitor the state of the entire machine in real time; when it is detected that any fault occurs (such as motor overheating, communication interruption) or that the operator has left the operator's foot pedal 61′, the VCU 78′ immediately sends a zero speed command, a motor enable off command, and a parking brake mechanism locking command to the traveling motor controller 7921′ via the controller area network bus; this instantly cuts off power and locks the vehicle, effectively limiting the expansion of the fault and protecting the safety of personnel and equipment.

In some examples, the VCU 78′ is configured to, after the entire machine is powered on, continuously monitor multiple parameters including the state of the mowing motor controller 7931′, the position of a PTO switch, the state of the parking brake mechanism, the occupancy state of the operator's foot pedal 61′, and the state of the operating mechanism 30′. When the VCU 78′ confirms that all the above states meet preset safety conditions, the VCU 78′ sends a motor enable command to the mowing motor controller 7931′ via the controller area network bus; this ensures that the mowing motor 82′ is only allowed to start under absolutely safe conditions, effectively preventing mechanical injury caused by misoperation.

In some examples, the VCU 78′ is configured to, after sending the enable command to the mowing motor controller 7931′, send a specific motor speed command to the mowing motor controller 7931′ via the controller area network bus according to an operation command or a preset cutting strategy. This adapts to the cutting needs of different grass conditions, optimizing energy efficiency while ensuring cutting quality.

In some examples, the VCU 78′ is configured to receive the motor enable state and actual speed signal fed back by the mowing motor controller 7931′ in real time, and compare the actual speed with the commanded speed. When it is found that the speed deviation continuously exceeds an allowable range, the VCU 78′ can determine that there is an abnormal load or a mechanical fault, and trigger a corresponding fault handling procedure. This timely identifies work abnormalities, protecting the mowing motor 82′ and its transmission system from damage.

In some examples, the VCU 78′ is programmed to perform coordinated control of the start and stop of the mowing motor 82′ with the traveling state and parking state of the device; for example, the VCU 78′ may be configured to allow the mowing motor 82′ to start only when the device is in a parking state, or to automatically adjust the speed of the mowing motor 82′ to an optimal value matching the vehicle speed when it is detected that the device starts traveling. This achieves coordinated operation of the traveling system and the working system, improving overall working efficiency and safety.

As shown in FIG. 79, a control method for a mowing mechanism includes:
S101: A start switch is triggered.
S102: A vehicle control unit continuously monitors: a mowing motor controller state, a PTO switch position, a parking brake mechanism state, and an operating mechanism state are normal.
S103: The vehicle control unit continuously monitors: communication of the entire machine is normal.
S104: A display screen of an operating system module displays a power-on interface.
S105: Power-on of the entire machine is completed, the power supply state is normal, and a power-on time exceeds a first preset time. In some examples, the first preset time includes 3 seconds, 3.5 seconds, 4 seconds or more.
S106: An operator's foot pedal is in the occupancy state.
S107: A PTO switch is activated.
S108: The PTO switch activation is timed.
S109: The timing is greater than a first count time; if yes, execute S110; if not, return to S108. In some examples, the first count time is greater than 0 seconds, for example, 0.01 seconds, 0.02 seconds. In some examples, the first count time is greater than 0 seconds and less than or equal to 0.1 seconds.
S110: A first mowing motor starts.
S111: The timing is greater than a second count time, the second count time is greater than the first count time; if yes, execute S112; if not, return to S108. In some examples, the second count time is greater than 0.1 seconds, for example, 0.2 seconds, 0.3 seconds . . . 1 second, 1.01 seconds.
S112: A second mowing motor starts. In some examples, the mowing motors are started sequentially using different count times.

In some examples, when the number of mowing motors is greater than 2, the PTO switch timing continues. For example, if there is also a third mowing motor, then execute S113:
S113: The timing is greater than a third count time, the third count time is greater than the second count time; if yes, execute S114; if not, return to S108.

In some examples, the third count time is greater than the second count time, for example, 2.01 seconds, and the difference between the third count time and the second count time, and the difference between the second count time and the first count time are the same.
S114: The third mowing motor starts. For a larger number of mowing motors, the starting method is analogous, performing sequential starting.

As shown in FIGS. 45 to 47, 50, and 53, the first drive wheel 411L′ and the second drive wheel 411R′ are respectively disposed on two sides of the frame 11′. The first drive wheel 411L′ and the second drive wheel 411R′ are substantially mirror-symmetrically designed, and the dimensions and structures of the first drive wheel 411L′ and the second drive wheel are substantially the same. For convenience of description, the first drive wheel 411L′ is taken as an example. In some examples, the first drive wheel 411L′ is a pneumatic wheel composed of a tire 413′ and a rim 414′. In some examples, the first drive wheel 411L′ is an integral wheel made of a high polymer. The structure of the wheel is not limited to a particular form.

In some examples, in the left-right direction, a distance L1′ between an inner side of the first drive wheel 411L′ and an inner side of the second drive wheel 411R′ is less than or equal to 520 mm. A distance L2′ between an outer side of the first drive wheel 411L′ and an outer side of the second drive wheel 411R′ is less than or equal to 860 mm.

In this example, the mowing mechanism 80′ includes a plurality of mowing blades 81′ and mowing motors 82′ respectively driving the mowing blades 81′. That is, the number of mowing motors 82′ provided corresponds to the number of mowing blades 81′. In some examples, the mowing mechanism 80′ includes a plurality of mowing blades 81′ and a mowing motor 82′ driving the mowing blades 81′, wherein one mowing motor 82′ is provided or the number of mowing motors 82′ is smaller than the number of mowing blades 81′. That is, one mowing motor 82′ can drive a plurality of mowing blades 81′. In some examples, the mowing mechanism 80′ includes a first blade 811′ and a second blade 812′ disposed adjacently, a first mowing motor 821′ driving the first blade 811′, and a second mowing motor 822′ driving the second blade 812′. In this example, a maximum cutting width W′ of the mowing mechanism 80′ is less than or equal to 40 inches. In some examples, the maximum cutting width W′ of the mowing mechanism 80′ is less than or equal to 36 inches. It should be explained that the maximum cutting width W′ of the mowing mechanism 80′ is not determined by the width of the mowing deck 83′. The maximum cutting width W′ of the mowing mechanism 80′ is the maximum lateral width of the lawn that can be covered by the rotational motion of the first blade 811′ and the second blade 812′. As shown in FIG. 62, in this example, in the left-right direction, the mowing deck 83′ at least partially extends out of the frame 11′. For example, the mowing deck 83′ extends out of the first longitudinal beam 111′ and/or the second longitudinal beam 112′, wherein a length L6′ by which the mowing deck 83′ extends out of the frame 11′ is greater than or equal to 100 mm and less than or equal to 200 mm. The length L6′ by which the mowing deck 83′ extends out of the frame 11′ is greater than or equal to 110 mm and less than or equal to 200 mm. The length L6′ by which the mowing deck 83′ extends out of the frame 11′ is greater than or equal to 120 mm and less than or equal to 200 mm. The length L6′ by which the mowing deck 83′ extends out of the frame 11′ is greater than or equal to 150 mm and less than or equal to 200 mm. The length L6′ by which the mowing deck 83′ extends out of the frame 11′ is greater than or equal to 100 mm and less than or equal to 180 mm. In the width direction, a maximum distance L′ from the mowing deck 83′ to the drive wheel is less than or equal to 880 mm. In this example, an overall width L′ formed by the mowing deck 83′ and the drive wheels is less than or equal to 880 mm, so that the stand-on mower can easily pass through narrow doors.

As shown in FIGS. 46, 47, and 62, the mowing deck 83′ further has a side discharge assembly 84′. The side discharge assembly 84′ is at least partially disposed on the side wall 832′ of the mowing deck 83′. The side discharge assembly 84′ includes a discharge opening 841′ and a side discharge baffle 843′ rotatable about a side discharge pivot shaft 842′. The side discharge pivot shaft 842′ pivotally connects the side discharge baffle 843′ to the mowing deck 83′ (FIG. 47 shows a flipped state of the side discharge baffle 843′, and FIG. 46 shows a state where the side discharge baffle 843′ guides grass clippings), so that grass clippings are directionally thrown to the ground through the discharge opening 841′. In some examples, the side discharge assembly 84′ is disposed in a region between the front wheels 421′ and the rear wheels 411′. The side discharge assembly 84′ at least partially extends outward beyond the main body structure of the frame 11′. The side discharge assembly 84′ is disposed between the front wheels 421′ and the rear wheels 411′. In some examples, the side discharge assembly 84′ at least partially extends beyond an outer edge of the first longitudinal beam 111′ or the second longitudinal beam 112′. A distance L5′ from the side discharge pivot shaft 842′ to an outermost point of the frame 11′ in the left-right direction is less than or equal to 47 mm. This compact layout significantly reduces the lateral dimension of the entire machine, improving the device's passability in narrow areas and storage convenience. In the left-right direction, the side discharge pivot shaft 842′ at least partially overlaps with a tire. In some examples, in the left-right direction, the side discharge pivot shaft 842′ overlaps with the tire, and the side discharge pivot shaft 842′ is arranged more toward the inner side of the tire. The positioning close to the inner side of the tire fully utilizes the redundant space inside the rim, optimizing the space utilization of the frame 11′ and avoiding the risk of interference with external obstacles. In the up-down direction, the side discharge pivot shaft 842′ is located below the frame 11′. In some examples, the side discharge pivot shaft 842′ is located below the first longitudinal beam 111′ or the second longitudinal beam 112′. The low-position design not only lowers the overall center of gravity to enhance stability, but also effectively utilizes the idle space below the frame 11′, avoiding conflict with power and transmission components above. The specific spatial layout of the present application has a synergistic effect, not only ensuring an unobstructed throwing path of grass clippings from the side of the mowing deck 83′ to the discharge opening 841′, avoiding accumulation and blockage of grass clippings in a narrow space, but also minimizing the increase in the overall contour size of the machine due to the side discharge assembly 84′, achieving a unity of efficient discharge and extreme compactness, which is particularly beneficial for the device to operate in low shrubs or yard corners.

As shown in FIGS. 50 and 53, in the left-right direction, a width L3′ of the circuit board assembly 73′ is less than or equal to 450 mm. The housing 71′ of the central control mechanism 70′ includes a left upright 716′ and a right upright 717′ disposed left and right. A width L4′ between inner edges of the left upright 716′ and the right upright 717′ is less than or equal to 510 mm. The compact design of the circuit board assembly 73′ with a width L3′≤450 mm and the upright inner width L4′≤510 mm significantly reduces the lateral space occupation of the central control mechanism 70′, making the overall layout more suitable for the narrow internal space of the frame 11′, particularly facilitating high-density integration of the electronic control system in a machine with a maximum cutting width of 40 inches.

In this example, the maximum cutting width of the mowing mechanism 80′ is less than or equal to 40 inches to adapt to standardized working scenarios. The angle α′ between the extension direction of the circuit board assembly 73′ and the extension direction of the first longitudinal beam 111′ is greater than or equal to 20° and less than or equal to 80°. In the left-right direction, the ratio of the maximum width L3′ of the circuit board assembly 73′ to the width L1′ between the inner side of the first drive wheel and the inner side of the second drive wheel is greater than or equal to 0.8. The circuit board assembly 73′ fully utilizes the core installation area between the left and right drive wheels, maximizing the use of the valuable central space of the frame 11′. Under the premise of a professional-level cutting capacity of 40 inches, a high-reliability and high-integration layout of the mower control system in a limited space is achieved, while providing basic support for the lightweight design, center of gravity optimization, and passability improvement of the entire machine.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A stand-on mower, comprising:
a traveling mechanism, comprising a first drive wheel and a second drive wheel, configured to support the stand-on mower traveling on a ground;
a mowing mechanism at least partially disposed between the first drive wheel and the second drive wheel;
a frame configured to mount the traveling mechanism and the mowing mechanism;
a power supply configured to supply power to at least the traveling mechanism and the mowing mechanism, the power supply comprising a plurality of battery packs; and
a support mechanism mounted on the frame, configured to carry an operator;
wherein, in a width direction of the stand-on mower, a distance L1′ between an inner side of the first drive wheel and an inner side of the second drive wheel is less than or equal to 520 mm.

2. The stand-on mower of claim 1, wherein a distance L2′ between an outer side of the first drive wheel and an outer side of the second drive wheel is less than or equal to 860 mm.

3. The stand-on mower of claim 1, wherein the mowing mechanism comprises a mowing blade and a mowing deck covering above the mowing blade, and in the width direction, a maximum distance L′ from the mowing deck to the first drive wheel or the second drive wheel is less than or equal to 880 mm.

4. The stand-on mower of claim 3, wherein a maximum cutting width of the mowing mechanism is less than or equal to 40 inches.

5. The stand-on mower of claim 3, wherein the mowing mechanism further comprises a side discharge assembly, the side discharge assembly comprises a discharge opening and a side discharge baffle rotatable about a side discharge pivot shaft, and the side discharge assembly is configured to directionally throw grass clippings to the ground through the discharge opening.

6. The stand-on mower of claim 5, wherein in a left-right direction of the stand-on mower, the side discharge pivot shaft at least partially overlaps with one of the first drive wheel or the second drive wheel, a distance from the side discharge pivot shaft to an inner side of a tire of an overlapping one of the first drive wheel or the second drive wheel is smaller than a distance from the side discharge pivot shaft to an outer side of the tire, and a distance L5′ from the side discharge pivot shaft to an outermost point of the frame is less than or equal to 47 mm.

7. The stand-on mower of claim 5, wherein in an up-down direction of the stand-on mower, the side discharge pivot shaft is located below the frame.

8. The stand-on mower of claim 1, further comprising a circuit board assembly mounted on the frame, wherein, in a left-right direction of the stand-one mower, a width L3′ of the circuit board assembly is less than or equal to 450 mm.

9. The stand-on mower of claim 8, wherein a housing is provided on the frame, the housing forms an accommodating space to receive the circuit board assembly, the housing comprises a left upright and a right upright, and a width L4′ between the left upright and the right upright is less than or equal to 510 mm.

10. The stand-on mower of claim 8, wherein the circuit board assembly comprises a printed circuit board and a housing assembly accommodating the printed circuit board, the frame comprises a first longitudinal beam and a second longitudinal beam extending in a front-rear direction of the stand-on mower, and the housing assembly is at least partially disposed between the first longitudinal beam and the second longitudinal beam.

11. The stand-on mower of claim 10, wherein an angle α′ between an extension direction of the housing assembly and an extension direction of the longitudinal beam of the frame is greater than or equal to 20° and less than or equal to 80°.

12. The stand-on mower of claim 10, wherein, in the width direction, a ratio of a maximum width L3′ of the housing assembly to the distance L1′ between the inner side of the first drive wheel and the inner side of the second drive wheel is greater than or equal to 0.8.

13. The stand-on mower of claim 8, wherein the circuit board assembly is electrically connectable to the traveling mechanism or the power supply.

14. The stand-on mower of claim 8, wherein the circuit board assembly is located at a rear of the power supply.

15. A stand-on mower, comprising:
a traveling mechanism, comprising a first drive wheel and a second drive wheel, configured to support the stand-on mower traveling on a ground;
a frame configured to mount the traveling mechanism, the frame comprising a first longitudinal beam and a second longitudinal beam extending in a front-rear direction of the stand-on mower;
a mowing mechanism comprising a mowing element for performing a mowing function;
a power supply configured to supply power to at least the traveling mechanism and the mowing mechanism, the power supply comprising a plurality of battery packs;
a support mechanism mounted on the frame, configured to carry an operator; and
a circuit board assembly at least partially disposed between the first longitudinal beam and the second longitudinal beam, the circuit board assembly comprising a printed circuit board and a housing assembly accommodating the printed circuit board;
wherein a maximum cutting width of the mowing mechanism is less than or equal to 40 inches; an angle α′ between an extension direction of the housing assembly and an extension direction of the first longitudinal beam is greater than or equal to 20° and less than or equal to 80°;
and, in a width direction of the stand-on mower, a ratio of a maximum width L3′ of the housing assembly to a distance L1′ between an inner side of the first drive wheel and an inner side of the second drive wheel is greater than or equal to 0.8.

16. A stand-on mower, comprising:
a traveling mechanism configured to support the stand-on mower traveling on a ground;
a mowing mechanism comprising a mowing element for performing a mowing function;
a support mechanism mounted on a frame, configured to carry an operator; and
a power supply configured to supply power to the traveling mechanism and the mowing mechanism, the power supply comprising a plurality of battery packs, at least one of the plurality of battery packs being detachable;
wherein the stand-on mower is configured with a minimum start-up state; in the minimum start-up state, at least one battery pack is installed and capable of providing current to the stand-on mower; and in the minimum start-up state, a weight of the stand-on mower is less than or equal to 320 kg.

17. The stand-on mower of claim 16, wherein the stand-on mower is configured with a bare machine state in which a weight of the stand-on mower is less than or equal to 300 kg, and the bare machine state is a machine state after removing components defined as user-detachable from the stand-on mower.

18. The stand-on mower of claim 16, wherein the stand-on mower is configured with a fully loaded state in which a weight of the stand-on mower is less than or equal to 350 kg, and the fully loaded state is a state after all standard interfaces in the power supply of the stand-on mower are respectively equipped with adapted battery packs.

19. The stand-on mower of claim 16, wherein at least one battery pack has a capacity greater than or equal to 40 Ah.

20. The stand-on mower of claim 16, wherein in the minimum start-up state, at least one battery pack is installed to perform a work function other than starting the mowing mechanism.
